(19) United States
(12) Patent Application Publication
(10) Pub. No.: US 2015/0358648 A1
(43) Pub. Date: Dec. 10, 2015

(54) Digital television broadcasting system using coded orthogonal frequency-division modulation and multilevel LDPC convolutional coding

(71) Applicant: Allen LeRoy Limberg, Port Charlotte, FL (US)

(72) Inventor: Allen LeRoy Limberg, Port Charlotte, FL (US)

(21) Appl. No.: 14/299,546

(22) Filed: Jun. 9, 2014

(51) Int. Cl. H04N 21/236; H04L 27/36; H04L 27/26

(52) U.S. Cl. CPC H04N 21/236; H04L 27/2602; H04L 27/2627; H04L 27/36

(57) ABSTRACT

In transmitter apparatus for a digital television (DTV) broadcasting system, internet-protocol (IP) packets of digital television information are subjected to multilevel concatenated Bose-Chaudhuri-Hocquenghem (BCH) coding and low-density parity-check convolutional coding (LDPCCC) before being bit-interleaved and mapped to quadrature-amplitude-modulation (QAM) constellations. The QAM constellations are used in coded orthogonal frequency-division modulation (COFDM) of plural carrier waves up-converted to a radio-frequency broadcast television channel. In receiver apparatus for the DTV broadcasting system the results of de-mapping QAM constellations recovered from demodulating the COFDM carrier waves are de-interleaved, and the constituent LDPCCC codewords are decoded to recover constituent BCH codewords of the multilevel BCH coding. The constituent BCH codewords are decoded to correct remnant bit errors in them. Then, IP packets of digital television information are reconstituted from the systematic data bits in those BCH codewords.

### FIELD OF THE INVENTION

Various aspects of the invention relate to systems of over-the-air broadcasting of orthogonal frequency-division modulation (OFDM) digital television (DTV) signals for iterative-diversity reception and particularly to receiver apparatus for such systems.

### BACKGROUND OF THE INVENTION

DTV broadcasting in the United States of America has been done in accordance with broadcasting standards formulated by an industry consortium called the Advanced Television Systems Committee (ATSC), which standards have prescribed the use of a vestigial-sideband amplitude-modulated single carrier in each radio-frequency (RF) channel allocated for broadcasting DTV signals. Consideration is being given to replacing those DTV broadcasting standards with new standards that may prescribe coded orthogonal frequency-division multiplexed (COFDM) plural carriers in each RF channel allocated for broadcasting DTV signals. These new standards may, for example, resemble the DVB-T2 broadcasting standard developed for use in Europe.

COFDM is typically generated by data randomizing digital data to insure that subsequent encoding of forward-error-correction (FEC) coding receives sufficient density of logic ONEs to operate efficiently. Then, the resulting FEC coding is subjected to some form of bit interleaving, and the bits of the interleaved FEC coding are mapped to quadrature-amplitude-modulation (QAM) symbol constellations. The real-axis and imaginary-axis spatial coordinates of the QAM constellations are parsed into orthogonal frequency-division multiplex (OFDM) symbols, which modulate a single carrier wave at high rate using quadrature-amplitude-modulation (QAM). The resulting modulated carrier wave is then transformed in a fast inverse discrete Fourier transform (I-DFT) procedure to generate a multiplicity of RF carrier waves uniformly distributed within the frequency spectrum of the RF channel, each of which RF carriers is modulated at low symbol rate.

The DVB-T2 standard for DTV broadcasting prescribes Bose-Chaudhuri-Hocquenghem (BCH) coding concatenated with subsequent low-density parity-check coding (LPDC) as FEC coding. This coding is favored because of its relatively low redundancy as compared to turbo coding that provides similar performance in the presence of additive white Gaussian noise (AWGN). The concatenated BCH-LDPC coding prescribed in the DVB-T2 standard is reported to allow better performance in the presence of AWGN to be achieved using 256QAM constellations than could be achieved using 16QAM constellations per the earlier DVB-T standard for over-the-air DTV broadcasting. The bits of the LDPC coding are block interleaved using a column-twist or matrix type of interleaving in which successive bits of LDPC coding are arranged in columns for subsequent row-by-row utilization for mapping to lattice points within successive QAM constellations. The FEC frames of LDPC coding extend over very large numbers of bits, a normal FEC frame being composed of 64,800 bits and a short FEC frame used for transmissions to mobile receivers being composed of 16,200 bits.

The mapping of LDPC coding to square QAM constellations is Gray mapping, in which plural-bit code segments that are mapped by adjacent portions of the constellation differ in only a single bit. This reduces the bit errors caused by AWGN when de-mapping is done in the DTV receiver. However, soft de-mapping of the square QAM constellations in the DTV receiver recovers the successive bits of LDPC coding with varying respective levels of confidence that they are correct. Those bits of the de-mapping results with lower respective levels of confidence that they are correct are more likely adversely to affect the capability of LDPC decoding to recover the BCH-coded data as originally transmitted, than are those bits of the de-mapping results with higher respective levels of confidence that they are correct. The ratio of parity bits to systematic bits in the LDPC coding is determined by the desire to correct the bits having the lowest respective levels of confidence that they are correct when the Shannon limit is approached during AWGN reception conditions.

The LDPC coding prescribed in the DVB-T2 DTV broadcasting standard does not employ multilevel coding (MLC), a concept introduced by H. Imai and S. Hirakawa in their paper “A new multilevel coding method using error correcting codes” appearing on pages 371-377 in the May 1977 issue of IEEE Transactions on Information Theory, vol. 23, no. 3. The key idea in MLC is that the bits of binary FEC coding are mapped to M-ary modulation symbol constellations for transmission. Decoding is expedited by FEC coding the bits mapped to different points in M-ary modulation symbol constellations independently of each other, which permits parallel independent decoding (PID). In September 2003 an MLC/PID scheme of data transmission was described by J. Hou, P. H. Siegel, L. B. Milstein, and H. D. Pfitser in their paper “Capacity approaching bandwidth-efficient coded modulation schemes based on low-density parity-check codes” appearing on pages 2141-2155 of IEEE Transactions on Information Theory, vol. 49, no. 9. In the MLC/PID scheme, the information bit stream is split into a plurality L in number of different levels, and the corresponding bits at different levels are encoded using different encoders, and then combined into a signal sample using an appropriate mapping rule. At the receiver side, decoders at different levels operate independently and in parallel. This paper and subsequent ones by other authors recognized that the use of Gray mapping and PID at each level separately with optimally chosen component codes offer performance approaching the Shannon limit on theoretical channel capacity. LDPC coding of the different levels into which the information bit stream is split was proposed and described by I. B. Djordjevic and B. Vasic in their paper “Multilevel coding in M-ary DPSK/differential QAM high-speed optical transmission with direct detection” appearing on pages 420-428 of Journal of Lightwave Technology, Vol. 24, No. 1, January 2006. An MLC scheme of data transmission using different constituent LDPC coding for each level was described by R. Y. S. Tee, O. Alamri, S. X. Ng and L. Hanzo in their paper “Block-Coded Sphere-Packing-Aided Multilevel Coding” appearing on pages 4173-4178 of IEEE International Conference on Communications, June 2007.

A paper titled “Design of low-density parity-check codes for bandwidth efficient modulation” and authored by J. Hou, P. H. Siegel, L. B. Milstein and H. D. Pfister that appeared on pages 24-26 of the conference publication of IEEEE ITW 2001 held Sep. 2-7, 2001 in Cairns, Australia is of interest. The authors report they were able to achieve asymptotic performance very close to the capacity of an AWGN channel using multilevel coding employing irregular LDPC coding optimized for each code level. They describe multilevel LDPC coding with different-rate LDPC codes for different levels, with the different-rate LDPC codes having codewords all of the same length. The Hou et alii paper describes the mapping of the multilevel LDPC coding to 4PAM and 8PSK modulation symbol constellations.

The above-cited papers do not describe multilevel coding being applied to the modulation of OFDM carrier waves. The application of multilevel LDPC coding to quadrature amplitude modulation (QAM) of OFDM carrier waves was described in provisional U.S. Pat. App. Ser. No. 61/809,639 filed 8 Apr. 2013 by A. L. R. Limberg and titled “Digital television broadcasting system using coded orthogonal frequency division modulation and multilevel low-density parity-check coding”. Limberg pointed out that the application of multilevel LDPC coding to quadrature amplitude modulated OFDM carrier waves permitted significantly greater coding efficiency for a specified bit error rate (BER) in the presence of additive white Gaussian noise (AWGN). Without increasing transmitter power or increasing radio-frequency channel bandwidth, a broadcaster could increase the number of bits he could transmit to a prescribed region of broadcast coverage by as much as 20 to 50%. U.S. Pat. App. Ser. No. 61/809,639 described keeping the systematic data bits in the resulting MLC in their original sequential order within each FEC Frame. This required the multilevel LDPC coding with different-rate LDPC codes for different levels to have codewords of different lengths, with lower-rate LDPC codewords each having more bits than higher-rate LDPC codewords each have. The parity bits of the constituent LDPC codewords were mapped into levels other than those containing their respective systematic data bits when defining the QAM symbol constellations modulating OFDM carrier waves. This was done to accommodate the asymmetry in the lengths of the constituent LDPC codes in the MLC. Provisional U.S. Pat. App. Ser. No. 61/827,694 filed 27 May 2013 by A. L. R. Limberg and titled “Digital television broadcasting system using coded orthogonal frequency division modulation and multilevel low-density parity-check coding” augmented the disclosure of U.S. Pat. App. Ser. No. 61/809,639 with specific suggestions as to preferred constituent LDPC codes for the multilevel LDPC coding. Provisional U.S. Pat. App. Ser. No. 61/827,692 filed 27 May 2013 by A. L. R. Limberg and titled “Digital television broadcasting system using coded orthogonal frequency division modulation and multilevel BCH/LDPC coding” disclosed multilevel coding in which separate BCH coding was provided for each level of constituent LDPC coding in the multilevel LDPC coding.

However, mapping parity bits of the constituent LDPC codewords into levels other than those containing their respective systematic data bits compromises the shaping gain available with multilevel LDPC coding (LDPC-MLC). Provisional U.S. Pat. App. Ser. No. 61/827,689 filed 27 May 2013 by A. L. R. Limberg and titled “Digital television broadcasting system using coded orthogonal frequency division modulation and multilevel forward-error-correction coding” described implementation of LDPC-MLC in which all constituent LDPC codewords consist of a prescribed number of respective bits. The parity bits of the constituent LDPC codewords are transmitted in the same levels of the LDPC-MLC as the respective systematic bits of those constituent LDPC codewords, which allows better shaping gain of the LDPC-MLC.

The DVB-T2 standard for DTV broadcasting, the papers cited above in regard to LDPC coding, and the provisional patent applications of A. L. R. Limberg referred to in the previous two paragraphs employed LDPC block coding. Preferably, the LDPC block codes would either fit within the 64,800-bit normal FEC Frames prescribed by the DVB-T2 standard or fit within the 16,200-bit short FEC frames also prescribed by the DVB-T2 standard. The LDPC block codes were further constrained by the desire to employ parallel independent decoding (PID) of those codes. When these constraints were applied to multilevel LDPC block coding some code rates were very difficult to obtain. U.S. Pat. App. Ser. No. 61/827,689 described preferred FEC Frames that differed from those prescribed by the DVB-T2 standard, but supported a better range of average code rates for the multilevel LDPC coding.

LDPC block codes have been extensively studied since the mid-1990's. The convolutional counterpart of LDPC block codes, LDPC convolutional codes, were first proposed by A. Jiménez-Feltström and K. Sh. Zigangirov in their paper “Time-varying periodic convolutional codes with low-density parity-check matrix”, IEEE Transactions on Information Theory, vol. IT-45, pp. 2181-2191, September 1999. Analogous to LDPC block codes, LDPC convolutional codes are defined by sparse parity-check matrices, which allow them to be decoded using iterative message-passing algorithms. The so-called pipeline decoder originally used to decode these codes had a potentially long initial decoding delay and high storage requirements. The first practical VLSI hardware architecture for LDPC convolutional decoders was proposed by S. Bates and G. Block in their paper “A memory based architecture for low-density parity-check convolutional decoders,” in Proceedings of IEEE International Symposium on Circuits and Systems, Kobe, Japan, May 2005. S. Bates, Z. Chen and X. Dong reported in their paper “Low-density parity check convolutional codes for Ethernet networks” in Proceedings of IEEE Pacific Rim Conference on Communications, in Proceedings of Computers and Signal Processing, Victoria, B.C., Canada, August 2005 that terminated LDPC convolutional codes were appropriate for packet data transmission in Ethernet networks. D. J. Costello, Jr., A. E. Pusane, S. Bates and K. Sh. Zigangirov presented an invited paper “A comparison Between LDPC block and convolutional codes”, Proceedings of Information Theory and Applications Workshop, San Diego, Calif., USA, Feb. 6-10, 2006. Improvements to the pipeline decoder to reduce both the long initial decoding delay and the high storage requirements for decoder memory were disclosed by A. E. Pusane, A. Jiménez-Feltström, A. Sridharan, M. Lentmaier, K. Sh. Zigangirov and D. J. Costello, Jr. in “Implementation aspects of LDPC convolutional codes”, IEEE Transactions on Communications, Vol. 56, No. 7, July 2008, pp. 1060-1069. S. Bates, Z. Chen, L. Gunthorpe, A. E. Pusane, K. Sh. Zigangirov and D. J. Costello, Jr. described further improvements in LDPC CC decoding in “A low-cost serial decoder architecture for low-density parity-check convolutional codes”, IEEE Transactions on Circuits and Systems—1: Regular Papers, Vol. 55, No. 7, August 2008, pp. 1967-1976. For a terminated LDPCC code ensemble, the noise thresholds were found to be better than for corresponding regular and irregular LDPC block codes according to M. Lentmaier, A. Sridharan, D. J. Costello, Jr. and K. Sh. Zigangirov, “Iterative decoding threshold analysis for LDPC convolutional codes,” IEEE Transactions on Information Theory, Vol. 56, No. 10, pp. 5274-5289, October 2010.

An attractive attribute of the sliding-window serial decoders for LDPC convolutional codes is that, by terminating such a code early, its length can be adjusted at will. Such decoders are sometimes referred to as “pipeline” decoders for LDPCCC. The memory requirements to support these serial decoders for LDPC convolutional codes are comparable to the memory requirements to support parallel independent decoders for LDPC block codes of similar length. However, the number of elements in the processor(s) used for serially decoding the LDPC convolutional codes can be many times smaller than the number of elements in the processors used for parallel independent decoding the LDPC block codes. The pipeline decoders for LDPCCC avoid for the most part the very complex routing of bits between memory and parallel independent decoders, which complex routing complicates laying out a monolithic integrated circuit, requiring several layers of metalized conductors.

### SUMMARY OF THE INVENTION

Overall, the invention is directed to COFDM transmission systems using multilevel LDPC convolutional coding (LDPCCC-MLC) using different constituent LDPC convolutional coding (LDPCCC) for each level. The systematic data bits are split into consecutive data packets of different sizes for respective constituent LDPCCC at respective code rates for each level of the LDPCCC-MLC, these procedures being performed so all constituent LDPC convolutional codewords consist of a prescribed number of respective bits. Aspects of the overall invention are embodied in COFDM transmitter apparatus for implementing LDPCCC-MLC. Other aspects of the invention are embodied in COFDM receiver apparatus comprising a de-mapper for QAM constellations followed by a plurality of decoders for respective levels of LDPCCC-MLC.

Further aspects of the invention relate to the constituent LDPCCC of each level of the LDPCCC-MLC being designed to be independently decoded using respective serial decoders. Some of these aspects of the invention are embodied in COFDM transmitter apparatus configured for bit interleaving the LDPCCC-MLC designed to facilitate parallel independent decoding of the constituent LDPCCC coding of each of its levels and mapping the interleaved LDPCCC-MLC to the QAM constellations modulating OFDM carrier waves in the COFDM transmissions. Others of these aspects of the invention are embodied in COFDM receiver apparatus comprising a de-mapper for QAM constellations followed by a plurality of decoders for respective levels of LDPCCC-MLC, each of which decoders is configured for serial sliding-window decoding its respective level of LDPCCC-MLC.

### BRIEF DESCRIPTION OF THE DRAWINGS

FIGS. 1, 2, 3 and 4 together form a schematic diagram of COFDM transmitter apparatus embodying aspects of the invention, which transmitter apparatus twice transmits the same coded DTV signal.

FIG. 5 is a schematic diagram of a memory structure that is a replacement for the random-access memory shown in FIG. 4.

FIG. 6 is a more detailed schematic diagram of a first embodiment of a part of the FIG. 2 portion of COFDM transmitter apparatus for encoding LDPCCC-MLC and mapping that coding into QAM constellations.

FIG. 7 is a more detailed schematic diagram of a second embodiment of a part of the FIG. 2 portion of COFDM receiver apparatus for encoding LDPCCC-MLC and mapping that coding into QAM constellations.

FIG. 8 is a diagram illustrating the content of the three layers of LDPCCC-MLC mapped into 64QAM constellations in the FIG. 6 schematic diagram of the first embodiment of the part of the FIG. 2 portion of COFDM transmitter apparatus for encoding LDPCC-MLC and mapping that coding into QAM constellations.

FIG. 9 is a diagram illustrating the content of the four layers of LDPCCC-MLC mapped into 256QAM constellations in the FIG. 7 schematic diagram of the second embodiment of the part of the FIG. 2 portion of COFDM transmitter apparatus for encoding LDPCCC-MLC and mapping that coding into QAM constellations.

FIG. 10 is a more detailed schematic diagram of a third embodiment of a part of the FIG. 2 portion of COFDM transmitter apparatus for encoding LDPCCC-MLC and mapping that coding into QAM constellations.

FIG. 11 is a diagram illustrating the content of the six layers of LDPCCC-MLC mapped into 64QAM constellations in the FIG. 10 schematic diagram of the third embodiment of the part of the FIG. 2 portion of COFDM transmitter apparatus for encoding LDPCCC-MLC and mapping that coding into QAM constellations.

FIG. 12 is a more detailed schematic diagram of a fourth embodiment of a part of the FIG. 2 portion of COFDM receiver apparatus, used for encoding LDPCCC-MLC and mapping that coding into QAM constellations.

FIG. 13 is a diagram illustrating the content of the eight layers of LDPCCC-MLC mapped into 256QAM constellations in the FIG. 12 schematic diagram of the fourth embodiment of the part of the FIG. 2 portion of COFDM transmitter apparatus for encoding LDPCCC-MLC and mapping that coding into QAM constellations.

FIG. 14 is a more detailed schematic diagram of a fifth embodiment of a part of the FIG. 2 portion of COFDM receiver apparatus, used for encoding LDPCCC-MLC and mapping that coding into QAM constellations.

FIG. 15 is a diagram illustrating the content of the nine layers of LDPCCC-MLC mapped into 512QAM constellations in the FIG. 14 schematic diagram of the fifth embodiment of the part of the FIG. 2 portion of COFDM transmitter apparatus for encoding LDPCCC-MLC and mapping that coding into QAM constellations.

FIGS. 16, 17 and 18 together form a schematic diagram of COFDM receiver apparatus configured for iterative-diversity reception of COFDM signals, which receiver apparatus embodies aspects of the invention and employs maximal-ratio code combining of twice-transmitted signals.

FIG. 19 is a schematic diagram of a modification of the FIG. 16 portion of the COFDM receiver apparatus further depicted in FIGS. 17 and 18, which COFDM receiver apparatus as so modified is an alternative embodiment of aspects of the invention.

FIG. 20 is a more detailed schematic diagram of a first embodiment of a part of the FIG. 18 portion of COFDM receiver apparatus for decoding multilevel BCH/LDPCCC coding recovered by de-mapping 64QAM constellations.

FIG. 21 is a more detailed schematic diagram of a second embodiment of a part of the FIG. 18 portion of COFDM receiver apparatus for decoding multilevel BCH/LDPCCC coding recovered by de-mapping 256QAM constellations.

FIG. 22 is a more detailed schematic diagram of a third embodiment of a part the FIG. 18 portion of COFDM receiver apparatus for decoding multilevel BCH/LDPCCC coding recovered by de-mapping 64QAM constellations.

FIG. 23 is a more detailed schematic diagram of a fourth embodiment of a part of the FIG. 18 portion of COFDM receiver apparatus for decoding multilevel BCH/LDPCCC coding recovered by de-mapping 256QAM constellations.

FIG. 24 is a more detailed schematic diagram of a fifth embodiment of a part of the FIG. 18 portion of COFDM receiver apparatus for decoding multilevel BCH/LDPCCC coding recovered by de-mapping 512QAM constellations.

FIG. 25 is a flow chart diagramming the operation of a decoder for a single level of the multilevel BCH/LDPCCC coding.

FIG. 26 is a table of characteristics of constituent LDPCCC codes in three levels of LDPCCC-MLC in a 64,800-bit FEC Frame de-mapped from 64QAM symbol constellations in a COFDM signal, which LDPCCC-MLC has an average code rate of 0.711.

FIG. 27 is a table of characteristics of constituent LDPCCC codes in four levels of LDPCCC-MLC in a 64,800-bit FEC Frame de-mapped from 256QAM symbol constellations in a COFDM signal, which LDPCCC-MLC has an average code rate of 0.756.

FIG. 28 is a table of characteristics of constituent LDPCCC codes in six levels of LDPCCC-MLC in a 64,800-bit FEC Frame de-mapped from 64QAM symbol constellations in a COFDM signal, which LDPCCC-MLC has an average code rate of 0.700.

FIG. 29 is a table of characteristics of constituent LDPCCC codes in eight levels of LDPCCC-MLC in a 64,800-bit FEC Frame de-mapped from 256QAM symbol constellations in a COFDM signal, which LDPCCC-MLC has an average code rate of 0.744.

FIG. 30 is a table of characteristics of constituent LDPCCC codes in nine levels of LDPCCC-MLC in a 64,800-bit FEC Frame de-mapped from 512QAM symbol constellations in a COFDM signal, which LDPCCC-MLC has an average code rate of 0.733.

FIG. 31 is a table of characteristics of constituent LDPCCC codes in three levels of LDPCCC-MLC in a 64,800-bit FEC Frame de-mapped from 64QAM symbol constellations in a COFDM signal, which LDPCCC-MLC has an average code rate of 0.806.

FIG. 32 is a table of characteristics of constituent LDPCCC codes in four levels of LDPCCC-MLC in a 64,800-bit FEC Frame de-mapped from 256QAM symbol constellations in a COFDM signal, which LDPCCC-MLC has an average code rate of 0.839.

FIG. 33 is a table of characteristics of constituent LDPCCC codes in six levels of LDPCCC-MLC in a 64,800-bit FEC Frame de-mapped from 64QAM symbol constellations in a COFDM signal, which LDPCCC-MLC has an average code rate of 0.800.

FIG. 34 is a table of characteristics of constituent LDPCCCCC codes in eight levels of LDPCCC-MLC in a 64,800-bit FEC Frame de-mapped from 256QAM symbol constellations in a COFDM signal, which LDPCCC-MLC has an average code rate of 0.833.

FIG. 35 is a table of characteristics of constituent LDPCCC codes in nine levels of LDPCCC-MLC in a 64,800-bit FEC Frame de-mapped from 512QAM symbol constellations in a COFDM signal, which LDPCCC-MLC has an average code rate of 0.800.

FIGS. 36, 37 and 38 are tables of characteristics of constituent LDPCCC codes in three levels of LDPCCC-MLC of 0.750, 0.850 and 0.900 respective code rates in a 64,800-bit FEC Frame de-mapped from 64QAM symbol constellations in a COFDM signal.

FIGS. 39, 40 and 41 are tables of characteristics of constituent LDPCCC codes in four levels of LDPCCC-MLC of 0.794, 0.875 and 0.917 respective code rates in a 64,800-bit FEC Frame de-mapped from 256QAM symbol constellations in a COFDM signal.

FIG. 42 is a detailed schematic diagram of the maximal-ratio code combiner depicted in the FIG. 16 and FIG. 19 portions of COFDM receiver apparatuses.

FIG. 43 is a detailed schematic diagram of portions of the pilot carriers processor as shown in FIG. 16, or as shown in FIG. 19, which portions generate measurements of the total RMS power of pilot carriers for controlling the maximal-ratio code combiner depicted in FIG. 16 or in FIG. 19.

FIGS. 44A, 44B, 44C and 44D together form FIG. 44, which is a detailed schematic diagram showing an arrangement for addressing memory within the FIG. 16 portion of the COFDM receiver apparatus.

FIGS. 45A, 45B, 45C and 45D together form FIG. 45, which is a detailed schematic diagram showing an alternative arrangement for addressing memory within the FIG. 16 portion of the COFDM receiver apparatus.

FIG. 46 is a schematic diagram of a respective form that is taken by replacements for read-only memories used as read address generators within the portions of COFDM receiver apparatus depicted in FIGS. 44A, 44B, 44C and 44D.

FIG. 47 is a schematic diagram of a respective form that is taken by replacements for read-only memories used as write address generators within the portions of COFDM receiver apparatus depicted in FIGS. 45A, 45B, 45C and 45D.

FIGS. 48, 17 and 49 together form a schematic diagram of COFDM receiver apparatus configured for iterative-diversity reception of COFDM signals, which receiver apparatus embodies aspects of the invention involving the choosing of correct internet-protocol packets from initial transmissions of COFDM signals and from final transmissions of COFDM signals.

FIG. 50 is a schematic diagram of a modification of the FIG. 16 portion of the COFDM receiver apparatus further depicted in FIGS. 17 and 18, which COFDM receiver apparatus as so modified is an alternative embodiment of aspects of the invention.

FIG. 51 is a schematic diagram of a modification of the FIG. 19 portion of the COFDM receiver apparatus further depicted in FIGS. 17 and 18, which COFDM receiver apparatus as so modified is an alternative embodiment of aspects of the invention.

### DETAILED DESCRIPTION

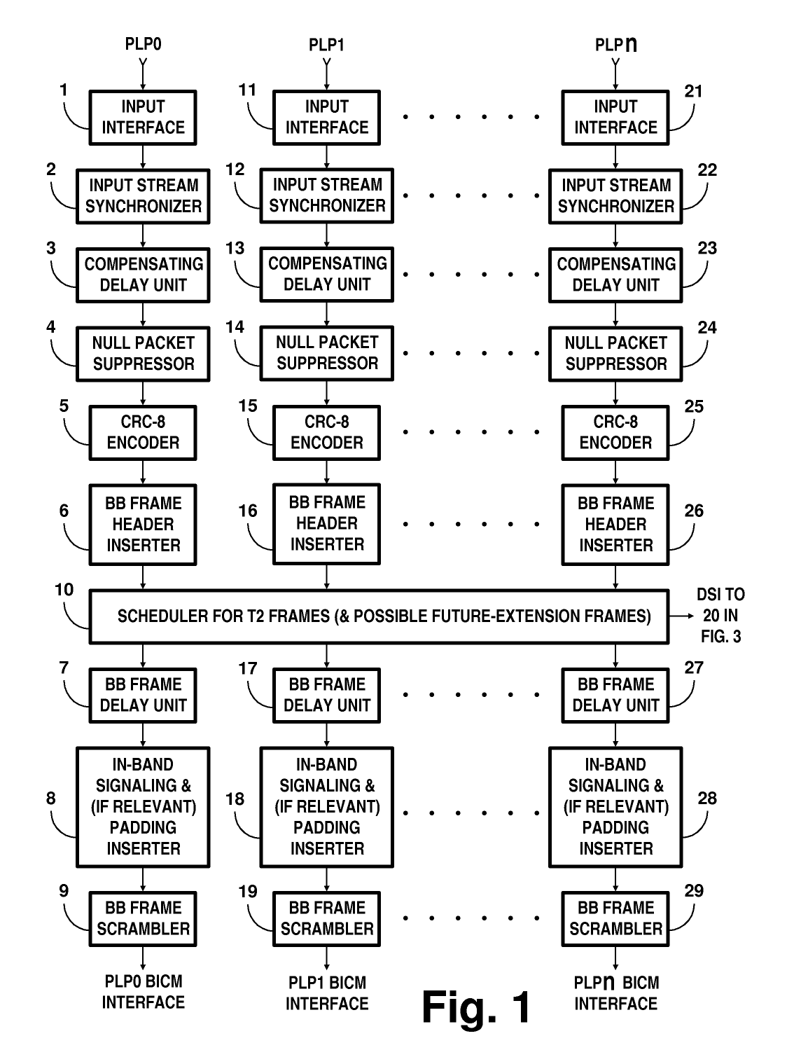

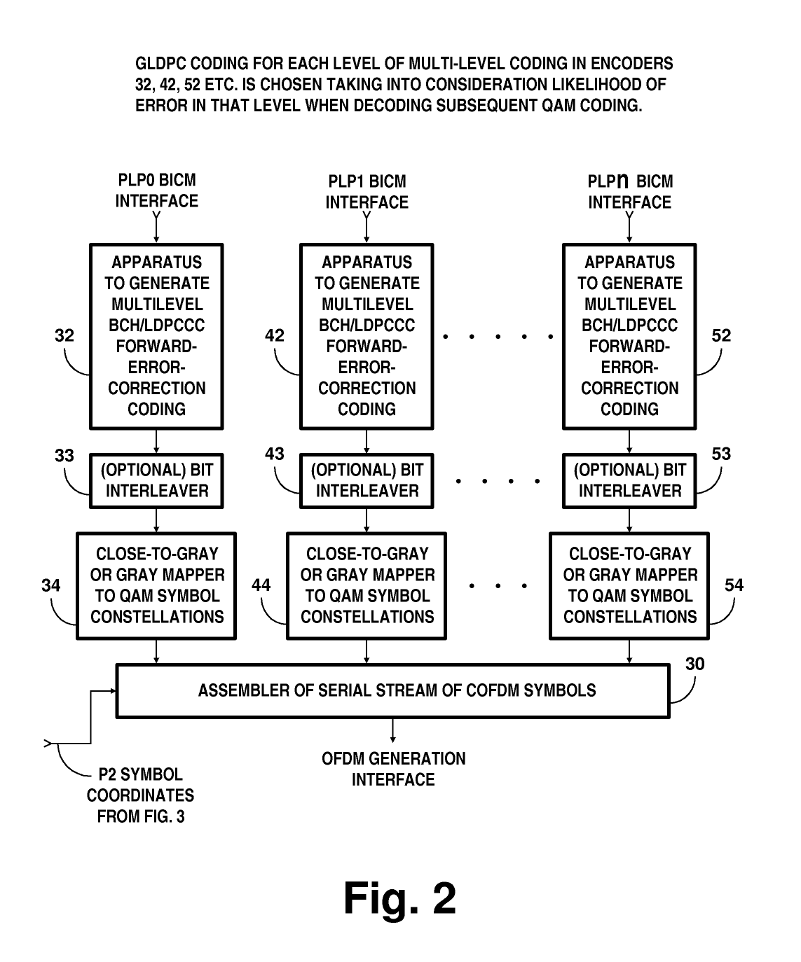

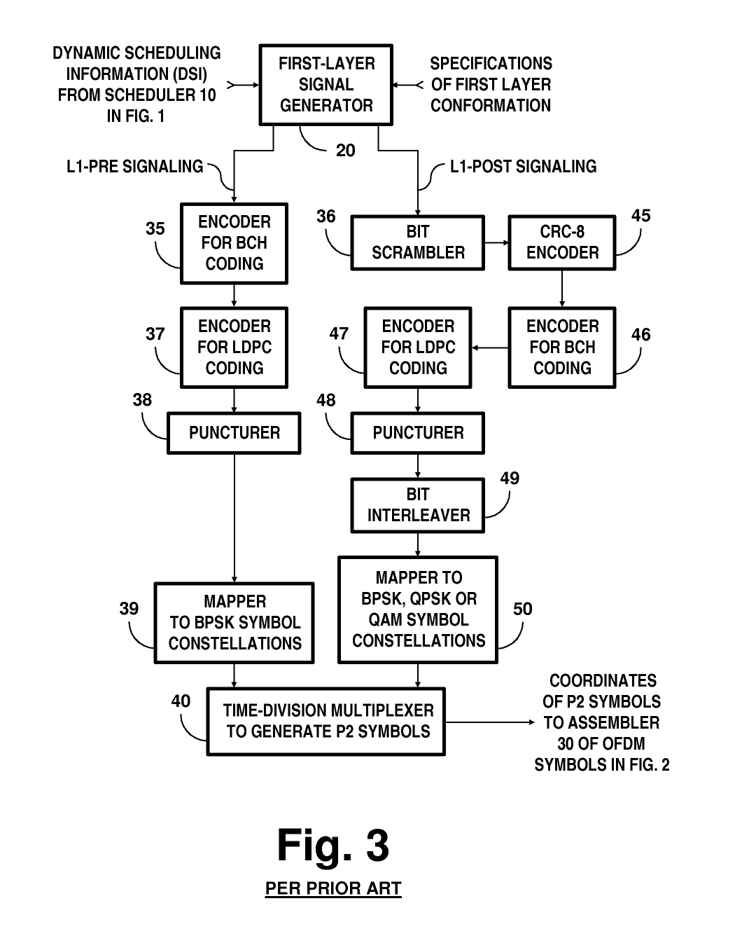

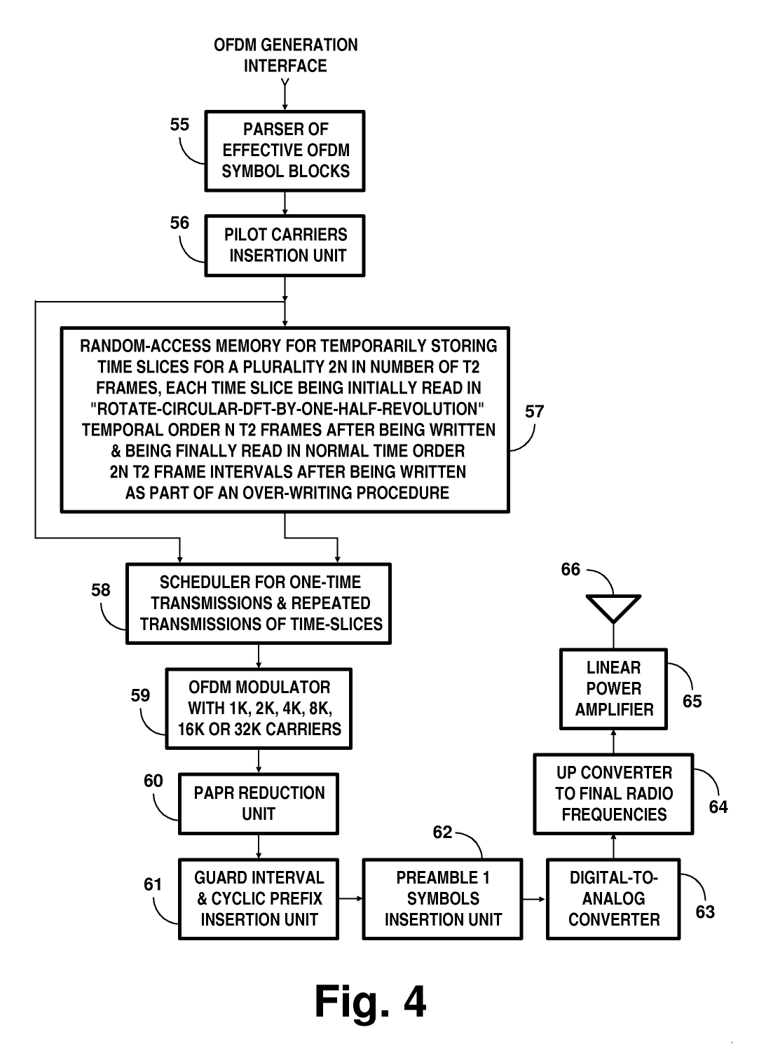

FIGS. 1, 2, 3 and 4 depict a DTV transmitter apparatus generating COFDM signals designed for reception by DTV receivers. FIG. 1 depicts apparatus for generating baseband frames (BBFRAMES) at a Bit-Interleaved Coding and Modulation (BICM) interface. FIG. 2 depicts apparatus for generating bit-wise forward-error-correction (FEC) coding and subsequent COFDM symbol blocks responsive to the BBFRAMEs supplied at the BICM interface. FIG. 3 depicts apparatus for generating bit-wise forward-error-correction (FEC) coding and subsequent COFDM symbol blocks responsive to first layer (L1) conformation specifications and to dynamic scheduling information (DSO. FIG. 4 depicts apparatus for generating and transmitting radio-frequency COFDM signals. Except for the processing of QAM constellations into COFDM symbols, the DTV transmitter apparatus depicted in FIGS. 1, 2, 3 and 4 is essentially the same as specified in European Telecommunications Standards Institute (ETSI) standard EN 302 755 V1.3.1 published in April 2012, titled “Digital Video Broadcasting (DVB); Frame structure channel coding and modulation for a second generation digital terrestrial television broadcasting system (DVB-T2)”, and incorporated herein by reference.

A scheduler 10 for interleaving time-slices of services to be broadcast to stationary DTV receivers is depicted in the middle of FIG. 1. The scheduler 10 schedules transmissions of time slices for a number (n+1) of physical layer pipes (PLPs), n being a positive integer at least zero. FIGS. 1 and 2 identify these PLPs by the letters “PLP” followed respectively by consecutive positive integers of a modulo-n numbering system. The scheduler 10 also generates and schedules dynamic scheduling information (DSI) for application to an additional PLP depicted in FIG. 3, which additional PLP generates OFDM symbol blocks that convey the DSI and first layer confirmation specifications. Recommended practice is that at least the physical layer pipe PLP0 is a so-called “common” PLP used for transmitting data, such as a program guide, relating to the other “data” PLPs. The common PLP or PLPs are transmitted in each T2 frame following the P1 and P2 symbols, but before the data PLP or PLPs. A PLP may be of a first type transmitted as a single slice per T2 frame, or the PLP may be of a second type transmitted as a plurality of sub-slices scattered through the T2 frame to achieve greater time diversity.

FIG. 1 depicts the (n+1)th physical layer pipe PLP0 comprising elements 1-6 in cascade connection before the scheduler 10 and further comprising elements 7-9 in cascade connection after the scheduler 10, but before a PLP0 bit-interleaved coding and modulation (BICM) interface. More specifically, FIG. 1 depicts a PLP0 stream of logical digital data is supplied to the input port of an input interface 1, the output port of which connects to the input port of an input stream synchronizer 2. The output port of the input stream synchronizer 2 connects to the input port of a compensating delay unit 3, the output port of which connects to the input port of a null-packet suppressor 4. The output port of the null-packet suppressor 4 connects to the input port of a CRC-8 encoder 5 operative at user packet level, the output port of which connects to the input port of an inserter 6 of headers for baseband (BB) frames. The output port of the BBFRAME header inserter 6 connects to a respective input port of the scheduler 10. The physical layer pipe PLP0 continues following the scheduler 10, with FIG. 1 showing a respective output port of the scheduler 10 connecting to the input port of a delay unit 7 for delaying baseband (BB) frames. FIG. 1 shows the output port of the BBFRAME delay unit 7 connecting to the input port of an inserter 8 for inserting in-band signaling into BBFRAMEs, which in-band signaling essentially consists of dynamic scheduling information (DSI) generated by the scheduler 10, and/or for inserting padding into the BBFRAME. Padding is inserted in circumstances when the user data available for transmission is not sufficient to completely fill a BBFRAME, or when an integer number of user packets is required to be allocated to a BBFRAME. FIG. 1 shows the output port of the inserter 8 connecting to the input port of a BBFRAME scrambler 9, which data randomizes bits of the BBFRAME supplied from the output port of the BBFRAME scrambler 9 as the PLP0 BICM interface. In practice the delay unit 7, the inserter 8 and the BBFRAME scrambler 9 are realized by suitable configuration of a random-access memory.

FIG. 1 depicts the first physical layer pipe PLP1 comprising elements 11-16 in cascade connection before the scheduler 10 and further comprising elements 17-19 in cascade connection after the scheduler 10, but before a PLP1 bit-interleaved coding and modulation (BICM) interface. More specifically, FIG. 1 depicts a PLP1 stream of logical digital data is supplied to the input port of an input interface 11, the output port of which connects to the input port of an input stream synchronizer 12. The output port of the input stream synchronizer 12 connects to the input port of a compensating delay unit 13, the output port of which connects to the input port of a null-packet suppressor 14. The output port of the null-packet suppressor 14 connects to the input port of a CRC-8 encoder 15 operative at user packet level, the output port of which connects to the input port of an inserter 16 of headers for BBFRAMEs. The output port of the BBFRAME header inserter 16 connects to a respective input port of the scheduler 10. The physical layer pipe PLP1 continues following the scheduler 10, with FIG. 1 showing a respective output port of the scheduler 10 connecting to the input port of a delay unit 17 for delaying BBFRAMEs. FIG. 1 shows the output port of the BBFRAME delay unit 17 connecting to the input port of an inserter 18 for inserting in-band signaling into BBFRAMEs, which in-band signaling essentially consists of DSI generated by the scheduler 10, and/or for inserting padding into the BBFRAME. FIG. 1 shows the output port of the inserter 18 connecting to the input port of a BBFRAME scrambler 19, which data randomizes bits of the BBFRAME supplied from the output port of the BBFRAME scrambler 19 as the PLP1 BICM interface. In practice the delay unit 17, the inserter 18 and the BBFRAME scrambler 19 are realized by suitable operation of a memory.

FIG. 1 depicts the (n)th physical layer pipe PLPn comprising elements 21-26 in cascade connection before the scheduler 10 and further comprising elements 27-29 in cascade connection after the scheduler 10, but before a PLPn bit-interleaved coding and modulation (BICM) interface. More specifically, FIG. 1 depicts a PLPn stream of logical digital data is supplied to the input port of an input interface 21, the output port of which connects to the input port of an input stream synchronizer 22. The output port of the input stream synchronizer 22 connects to the input port of a compensating delay unit 23, the output port of which connects to the input port of a null-packet suppressor 24. The output port of the null-packet suppressor 24 connects to the input port of a CRC-8 encoder 25 operative at user packet level, the output port of which connects to the input port of an inserter 26 of headers for BBFRAMEs. The output port of the BBFRAME header inserter 26 connects to a respective input port of the scheduler 10. The physical layer pipe PLPn continues following the scheduler 10, with FIG. 1 showing a respective output port of the scheduler 10 connecting to the input port of a delay unit 27 for delaying BBFRAMEs. FIG. 1 shows the output port of the BBFRAME delay unit 27 connecting to the input port of an inserter 28 for inserting in-band signaling into BBFRAMEs, which in-band signaling essentially consists of dynamic scheduling information (DSI) generated by the scheduler 10, and/or for inserting padding into the BBFRAME. FIG. 1 shows the output port of the inserter 28 connecting to the input port of a BBFRAME scrambler 29, which data randomizes bits of the BBFRAME supplied from the output port of the BBFRAME scrambler 29 as the PLPn BICM interface. In practice the delay unit 27, the inserter 28 and the BBFRAME scrambler 29 are realized by suitable operation of a memory.

The input stream synchronizers 2, 12, 22 etc. are operable to guarantee Constant Bit Rate (CBR) and constant end-to-end transmission delay for any input data format when there is more than one input data format. Some transmitters may not include ones of the input stream synchronizers 2, 12, 22 etc. or ones of the compensating delay units 3, 13, 23 etc. For some Transport-Stream (TS) input signals, a large percentage of null-packets may be present in order to accommodate variable bit-rate services in a constant bit-rate TS. In such a case, to avoid unnecessary transmission overhead, the null-packet suppressors 4, 14, 24 etc. identify TS null-packets from the packet-identification (PID) sequences in their packet headers and remove those TS null-packets from the data streams to be scrambled by the BBFRAME scramblers 9, 19, 29 etc. This removal is done in a way such that the removed null-packets can be re-inserted in the receiver in the exact positions they originally were in, thus guaranteeing constant bit-rate and avoiding the need for time-stamp (PCR) updating. Further details of the operation of the input stream synchronizers 2, 12, 22 etc.; the compensating delay units 3, 13, 23 etc.; and the null-packet suppressors 4, 14, 24 etc. can be gleaned from ETSI standard EN 302 755 V1.3.1 for DVB-T2.

FIG. 2 depicts the (n+1)th physical layer pipe PLP0 further comprising elements 32-34 in cascade connection after the PLP0 BICM interface, but before a respective input port of an assembler 30 for assembling a serial stream of OFDM symbols. More specifically, FIG. 2 depicts the PLP0 BICM interface signal from the output port of the BBFRAME scrambler 9 being applied to the input port of apparatus 32 to generate multilevel concatenated BCH/LDPCC forward-error-correction coding. FIG. 2 depicts the output port of the apparatus 32 connected to the input port of a bit interleaver 33, the output port of which is connected for applying bit-interleaved multilevel concatenated BCH/LDPCC coding to the input port of a mapper 34 for mapping successive bits of that bit-interleaved multilevel FEC coding to successive QAM constellations. In the case of transmissions broadcast for reception by stationary DTV receivers, these QAM constellations are apt to be square 256QAM constellations or cruciform 512QAM constellations, by way of specific examples. In the case of transmissions broadcast for reception by mobile DTV receivers, these QAM constellations are apt to be square 16QAM constellations, square 64 QAM constellations or cruciform 32QAM constellations, by way of specific examples. The complex coordinates of the QAM constellations are supplied from the output port of the mapper 34 to a respective input port of the assembler 30 for assembling a stream of OFDM symbols.

FIG. 2 depicts the first physical layer pipe PLP1 further comprising elements 42-44 in cascade connection after the PLP1 BICM interface, but before a respective input port of the assembler 30 for assembling a serial stream of OFDM symbols. More specifically, FIG. 2 depicts the PLP1 BICM interface signal from the output port of the BBFRAME scrambler 19 being applied to the input port of apparatus 42 to generate multilevel concatenated BCH/LDPCC forward-error-correction coding. FIG. 2 depicts the output port of the apparatus 42 connected to the input port of a bit interleaver 43, the output port of which is connected for applying bit-interleaved multilevel concatenated BCH/LDPCC coding to the input port of a mapper 44 for mapping successive bits of that bit-interleaved multilevel FEC coding to successive QAM constellations. In the case of transmissions broadcast for reception by stationary DTV receivers, these QAM constellations are apt to be square 256QAM constellations or cruciform 512QAM constellations, by way of specific examples. In the case of transmissions broadcast for reception by mobile DTV receivers, these QAM constellations are apt to be square 16QAM constellations, square 64 QAM constellations or cruciform 32QAM constellations, by way of specific examples. The complex coordinates of the QAM constellations are supplied from the output port of the mapper 44 to a respective input port of the assembler 30 for assembling a stream of OFDM symbols.

FIG. 2 depicts the (n)th physical layer pipe PLPn further comprising elements 51-54 in cascade connection after the PLPn BICM interface, but before a respective input port of the assembler 30 for assembling a serial stream of OFDM symbols. More specifically, FIG. 2 depicts the PLPn BICM interface signal from the output port of the BBFRAME scrambler 29 being applied to apparatus 52 for generating multilevel concatenated BCH/LDPCC forward-error-correction coding. FIG. 2 depicts the output port of the apparatus 52 connected to the input port of a bit interleaver 53, the output port of which is connected for applying bit-interleaved multilevel concatenated BCH/LDPCC coding to the input port of a mapper 44 for mapping successive bits of that bit-interleaved multilevel FEC coding to successive QAM constellations. In the case of transmissions broadcast for reception by stationary DTV receivers, these QAM constellations are apt to be square 256QAM constellations or cruciform 512QAM constellations, by way of specific examples. In the case of transmissions broadcast for reception by mobile DTV receivers, these QAM constellations are apt to be square 16QAM constellations, square 64 QAM constellations or cruciform 32QAM constellations, by way of specific examples. The complex coordinates of the QAM constellations are supplied from the output port of the mapper 54 to a respective input port of the assembler 30 for assembling a stream of OFDM symbols.

FIG. 2 depicts bit interleavers 33, 43, 53 etc. for the multilevel LDPC convolutional coding supplied to the mappers 34, 44, 54 etc., respectively. The bit interleavers 33, 43, 53 etc. are homologous to bit interleavers for LDPC block coding employed in DTV transmitter apparatus complying with the DVB-T2 Standard. The bit interleavers are designed to keep the interleaved bits in their respective original levels. In a paper titled “Generalized Low-Density Parity-Check Coding Aided Multilevel Codes” R. Y. S. Tee, F. C. Kuo and L. Hanzo, School of ECS, University of Southampton, SO17 1BJ, UK asserted it to be widely recognized that as a benefit of their block-based nature and random generator matrix construction, long block codes are capable of “over-bridging” the channel fades and hence no channel interleaver is required for LDPC or generalized LDPC component codes. Presuming this to be true, the bit interleavers 33, 43, 53 etc. are apt not to be needed even for LDPCCC-MLC constituent codes although they are not block-based. This is so even though the constituent codes of the LDPCCC-MLC in each 64,800-bit FEC Frame have fewer than 64,800 bits since those codes each extend over all the 64,800 bit epochs in that FEC Frame. Furthermore, this also is likely so even though the constituent codes of the LDPCCC-MLC in each 16,200-bit short FEC Frame have fewer than 16,200 bits since those codes each extend over all the 16,200 bit epochs in that short FEC Frame. Accordingly, the bit interleaver 33 can be replaced by direct connection from the output port of the apparatus 32 to the input port of the mapper 34 to QAM symbol constellations; the bit interleaver 43 can be replaced by direct connection from the output port of the apparatus 42 to the input port of the mapper 44 to QAM symbol constellations; the bit interleaver 53 can be replaced by direct connection from the output port of the apparatus 52 to the input port of the mapper 54 to QAM symbol constellations; etc.

There is usually a number of other physical layer pipes besides PLP1, PLP2 and PLPn, which other physical pipes are identified by the prefix PLP followed by respective ones of consecutive numbers three through (n−1). Each of these PLPs, n in number, may differ from the others in at least one aspect. One possible difference between these n PLPs concerns the natures of the concatenated BCH-LDPC coding these PLPs respectively employ. ETSI standard EN 302 755 V1.3.1 for DVB-T2 specifies a block size of 64,800 bits is specified for normal FEC frames as a first alternative, and a block size of 16,200 bits is specified for short FEC frames as a second alternative. Also, a variety of different LDPC code rates are authorized. PLPs may differ in the number of OFDM carriers involved in each of their spectral samples, which affects the size of the DFT used for demodulating those OFDM carriers. Another possible difference between PLPs concerns the natures of the QAM constellations (or possibly other modulation symbol constellations) they respectively employ.

In accordance with well-known practice, it is preferable that the mappers 34, 44, 54 etc. for the PLPs provide Gray mapping of bit-interleaved LDPC coding to square QAM constellations. Cruciform QAM constellations cannot be Gray mapped exactly, but it is preferable that the mappers 34, 44, 54 etc. for the PLPs provide close-to-Gray mapping of such QAM constellations. By way of example, the cruciform QAM constellations can be 512QAM constellations provided close-to-Gray mapping as described in U.S. patent application Ser. No. 13/555,117 filed 6 Aug. 2012 for A. L. R. Limberg with the title “COFDM broadcast systems employing turbo coding”. Cruciform 32QAM constellations and cruciform 128QAM constellations with close-to-Gray mapping are also possible. Cruciform QAM constellations are advantageous in that they tend to have smaller PAPRs than square QAM constellations have. Accordingly, the PAPR reduction unit 60 is apt to be omitted, with the output port of the of the OFDM modulator 59 connecting directly to the input port of the guard-interval-and-cyclic-prefix-insertion unit 61. Transmitter apparatus is possible in which at least one of the memories in mappers 34, 44, 55 etc. is written with cruciform QAM constellations, but each other of those memories is written with square QAM constellations. In such case, the PAPR reduction unit 60 is retained.

The function of the OFDM frames assembler 30 is to assemble the complex coordinates of QAM constellations read from the mappers 34, 44, 54 etc. for each of the PLPs and the complex coordinates of QAM constellations of the modulated L1 signaling data into arrays of effective OFDM symbols to be conveyed within respective ones of T2-frames, as prescribed for DVB-T2 in ETSI standard EN 302 755 V1.3.1. Successive ones of these T2-frames, possibly with Future Extension Frame (FEF) parts interspersed among them, make up super-frames in the overall frame structure. The OFDM frames assembler 30 comprises respective buffer memories for the n PLPs and means for time-division multiplexing T2-frames from the various PLPs into an OFDM generation interface signal to be supplied to the FIG. 4 portion of the transmitter apparatus for broadcasting DTV signals. The buffer memories included in the OFDM frames assembler 30 are usually dual-ported random-access memories (RAMs). The cell interleaving procedures described in §§6.4 of ETSI standard EN 302 755 V1.3.1 and the time interleaving procedures described in §§6.5 of ETSI standard EN 302 755 V1.3.1 are subsumed into the addressing of these RAMs. The operation of the assembler 30 for assembling a serial stream of OFDM symbols takes into account the configuration of the frame structure and is further controlled responsive to the dynamic scheduling information produced by the scheduler 10. FIG. 2 does not explicitly show the connections for applying these control signals to the assembler 30. FIG. 2 shows the assembler 30 connected for receiving at an input port thereof coordinates of P2 modulation symbols supplied from apparatus depicted in FIG. 3.

The coordinates of P2 modulation symbol constellations supplied from the FIG. 3 apparatus convey the conformation of the frame structure and also convey the dynamic scheduling information (DSI) produced by the scheduler 10. FIG. 3 depicts a first-layer signal generator 20 with two input ports and two output ports. The first of the two input ports is connected for receiving DSI from the scheduler 10, and the second of the two input ports is connected for receiving digital indications specifying the conformation of the frame structure. The first output port of the first-layer (L1) signal generator 20 is connected for supplying L1-pre signaling to the input port of an encoder 35 for BCH coding, and the second output port of the first-layer signal generator 20 is connected for supplying L1-post signaling to the input port of a bit scrambler 36.

FIG. 3 shows the output port of the encoder 35 for BCH coding connected to the input port of an encoder 37 for LDPC coding. The output port of the encoder 37 connects to the input port of a puncturer 38, the output port of which connects to the input port of a mapper 39 for mapping the coded L1-pre signaling to BPSK symbol constellations. The output port of the mapper 39 connects to a first of two input ports of a time-division multiplexer 40. Details of the processing of L1-pre signaling are essentially as described in §§7.3.1.1 of ETSI standard EN 302 755 V1.3.1 for DVB-T2.

The bit scrambler 36 provides data bit randomization similar to that provided by the BBFRAME scramblers 9, 19 and 29. The output port of the bit scrambler 36 connects to the input port of an encoder 45 for CRC-8 coding, the output port of which connects to the input port of an encoder 46 for BCH coding. The output port of the encoder 46 for BCH coding is connected to the input port of an encoder 47 for LDPC coding. FIG. 3 shows the output port of the encoder 47 connected to the input port of a puncturer 59, the output port of which connects to the input port of a bit interleaver 49 similar to the bit interleavers 33, 43 and 54. The output port of the bit interleaver 49 connects to the input port of a mapper 50 for mapping the coded L1-post signaling to BPSK, QPSK, 16QAM or 64QAM constellations. The output port of the mapper 50 connects to the second input port of the time-division multiplexer 40. The puncturer 48 is optional and can be replaced by a direct connection from the output port of the encoder 47 for LDPC coding to the input port of the bit interleaver 49. Details of the processing of L1-post signaling are essentially as described in §§7.3.2 and §§7.3.3 of ETSI standard EN 302 755 V1.3.1 for DVB-T2.

The time-division multiplexer 40 is configured for generating a response therefrom that time-interleaves complex coordinates of the BPSK symbol constellations mapping respective segments of coded L1-pre signaling supplied to its first input port from the mapper 39 with the complex coordinates of the BPSK, QPSK or QAM constellations mapping respective segments of coded L1-post signaling supplied to its second input port from the mapper 50. FIG. 3 indicates that the time-division multiplexer 40 supplies the complex coordinates of P2 symbols in its response to a respective input port of the assembler 30 of OFDM symbols depicted in FIG. 2.

A transmission signal in an OFDM broadcast system is transmitted in successive segments called OFDM symbol blocks. Each OFDM symbol block includes an interval during which an effective symbol is supplied for inverse discrete Fourier transformation (I-DFT), and further includes a guard interval into which the waveform of a part of the latter half of this effective symbol will be directly copied. This guard interval is provided in the initial half of the OFDM symbol block. In an OFDM system, such a guard interval is provided to improve performance during multi-path reception. A plurality of OFDM symbol blocks are collected to form one OFDM transmission frame. For example, in the ISDB-T standard, ten OFDM transmission frames are formed by a succession of two hundred four OFDM symbol blocks. Insertion positions of pilot signals are set with this unit of OFDM transmission frames as a reference.

FIG. 4 depicts apparatus that generates and transmits radio-frequency COFDM signals responsive to the stream of OFDM symbols supplied via an OFDM generation interface from the output port of the assembler 30 for assembling a serial stream of OFDM symbols, which assembler 30 is depicted in FIG. 2. The output port of the assembler 30 connects to the input port of a parser 55 for effective OFDM symbol blocks, which parser 55 is depicted in FIG. 4. The block parser 55 parses the serial stream of OFDM symbols into uniform-length sequences of samples, each of which sequences is associated with a respective effective OFDM symbol. The output port of the block parser 55 is connected to a first input port of a pilot carriers insertion unit 56. ETSI standard EN 302 755 V1.3.1 identifies a number of different patterns regarding the insertion of pilot carriers into the frequency spectrum of the transmission channel, any one of which may be used for a PLP in DVB-T2.

In a departure from customary practice in COFDM broadcast transmitters, the output port of the pilot carriers insertion unit 56 is connected for supplying the effective OFDM symbol blocks with pilot carriers inserted therein to the write input port of a dual-port random-access memory 57, rather than supplying them directly to the input port of a subsequent OFDM modulator 59. The dual-port RAM 57 has temporary storage capability for coordinates of modulation symbol constellations extending over a plurality 2N in number of T2 frames plus an additional time-slice interval, N being an integer one or more. The complex coordinates of modulation symbol constellations written into the RAM 57 a number 2N of T2 frames before being read therefrom as part of a read-and-immediately-write-over procedure. The complex coordinates of modulation symbol constellations read from the RAM 57 as part of each read-and-immediately-write-over procedure are used to support the delayed final transmission of a time-slice, which takes place during an odd-numbered one of consecutive time-slice intervals. The addressing of the RAM 57 for the reading portion of each read-and-immediately-write-over procedure is the same as for the over-writing portion of that procedure. During an even-numbered one of the consecutive time-slice intervals beginning a number N of T2 frames minus a time-slice interval after the time slice has been written, the complex coordinates of modulation symbol constellations from the time-slice temporarily stored the a plurality N of T2 frames before are read from the RAM 57 to support the initial transmission of the time-slice to be re-transmitted the number 2N of T2 frames plus a time-slice interval later in time. The read-outs from the RAM 57, both to support the initial transmission of the time-slice and to support the final transmission of the time-slice, are supplied to a first of two input ports of a scheduler 58 for one-time transmissions and repeated transmissions of time-slices.

Time-slices that are to be repeated to permit iterative-diversity reception are routed from the output port of the pilot carriers insertion unit 56 through the RAM 57 to the first input port of the scheduler 58, and the scheduler 58 is conditioned to reproduce these time-slices at its output port. The output port of the pilot carriers insertion unit 56 is further connected for supplying the effective OFDM symbol blocks with pilot carriers inserted therein to the second input port of the scheduler 58. Time-slices supplied from the output port of the pilot carriers insertion unit 56 that are to be transmitted only one time are not written into the RAM 57. The scheduler 58 is conditioned to reproduce at its output port those time-slices supplied to its second input port that are to be transmitted only one time. The output port of the scheduler 58 connects to the input port of the OFDM modulator 59. The addressing of the RAM 57, the scheduling of one-time transmissions and repeated transmissions of time-slices by the scheduler 58, the assembly of the serial stream of COFDM symbols by the assembler 30, and the scheduling of time-slices by the scheduler 10 are performed in concert responsive to control signals from a master controller not explicitly depicted in FIGS. 1, 2, 3 and 4.

FIG. 4 depicts the OFDM modulator 59 as having 1 K, 2K, 4K, 8K, 16K or 32K carriers capability. That is, DFT size can be 1 K, 2K, 4K, 8K, 16K or 32K. The 8K, 16K and 32K sizes of DFT are suitable for transmissions to stationary DTV receivers. Transmissions to mobile receivers are apt to employ smaller DFT size, 4K generally being preferred. The 1K DFT size is employed only when sending indications of the beginnings of T2 frames.

The OFDM modulator 59 includes a serial-to-parallel converter for converting the serially generated complex digital samples of the effective OFDM symbols to parallel complex digital samples for inverse discrete Fourier transformation (I-DFT). The OFDM modulator 59 further includes a parallel-to-serial converter for converting the parallel complex digital samples of the I-DFT results to serial complex digital samples of the I-DFT results. FIG. 4 shows a connection for applying digital samples supplied from the output port of the OFDM modulator 59 to the input port of a peak-to-average-power-ratio (PAPR) reduction unit 60.

ETSI standard EN 302 755 V1.3.1 includes two methods for reducing PAPR in DVB-T2 that allow about a 20% reduction in peak amplifier power rating, which can save significantly on electricity costs for operating a broadcast station. In the first method, called “tone reservation”, 1% of the OFDM carriers are reserved and do not carry any data, but instead may be used for inserting values that will counteract the peaks in the signal. In the second method, called “active constellation extension”, the values of certain of the edge constellation points are moved “outward” in such way as to reduce the signal peaks. Since only edge constellation points are ever moved outward, their movement has no significant impact on the ability of the DTV receiver to decode the data.

The output port of the PAPR reduction unit 60 is connected to the input port of a guard-interval-and-cyclic-prefix-insertion unit 61. The output port of the guard-interval-and-cyclic-prefix insertion unit 61 is connected to the input port of a unit 62 for inserting preamble-1 (P1) symbols into the digital data stream. The output port of the P1 symbols insertion unit 62 connects to the input port of a digital-to-analog converter 63, the output port of which is connected for supplying analog COFDM carriers to the input port of an up converter 64. The up converter 64 converts the analog COFDM carriers in the DAC 63 response to final radio frequencies and is connected for supplying them from its output port to the input port of a linear power amplifier 65. FIG. 4 shows the output port of the linear power amplifier 65 connected for driving RF analog COFDM signal power to a transmission antenna 66. FIG. 4 omits showing some details of the DTV transmitter, such as band-shaping filters for the RF signals.

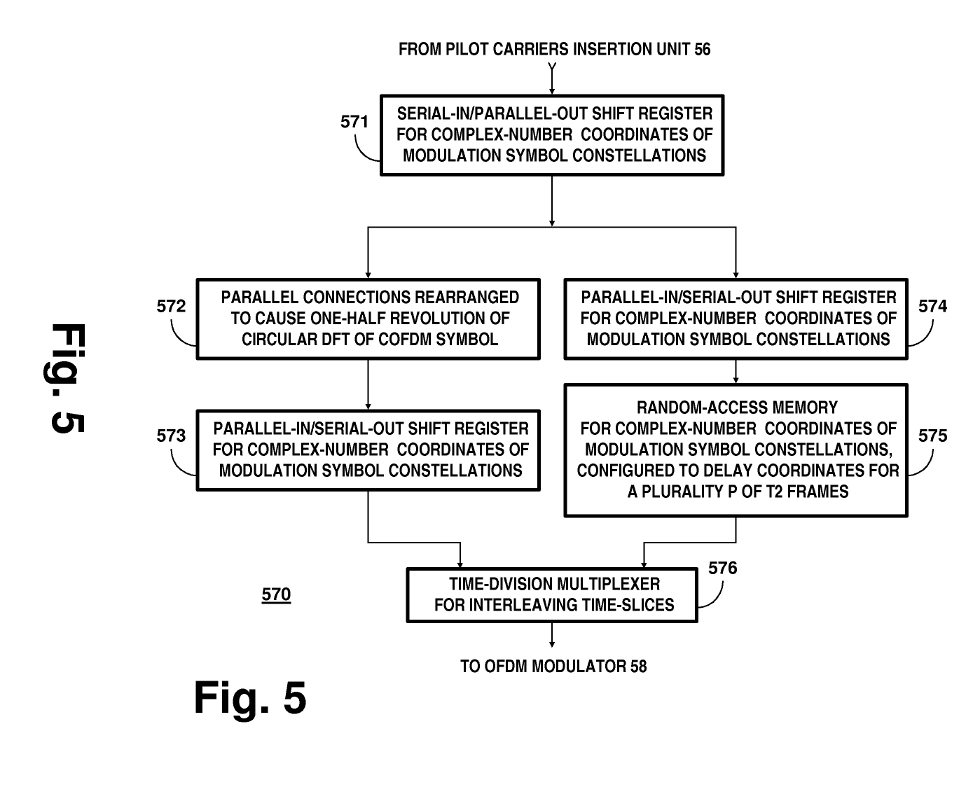

FIG. 5 depicts a memory structure 570 that replaces the FIG. 4 memory 57 in alternative DTV transmitter apparatus that embodies aspects of the invention. The FIG. 5 memory structure 570 has latent delay smaller than that exhibited by the FIG. 4 memory 57, reducing the delay of FEC coded DTV data before the initial transmission thereof by almost N times a T2 frame interval. The response of the pilot carriers insertion unit 56 is supplied to the input port of a serial-in/parallel-out (SIPO) shift register 571 in the FIG. 5 memory structure 570. The number of parallel bit streams from the multiple-connection output port of the SIPO shift register 571 is such as to comprehend all the bits in a complex COFDM symbol. Parallel connections 572 rearrange these parallel bit streams for application to the multiple-connection input port of a parallel-in/serial-out (PISO) shift register 573. The rearrangement is such as to rotate the circular DFT of the COFDM symbol by one-half revolution. That is, the PISO shift register 573 supplies a serial bitstream from its output port that reproduces the final half of each COFDM symbol supplied to the input port of the SIPO shift register 571 before reproducing the initial half of each COFDM symbol supplied to the input port of the SIPO shift register 571. This bitstream is subsequently used in the initial transmissions conveying FEC-coded data for iterative-diversity reception.

The bitstream to be used in the final transmissions conveying FEC-coded data for iterative-diversity reception is generated by the FIG. 5 memory structure, using a further parallel-in/serial-out (PISO) shift register 574 and a random-access memory (RAM) 575. The multiple-connection output port of the SIPO shift register 571 connects to the multiple-connection input port of the SIPO shift register 574. The SIPO shift register 574 supplies a serial bitstream from its output port that reproduces of each COFDM symbol supplied to the input port of the SIPO shift register 571, without altering the order of the bits therein. The total latent delay of COFDM symbols processed through the shift registers 571 and 574 compensates for latent delay of COFDM symbols processed through the shift registers 571 and 573, except for the half-revolution of DFT of COFDM symbols introduced by rearrangement of bit streams in the parallel connections 572. The RAM 575 is configured to delay the COFDM symbols reproduced at the output port of the SIPO shift register 574 further, delaying them by the number N of T2 frame intervals.

FIG. 5 depicts a time-division multiplexer 576 for interleaving time slices for inclusion in the earlier transmissions for iterative-diversity reception with time slices for inclusion in the earlier transmissions for iterative-diversity reception. The output port of the SIPO shift register 573 is connected for supplying the time-slices for inclusion in the earlier transmissions for iterative-diversity reception to a first of two input ports of the time-division multiplexer 576. A read-output port of the RAM 575 is connected for supplying the second input port of the time-division multiplexer 576 with delayed time-slices for inclusion in the later transmissions for iterative-diversity reception. The output port of the time-division multiplexer 576 connects to the input port of the OFDM modulator 59. The time-interleaving introduced by time-division multiplexer 576 in the FIG. 5 memory structure delays the COFDM symbols with rotated circular DFT an extra time-slice interval compared to the COFDM symbols with non-rotated circular DFT, which differential delay is preferably accomplished by suitable addressing of the RAM 575 rather than by an additional delay element within the multiplexer 576.

In a modification of what is depicted in FIG. 5, the time-division multiplexer 576 is replaced by tri-state buffering at the output ports of the PISO shift register 573 and the RAM 575. In another modification of what is depicted in FIG. 5, the RAM 575 is written to in parallel with writing to the input port of the SIPO shift register 571, and the PISO shift register 574 is dispensed with. The addressing of the RAM 575 is adjusted for properly interleaving the COFDM symbols with rotated circular DFT and the COFDM symbols with non-rotated circular DFT.

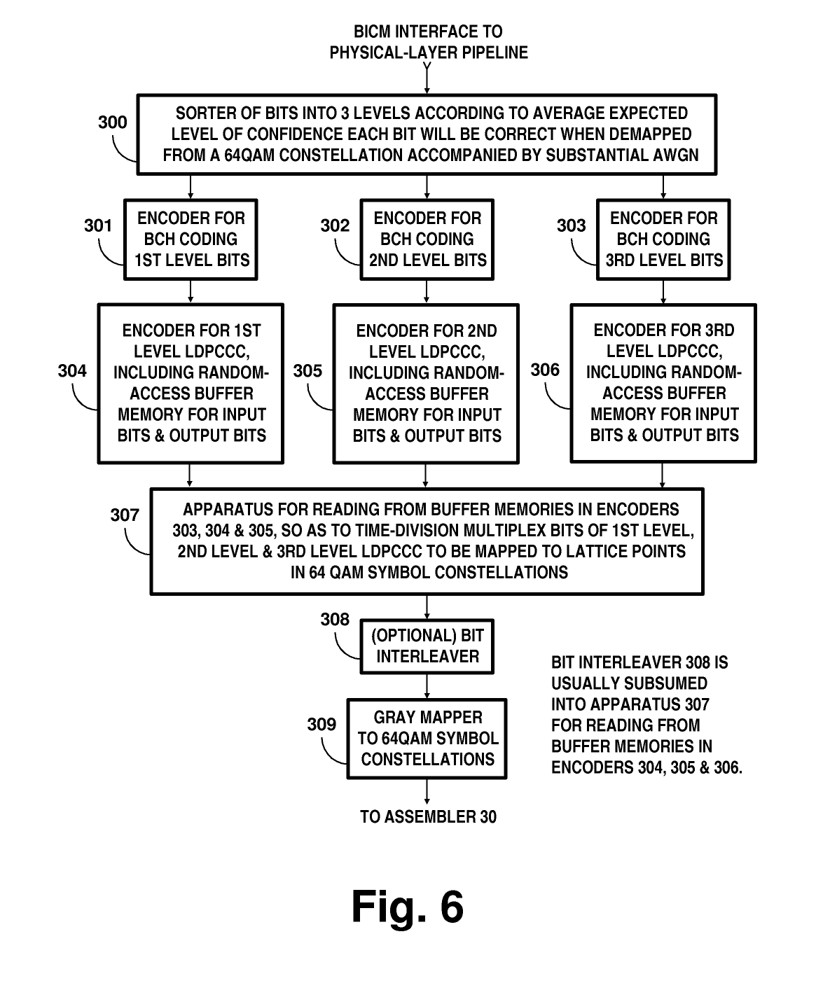

FIG. 6 shows in more detail a first embodiment of the concluding portion of one of the PLPs in the FIG. 2 portion of COFDM transmitter apparatus for encoding LDPCCC-MLC designed for being mapped into 64QAM constellations. The output port of a BB Frame scrambler in the beginning portion of that PLP is connected for supplying BICM interface signal to the input port of a sorter 300 of successive bits of BICM interface signal into groups cyclically assigned to three levels according to the average expected level of confidence that each bit will be correct when the DTV receiver de-maps those bits from a 64QAM constellation accompanied by substantial AWGN. The groups of bits assigned to the first level each consist of a prescribed number of bits larger than a prescribed number of bits that groups of bits assigned to the second level each consist of. The groups of bits assigned to the second level each consist of a prescribed number of bits larger than a prescribed number of bits that groups of bits assigned to the third level each consist of.

An encoder 301 for BCH coding first-level bits shown in FIG. 6 is a first component of the one of the apparatuses 32, 42, 52 etc. shown in FIG. 2 that resides in the PLP under consideration and is used for generating multilevel concatenated BCH/LDPCC forward-error-correction coding. A first output port of the sorter 300 is connected for supplying the input port of the encoder 301 the bits of the level of BICM interface signal least likely to exhibit AWGN-caused error in the results of de-mapping 64QAM constellations in the DTV receiver. An encoder 302 for BCH coding second-level bits shown in FIG. 6 is a second component of the one of the apparatuses 32, 42, 52 etc. that resides in the PLP under consideration. A second output port of the sorter 300 is connected for supplying the input port of the encoder 302 the bits in the level of BICM interface signal more likely, but not most likely, to exhibit AWGN-caused error in the results of de-mapping 64QAM constellations in the DTV receiver. An encoder 303 for BCH coding third-level bits shown in FIG. 6 is a third component of the one of the encoders 32, 42, 52 etc. that resides in the PLP under consideration. A third output port of the sorter 300 is connected for supplying the input port of the encoder 303 the bits of BICM interface signal most likely to exhibit AWGN-caused error in the results of de-mapping 64QAM constellations in the DTV receiver.

The output port of the encoder 301 for BCH coding connects to the input port of an encoder 304 for the first level of LDPCCC, to deliver to the encoder 304 the bits in the level of BCH coding least likely to exhibit AWGN-caused error in the results of de-mapping 64QAM constellations in the DTV receiver. The bits in this first level of LDPCCC are those that change least frequently in the in-phase direction as mapped within 64QAM constellations and those that change least frequently in the quadrature-phase direction as mapped within 64QAM constellations. The output port of the encoder 302 for BCH coding connects to the input port of an encoder 305 for the second level of LDPCCC, to deliver to the encoder 305 the bits of in the level of BCH coding next more likely (but not most likely) to exhibit AWGN-caused error in the results of de-mapping 64QAM constellations in the DTV receiver. The output port of the encoder 303 for BCH coding connects to the input port of an encoder 306 for the third level of LDPCCC, to deliver to the encoder 306 the bits of BCH coding most likely to exhibit AWGN-caused error in the results of de-mapping 64QAM constellations in the DTV receiver. The bits in this third level of LDPCCC are those that change most frequently in the in-phase direction as mapped within 64QAM constellations and those that change most frequently in the quadrature-phase direction as mapped within 64QAM constellations.

Each of the encoders 304, 305 and 306 includes a respective random-access buffer memory for temporarily storing, row by row, the bits of BCH coding that encoder receives as input signal during each successive FEC frame. This random-access buffer memory is addressed so as to introduce the column-twist associated with a respective level of the LDPC convolutional coding procedure. Furthermore, this random-access buffer memory temporarily stores rows of LDPCCC parity bits generated for each successive FEC frame. Apparatus 307 arranges for time-division-multiplexed reading from the random-access buffer memories included in the encoders 304, 305 and 306 after all those encoders finish LDPC convolutional coding their respective levels of BCH coding in an FEC frame. The apparatus 307 generates or helps generate successive Gray labels for specifying lattice points in a 64QAM symbol constellation. Each Gray label is generated responsive to two bits of a first-level LDPCCC codeword read from the buffer memory of encoder 304, two bits of a second-level LDPCCC codeword read from the buffer memory of encoder 305 and two bits of a third-level LDPCCC codeword read from the buffer memory of encoder 306.

FIG. 6 shows the output port of the bit interleaver 308 connected to supply interleaved bits to the input port of a mapper 309 for Gray mapping those bits to 64QAM symbol constellations. The bit interleaver 308 corresponds to one of the bit interleavers 33, 43, 53 etc. shown in FIG. 2; and the mapper 309 corresponds to the succeeding one of the mappers 34, 44, 54 etc. further shown in FIG. 2. FIG. 6 shows the bit interleaver 308 as a separate element to make it easier for the reader to understand the multilevel coding procedures. However, in actual practice the apparatus 307 is apt to arrange the addressing of the random-access buffer memories included in the encoders 304, 305 and 306 so as to subsume the function of the bit interleaver 308 within the reading of output bits from those random-access buffer memories. FIG. 6 indicates that the bit interleaver 308 is optional. If the bit interleaver 308 is omitted, the apparatus 307 arranges time-division multiplexing to read the LDPCCC parity bits for each FEC frame directly to the input port of the mapper 309, which is done close to the conclusion of that FEC frame. In any case, the apparatus 307 arranges the addressing of the random-access buffer memories included in the encoders 304, 305 and 306 such that the LDPCCC parity bits for the first, second and third levels of systematic bits and BCH coding parity bits are transmitted in the same levels as in the same levels as the systematic bits and BCH coding parity bits to which they respectively pertain.

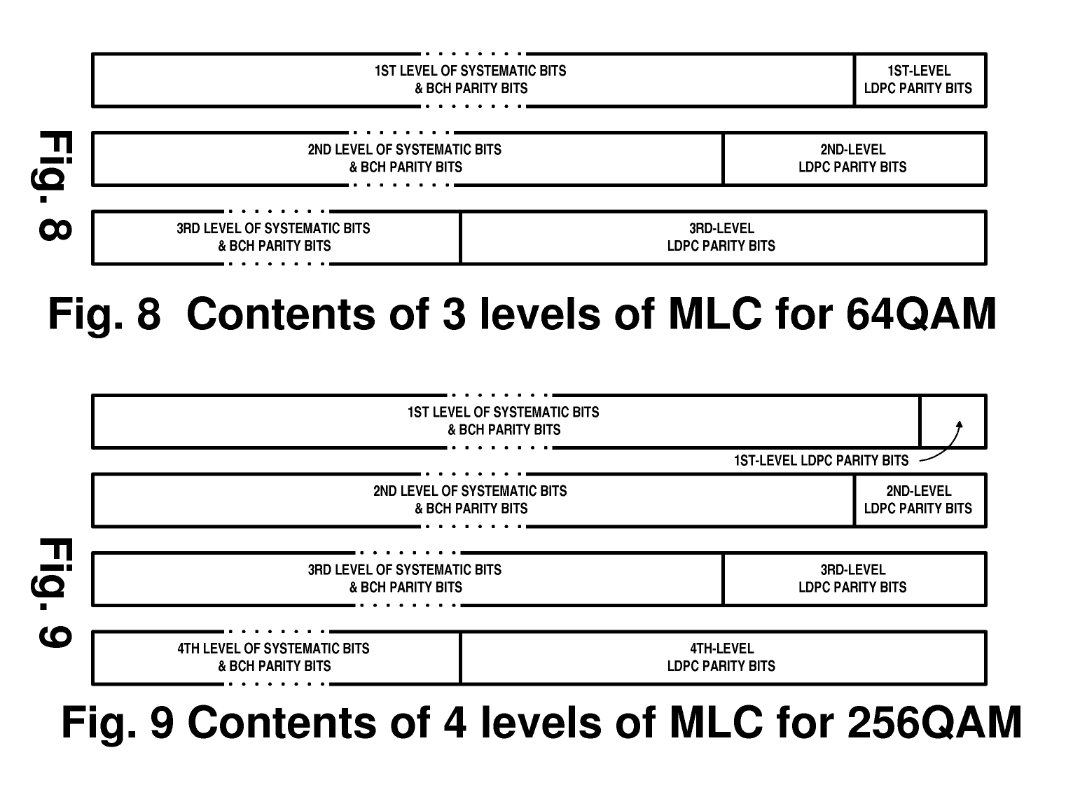

FIG. 8 illustrates the nature of the constituent LDPCCC codewords stored in the buffer memories of the encoders 304, 305 and 306. In LDPCCC-MLC per FIGS. 6 and 8 there are many more LDPCCC parity bits for the third level of systematic bits and BCH coding parity bits than for the second level of systematic bits and BCH coding parity bits, and there are many more LDPCCC parity bits for the second level of systematic bits and BCH coding parity bits than for the first level of systematic bits and BCH coding parity bits. The uppermost of the blocks in FIG. 8 (as viewed from the right side of the page) shows successive ones of the first level of systematic bits and BCH coding parity bits, followed by the first-level LDPCCC parity bits. Successive pairs of bits in the first level of LDPCCC specify the quadrants within the 64QAM constellations those pairs of bits are mapped to by the Gray mapper 309. The middle one of the three blocks in FIG. 8 (as viewed from the right side of the page) shows successive ones of the second level of systematic bits and BCH coding parity bits, followed by the second-level LDPCCC parity bits. Successive pairs of bits in the second level of LDPCCC specify the sub-quadrants of the quadrants within the 64QAM constellations that successive pairs of bits in the second level of LDPCCC are mapped to by the Gray mapper 309. The lowermost one of the blocks in FIG. 8 (as viewed from the right side of the page) shows successive ones of the third level of systematic bits and BCH coding parity bits, followed by the third-level LDPCCC parity bits. as arranged for being mapped to a third set of lattice points in each of the point lattices mapped to respective ones of 64QAM constellations for inverse Fourier transformation to a COFDM signal. Successive pairs of bits in the third level of LDPCCC specify the sub-sub-quadrants of the sub-quadrants of the quadrants within the 64QAM constellations that successive pairs of bits in the third level of LDPCCC are mapped to by the Gray mapper 309.

FIG. 8 suggests the number of first-level LDPCCC parity bits, the number of second-level LDPCCC parity bits and the number of third-level LDPCCC parity bits being in 1:2:4 ratio. This set of ratios is roughly based on the likelihood of error in each level owing to additive white Gaussian noise (AWGN). The component ratios are apt to be optimized over the course of time, based on extensive computer simulation of noise conditions.

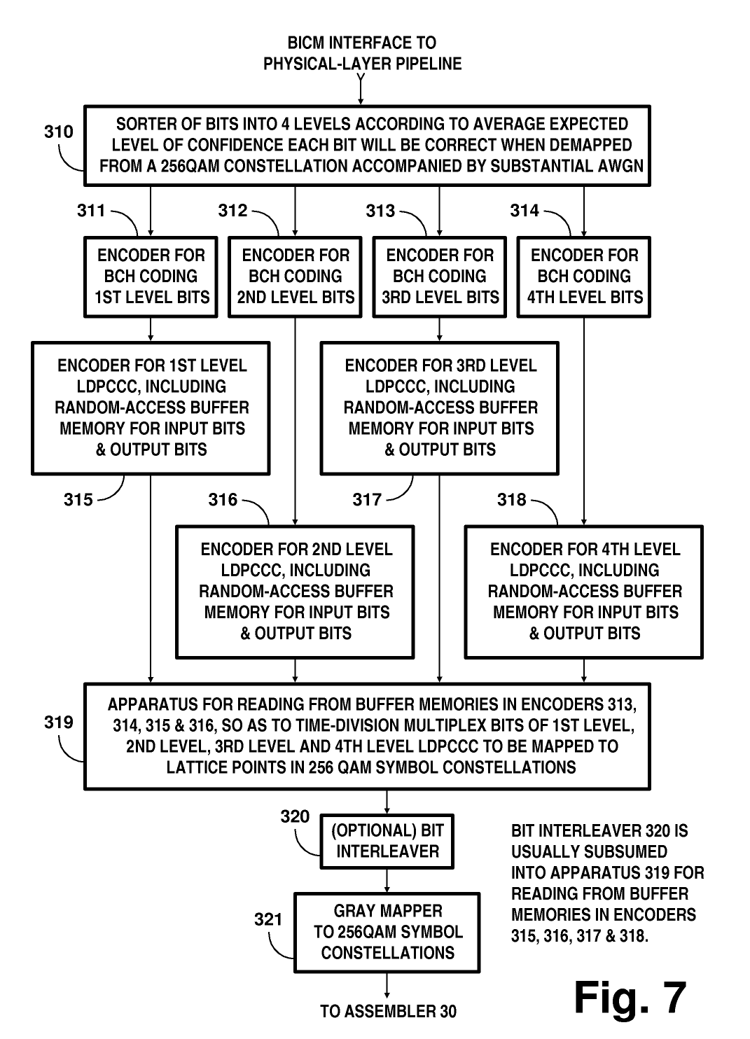

FIG. 7 shows in more detail a second embodiment of the concluding portion of one of the PLPs in the FIG. 2 portion of COFDM transmitter apparatus for encoding LDPCCC-MLC designed for being mapped into 256QAM constellations. The output port of a BB Frame scrambler in the beginning portion of that PLP is connected for supplying BICM interface signal to the input port of a sorter 310 of successive bits of BICM interface signal into groups cyclically assigned to four levels according to the average expected level of confidence that each bit will be correct when the DTV receiver de-maps those bits from a 256QAM constellation accompanied by substantial AWGN. The groups of bits assigned to the first level each consist of a prescribed number of bits larger than a prescribed number of bits that groups of bits assigned to the second level each consist of. The groups of bits assigned to the second level each consist of a prescribed number of bits larger than a prescribed number of bits that groups of bits assigned to the third level each consist of. The groups of bits assigned to the third level each consist of a prescribed number of bits larger than a prescribed number of bits that groups of bits assigned to the fourth level each consist of.

An encoder 311 for BCH coding first-level bits shown in FIG. 7 is a first component of the one of the encoders 32, 42, 52 etc. shown in FIG. 2 that resides in the PLP under consideration and is used for generating multilevel concatenated BCH/LDPCC forward-error-correction coding. A first output port of the sorter 310 is connected for supplying the input port of the encoder 311 the bits of the level of BICM interface signal least likely to exhibit AWGN-caused error in the results of de-mapping 256QAM constellations in the DTV receiver. An encoder 312 for BCH coding second-level bits shown in FIG. 7 is a second component of the one of the encoders 32, 42, 52 etc. shown in FIG. 2 that resides in the PLP under consideration. A second output port of the sorter 310 is connected for supplying the input port of the encoder 312 the bits in the level of BICM interface signal more likely, but not most likely, to exhibit AWGN-caused error in the results of de-mapping 256QAM constellations in the DTV receiver. An encoder 313 for BCH coding third-level bits shown in FIG. 7 is a third component of the one of the encoders 32, 42, 52 etc. shown in FIG. 2 that resides in the PLP under consideration. A third output port of the sorter 310 is connected for supplying the input port of the encoder 313 the bits of BICM interface signal still more likely to exhibit AWGN-caused error in the results of de-mapping 256QAM constellations in the DTV receiver. An encoder 314 for BCH coding fourth-level bits shown in FIG. 7 is a fourth component of the one of the encoders 32, 42, 52 etc. shown in FIG. 2 that resides in the PLP under consideration. A fourth output port of the sorter 310 is connected for supplying the input port of the encoder 314 the bits of BICM interface signal most likely to exhibit AWGN-caused error in the results of de-mapping 256QAM constellations in the DTV receiver.

The output port of the encoder 311 for BCH coding connects to the input port of an encoder 315 for the first level of LDPCCC, to deliver to the encoder 315 the bits in the level of BCH coding least likely to exhibit AWGN-caused error in the results of de-mapping 256QAM constellations in the DTV receiver. The bits in this first level of LDPCCC are those that change least frequently in the in-phase direction as mapped within 256QAM constellations and those that change least frequently in the quadrature-phase direction as mapped within 256QAM constellations. The output port of the encoder 312 for BCH coding connects to the input port of an encoder 316 for the second level of LDPCCC, to deliver to the encoder 316 the bits of in the level of BCH coding next more likely to exhibit AWGN-caused error in the results of de-mapping 256QAM constellations in the DTV receiver. The output port of the encoder 313 for BCH coding connects to the input port of an encoder 317 for the third level of LDPCCC, to deliver to the encoder 317 the bits of BCH coding most likely to exhibit AWGN-caused error in the results of de-mapping 64QAM constellations in the DTV receiver. The output port of the encoder 314 for BCH coding connects to the input port of an encoder 318 for the fourth level of LDPCCC, to deliver to the encoder 318 the bits of BCH coding most likely to exhibit AWGN-caused error in the results of de-mapping 64QAM constellations in the DTV receiver. The bits in this fourth level of LDPCCC are those that change most frequently in the in-phase direction as mapped within 256QAM constellations and those that change most frequently in the quadrature-phase direction as mapped within 256QAM constellations.

Each of the encoders 315, 316, 317 and 318 includes a respective random-access buffer memory for temporarily storing, row by row, the bits of BCH coding that encoder receives as input signal during each successive FEC frame. This random-access buffer memory is addressed so as to introduce the column-twist associated with a respective level of the LDPCCC procedure. Furthermore, this random-access buffer memory temporarily stores rows of LDPCCC parity bits generated for each successive FEC frame. Apparatus 319 arranges for time-division-multiplexed reading from the random-access buffer memories included in the encoders 315, 316, 317 and 318 after all those encoders finish LDPC convolutional coding their respective levels of BCH coding in an FEC frame. The apparatus 319 generates or helps generate successive Gray labels for specifying lattice points in a 256QAM symbol constellation. Each Gray label is generated responsive to two bits of a first-level LDPCCC codeword read from the buffer memory of encoder 315, two bits of a second-level LDPCCC codeword read from the buffer memory of encoder 316, two bits of a third-level LDPCCC codeword read from the buffer memory of encoder 317, and two bits of a fourth-level LDPCCC codeword read from the buffer memory of encoder 318.

FIG. 7 shows the output port of the bit interleaver 320 connected to supply interleaved bits to the input port of the mapper 321 for Gray mapping those bits to 256QAM symbol constellations. The bit interleaver 320 corresponds to one of the bit interleavers 33, 43, 53 etc. shown in FIG. 2; and the mapper 321 corresponds to the succeeding one of the mappers 34, 44, 54 etc. further shown in FIG. 2. FIG. 7 shows the bit interleaver 320 as a separate element to make it easier for the reader to understand the multilevel coding procedures. However, in actual practice the apparatus 317 is apt to arrange the addressing of the random-access buffer memories included in the encoders 313, 314, 315 and 316 so as to subsume the function of the bit interleaver 320 within the reading of output bits from those random-access buffer memories. FIG. 7 indicates that the bit interleaver 320 is optional. If the bit interleaver 320 is omitted, the apparatus 319 arranges time-division multiplexing to read the LDPCCC parity bits for each FEC frame directly to the input port of the mapper 321 at the conclusion of that FEC frame. In any case, the apparatus 319 arranges the addressing of the random-access buffer memories included in the encoders 315, 316, 317 and 318 such that the LDPCCC parity bits for the first, second, third and fourth levels of systematic bits and BCH coding parity bits are transmitted in the same levels as the systematic bits and BCH coding parity bits to which they respectively pertain.

FIG. 9 illustrates one example of such practice. In LDPCCC-MLC per FIG. 7 there are many more LDPCCC parity bits for the fourth level of systematic bits and BCH coding parity bits than for the third level of systematic bits and BCH coding parity bits, there are many more LDPCCC parity bits for the third level of systematic bits and BCH coding parity bits than for the second level of systematic bits and BCH coding parity bits, and there are many more LDPCCC parity bits for the second level of systematic bits and BCH coding parity bits than for the first level of systematic bits and BCH coding parity bits. The uppermost of the blocks in FIG. 9 (as viewed from the right side of the page) shows successive ones of the first level of systematic bits and BCH coding parity bits followed by the first-level LDPCCC parity bits, as arranged for being mapped to a first set of lattice points in each of the point lattices mapped to respective ones of 256QAM constellations for inverse Fourier transformation to a COFDM signal. The next-to-uppermost one of the blocks in FIG. 9 (as viewed from the right side of the page) shows successive ones of the second level of systematic bits and BCH coding parity bits, followed by the second-level LDPCCC parity bits, as arranged for being mapped to a second set of lattice points in each of the point lattices mapped to respective ones of 256QAM constellations for inverse Fourier transformation to a COFDM signal. The next-to-lowest one of the blocks in FIG. 9 (as viewed from the right side of the page) shows successive ones of the third level of systematic bits and BCH coding parity bits, followed by the third-level LDPCCC parity bits, as arranged for being mapped to a third set of lattice points in each of the point lattices mapped to respective ones of 256QAM constellations for inverse Fourier transformation to a COFDM signal. The lowermost one of the blocks in FIG. 8 (as viewed from the right side of the page) shows successive ones of the fourth level of systematic bits and BCH coding parity bits, followed by the fourth-level LDPCCC parity bits, as arranged for being mapped to a fourth set of lattice points in each of the point lattices mapped to respective ones of 256QAM constellations for inverse Fourier transformation to a COFDM signal.

FIG. 9 suggests the number of first-level LDPCCC parity bits, the number of second-level LDPCCC parity bits, the number of third-level LDPCCC parity bits and the number of fourth-level LDPCCC parity bits being in 1:2:4:8 ratio. This set of ratios is roughly based on the likelihood of error in each level owing to AWGN. These ratios are apt to be optimized over the course of time, based on extensive computer simulation of noise conditions encountered in the field.

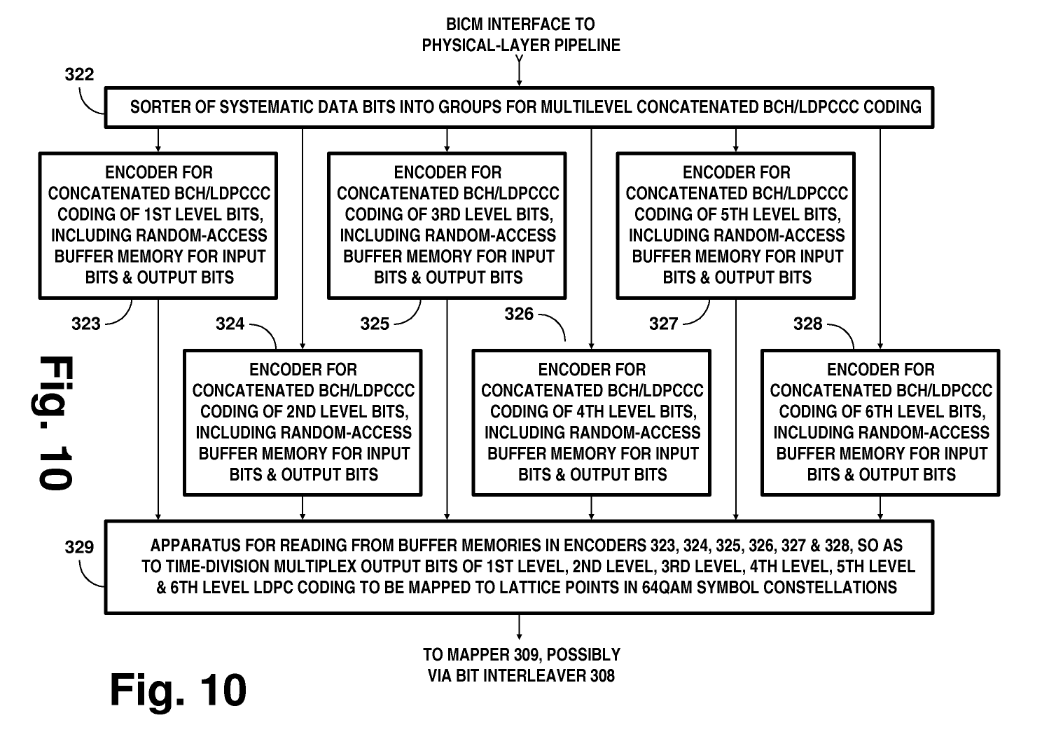

FIG. 10 shows in more detail a third embodiment of a part of the FIG. 2 portion of COFDM transmitter apparatus for encoding multilevel concatenated BCH/LDPCCC, which multilevel coding is designed for being mapped into 64QAM constellations. The FIG. 10 third embodiment of this part of the FIG. 2 portion of COFDM transmitter apparatus is essentially a modification of the FIG. 6 first embodiment of this part of the FIG. 2 portion of COFDM transmitter apparatus. In this modification the three levels of systematic data bits are each subdivided into two halves for separate concatenated BCH/LDPCCC. Arranging for six levels of multilevel concatenated BCH/LDPCCC, rather than just three levels, fosters additional parallelism when decoding that coding in the DTV receiver. FIG. 10 indicates that systematic data bits from the BICM interface are supplied to the input port of a sorter 322 for sorting bits successive bits of the BICM interface into groups cyclically assigned to respective ones of six levels according to how they will map into 64QAM symbol constellations. The groups of bits assigned to the first and fourth levels each consist of a prescribed number of bits larger than a prescribed number of bits that groups of bits assigned to the second and fifth levels each consist of. The groups of bits assigned to the second and fifth levels each consist of a prescribed number of bits larger than a prescribed number of bits that groups of bits assigned to the third and sixth levels each consist of.

The first, second and third levels of bits are those unaffected by data-slicing errors when determining the in-phase coordinates of the 64QAM symbol constellations during de-mapping procedures in the DTV receiver. The first level of bits are those that change least frequently across the range of quadrature-phase coordinates of the 64QAM symbol constellations, and the third level of bits are those that change most frequently across that range. Accordingly, the first, second and third levels of bits are sorted according to the average expected level of confidence that each bit will be correct when the DTV receiver de-maps those bits from a 64QAM constellation accompanied by substantial AWGN. A first output port of the sorter 322 connects to the input port of an encoder 323 for the first level of concatenated BCH/LDPCCC, to deliver to the encoder 323 a first of the two sets of systematic data bits least likely to exhibit AWGN-caused error in the results of de-mapping 64QAM constellations in the DTV receiver. A second output port of the sorter 322 connects to the input port of an encoder 324 for the second level of concatenated BCH/LDPCCC, to deliver to the encoder 324 a first of the two sets of systematic data bits next more likely to exhibit AWGN-caused error in the results of de-mapping 64QAM constellations in the DTV receiver. A third output port of the sorter 322 connects to the input port of an encoder 325 for the third level of concatenated BCH/LDPCCC, to deliver to the encoder 325 a first of the two sets of bits of systematic data bits most likely to exhibit AWGN-caused error in the results of de-mapping 64QAM constellations in the DTV receiver.

The fourth, fifth and sixth levels of bits are those unaffected by data-slicing errors when determining the quadrature-phase coordinates of the 64QAM symbol constellations during de-mapping procedures in the DTV receiver. The fourth level of bits are those that change least frequently across the range of in-phase coordinates of the 64QAM symbol constellations, and the sixth level of bits are those that change most frequently across that range. Accordingly, the fourth, fifth and sixth levels of bits are sorted according to the average expected level of confidence that each bit will be correct when the DTV receiver de-maps those bits from a 64QAM constellation accompanied by substantial AWGN. A fourth output port of the sorter 322 connects to the input port of an encoder 326 for the fourth level of concatenated BCH/LDPCCC, to deliver to the encoder 326 the second set of systematic data bits least likely to exhibit AWGN-caused error in the results of de-mapping 64QAM constellations in the DTV receiver. A fifth output port of the sorter 302 connects to the input port of an encoder 327 for the fifth level of concatenated BCH/LDPCCC, to deliver to the encoder 327 the second set of systematic data bits next more likely to exhibit AWGN-caused error in the results of de-mapping 64QAM constellations in the DTV receiver. A sixth output port of the sorter 322 connects to the input port of an encoder 328 for the sixth level of concatenated BCH/LDPCCC, to deliver to the encoder 328 the second set of systematic data bits most likely to exhibit AWGN-caused error in the results of de-mapping 64QAM constellations in the DTV receiver.

Each of the encoders 323, 324, 325, 326, 327 and 328 can be thought of as comprising a respective encoder for BCH coding of systematic data bits followed in cascade by a respective encoder for LDPC convolutional coding of the BCH coding for that level, although in practice the BCH and LDPCCC coding procedures are apt to be performed by a microprocessor. Each of the encoders 323, 324, 325, 326, 327 and 328 includes a respective random-access buffer memory for temporarily storing, row by row, the bits of BCH coding that one of these encoders generates prior to LDPCCC coding during each successive FEC frame. This random-access buffer memory is addressed so as to introduce the column-twist associated with a respective level of the LDPCCC coding procedure. Furthermore, this buffer memory temporarily stores rows of LDPCCC parity bits for each successive FEC frame that are generated by the encoder including that buffer memory. Apparatus 329 arranges for time-division-multiplexed reading from the random-access buffer memories included in the encoders 323, 324, 325, 326, 327 and 328 after those encoders finish LDPCCC coding their respective levels of BCH coding of an FEC frame. The apparatus 329 generates or helps generate successive Gray labels for specifying lattice points in a 64QAM symbol constellation. Each Gray label is generated responsive to a bit of a first-level LDPCCC codeword read from the buffer memory of encoder 323, a bit of a second-level LDPCCC codeword read from the buffer memory of encoder 324, a bit of a third-level LDPCCC codeword read from the buffer memory of encoder 325, a bit of a fourth-level LDPCCC codeword read from the buffer memory of encoder 326, a bit of a fifth-level LDPCCC codeword read from the buffer memory of encoder 327 and a bit of a sixth-level LDPCCC codeword read from the buffer memory of encoder 328.

In actual practice the apparatus 329 is apt to arrange the addressing of the random-access buffer memories included in the encoders 323, 324, 325, 326, 327 and 328 so as to subsume the function of the bit interleaver 308 within the reading of output bits from those random-access buffer memories. If the bit interleaver 308 is omitted, the apparatus 329 arranges time-division multiplexing to read the LDPCCC parity bits for each FEC frame directly to the input port of the mapper 309 at the conclusion of that FEC frame. In any case, the apparatus 329 arranges the addressing of the random-access buffer memories included in the encoders 323, 324, 325, 326, 327 and 328 such that the LDPCCC parity bits for the first, second, third, fourth, fifth and sixth levels of systematic bits and BCH coding parity bits are transmitted in the same levels as the systematic bits and BCH coding parity bits to which they respectively pertain.

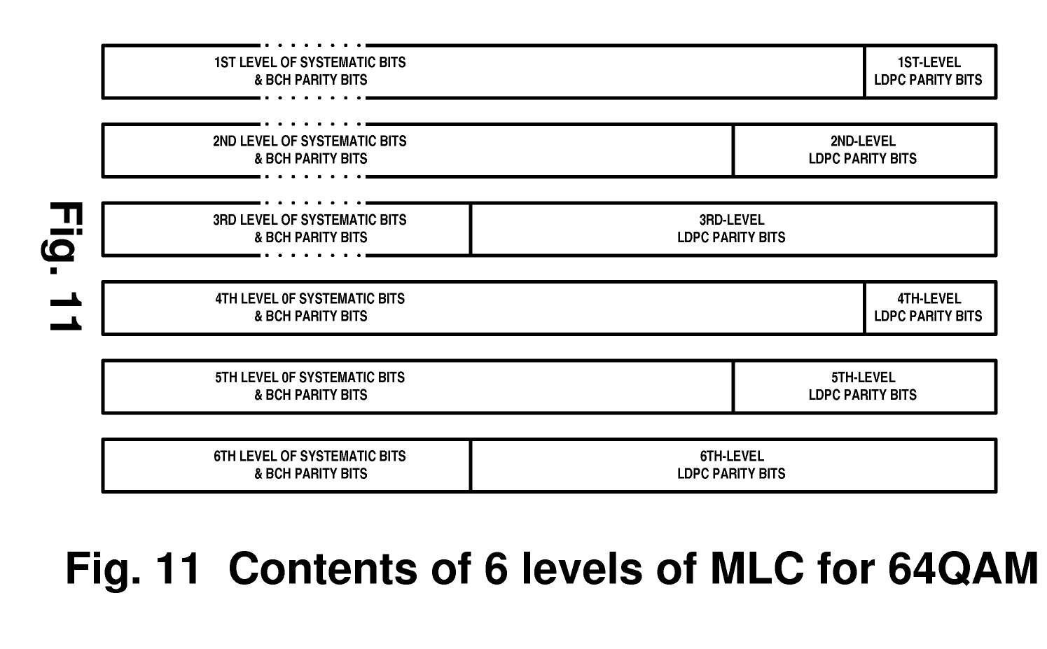

FIG. 11 illustrates one example of such practice. In two-dimensional LDPCCC-MLC per FIG. 10 there are many more LDPCCC parity bits for the third and sixth levels of systematic bits and BCH coding parity bits than for the second and fifth levels of systematic bits and BCH coding parity bits, and there are many more LDPCCC parity bits for the second and fifth levels of systematic bits and BCH coding parity bits than for the first and fourth levels of systematic bits and BCH coding parity bits.

The uppermost of the three top blocks in FIG. 11 (as viewed from the right side of the page) shows successive ones of the first level of systematic bits and BCH coding parity bits followed by the first-level LDPCCC parity bits, as arranged for being mapped to a first set of lattice points in each of the point lattices mapped to respective ones of 64QAM constellations for inverse Fourier transformation to a COFDM signal. The middle one of the three top blocks in FIG. 11 (as viewed from the right side of the page) shows successive ones of the second level of systematic bits and BCH coding parity bits, followed by the second-level LDPCCC parity bits, as arranged for being mapped to a second set of lattice points in each of the point lattices mapped to respective ones of 64QAM constellations for inverse Fourier transformation to a COFDM signal. The lowest one of the three top blocks in FIG. 11 (as viewed from the right side of the page) shows successive ones of the third level of systematic bits and BCH coding parity bits, followed by the third-level LDPCCC parity bits, as arranged for being mapped to a third set of lattice points in each of the point lattices mapped to respective ones of 64QAM constellations for inverse Fourier transformation to a COFDM signal.

The uppermost of the three bottom blocks in FIG. 11 (as viewed from the right side of the page) shows successive ones of the fourth level of systematic bits and BCH coding parity bits followed by the fourth-level LDPCCC parity bits, as arranged for being mapped to a fourth set of lattice points in each of the point lattices mapped to respective ones of 64QAM constellations for inverse Fourier transformation to a COFDM signal. The middle one of the three bottom blocks in FIG. 11 (as viewed from the right side of the page) shows successive ones of the fifth level of systematic bits and BCH coding parity bits, followed by the fifth-level LDPCCC parity bits, as arranged for being mapped to a fifth set of lattice points in each of the point lattices mapped to respective ones of 64QAM constellations for inverse Fourier transformation to a COFDM signal. The lowest one of the three bottom blocks in FIG. 11 (as viewed from the right side of the page) shows successive ones of the sixth level of systematic bits and BCH coding parity bits, followed by the sixth-level LDPCCC parity bits, as arranged for being mapped to a six set of lattice points in each of the point lattices mapped to respective ones of 64QAM constellations for inverse Fourier transformation to a COFDM signal.

FIG. 11 suggests the number of first-level LDPCCC parity bits, the number of second-level LDPCCC parity bits, the number of third-level LDPCCC parity bits, the number of fourth-level LDPCCC parity bits, the number of fifth-level LDPCCC parity bits and the number of sixth-level LDPCCC parity bits being in 1:2:4:1:2:4 ratio. This set of ratios is roughly based on the likelihood of error in each level owing to AWGN. These ratios are expected to be optimized over the course of time, based on extensive computer simulation of noise conditions in the field.

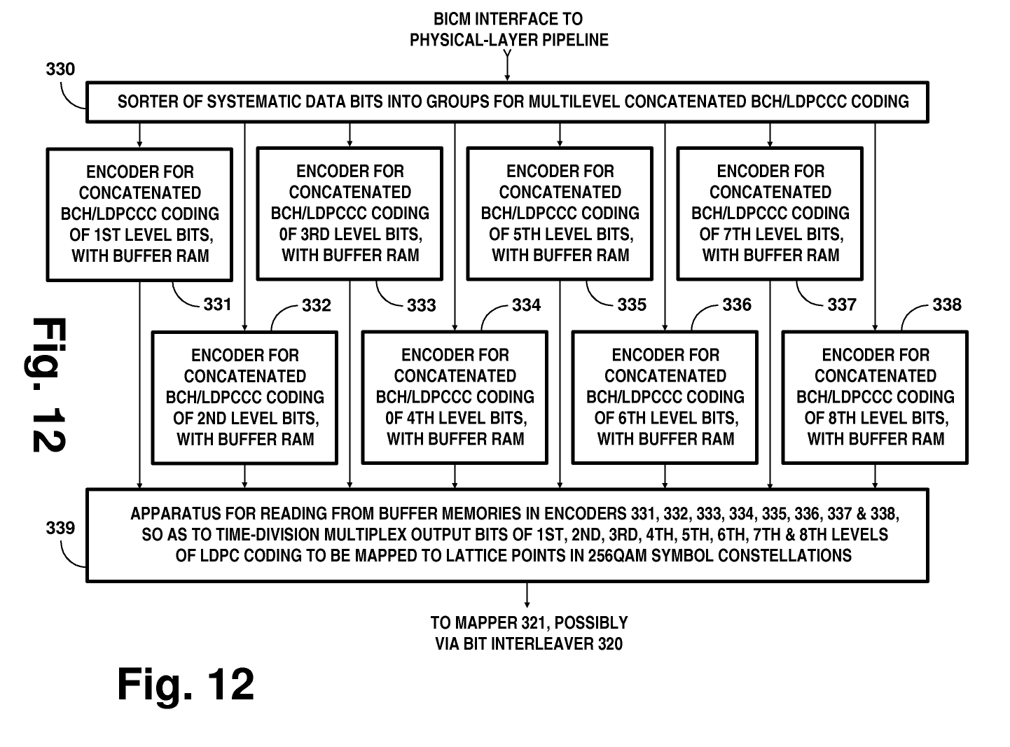

FIG. 12 shows in more detail a fourth embodiment of a part of the FIG. 2 portion of COFDM transmitter apparatus for encoding multilevel concatenated BCH/LDPCCC, which multilevel coding is designed for being mapped into 256QAM constellations. The FIG. 12 fourth embodiment of this part of the FIG. 4 portion of COFDM transmitter apparatus is essentially a modification of the FIG. 7 third embodiment of this part of the FIG. 2 portion of COFDM transmitter apparatus, in which modification the four levels of systematic data bits are each subdivided into two halves for separate concatenated BCH/LDPCCC coding. Arranging for eight levels of multilevel concatenated BCH/LDPCCC, rather than just four levels, allows additional parallelism when decoding that coding in the DTV receiver. FIG. 12 indicates that systematic data bits from the BICM interface are supplied to the input port of a sorter 330 for sorting successive bits of the BICM interface into groups cyclically assigned to respective ones of eight levels according to how they will map into 256QAM symbol constellations. The groups of bits assigned to the first and fifth levels each consist of a prescribed number of bits larger than a prescribed number of bits that groups of bits assigned to the second and sixth levels each consist of. The groups of bits assigned to the second and sixth levels each consist of a prescribed number of bits larger than a prescribed number of bits that groups of bits assigned to the third and seventh levels each consist of. The groups of bits assigned to the third and seventh levels each consist of a prescribed number of bits larger than a prescribed number of bits that groups of bits assigned to the fourth and eighth levels each consist of.

The first, second, third and fourth levels of bits are those unaffected by data-slicing errors when determining the in-phase coordinates of the 256QAM symbol constellations during de-mapping procedures in the DTV receiver. The first level of bits are those that change least frequently across the range of quadrature-phase coordinates of the 256QAM symbol constellations, and the second level of bits are those that change next to least frequently across that range. The third level of bits are those that change next to most frequently across the range of quadrature-phase coordinates of the 256QAM symbol constellations, and the fourth level of bits are those that change most frequently across that range. Accordingly, the first, second, third and fourth levels of bits are sorted according to the average expected level of confidence that each bit will be correct when the DTV receiver de-maps those bits from a 256QAM constellation accompanied by substantial AWGN. A first output port of the sorter 330 connects to the input port of an encoder 331 for the first level of concatenated BCH/LDPCCC, to deliver to the encoder 331 a first of the two sets of bits of systematic data bits least likely to exhibit AWGN-caused error in the results of de-mapping 256QAM constellations in the DTV receiver. A second output port of the sorter 330 connects to the input port of an encoder 332 for the second level of concatenated BCH/LDPCCC, to deliver to the encoder 332 a first of the two sets of bits of systematic data bits next to least likely to exhibit AWGN-caused error in the results of de-mapping 256QAM constellations in the DTV receiver. A third output port of the sorter 330 connects to the input port of an encoder 333 for the third level of concatenated BCH/LDPCCC, to deliver to the encoder 333 a first of the two sets of bits of systematic data bits next to most likely to exhibit AWGN-caused error in the results of de-mapping 256QAM constellations in the DTV receiver. A fourth output port of the sorter 330 connects to the input port of an encoder 334 for the fourth level of concatenated BCH/LDPCCC, to deliver to the encoder 334 a first of the two sets of bits of systematic data bits most likely to exhibit AWGN-caused error in the results of de-mapping 256QAM constellations in the DTV receiver.

The fifth, sixth, seventh and eighth levels of bits are those unaffected by data-slicing errors when determining the quadrature-phase coordinates of the 256QAM symbol constellations during de-mapping procedures in the DTV receiver. The fifth level of bits are those that change least frequently across the range of in-phase coordinates of the 256QAM symbol constellations, and the sixth level of bits are those that change next to least frequently across that range. The seventh level of bits are those that change next to most frequently across the range of in-phase coordinates of the 256QAM symbol constellations, and the eighth level of bits are those that change most frequently across that range. Accordingly, the fifth, sixth, seventh and eighth levels of bits are sorted according to the average expected level of confidence that each bit will be correct when the DTV receiver de-maps those bits from a 256QAM constellation accompanied by substantial AWGN. A fifth output port of the sorter 330 connects to the input port of an encoder 335 for the fifth level of concatenated BCH/LDPCCC, to deliver to the encoder 335 the fifth set of bits of systematic data bits least likely to exhibit AWGN-caused error in the results of de-mapping 2564QAM constellations in the DTV receiver. A sixth output port of the sorter 330 connects to the input port of an encoder 336 for the sixth level of concatenated BCH/LDPCCC, to deliver to the encoder 336 the second set of bits of systematic data bits next to least likely to exhibit AWGN-caused error in the results of de-mapping 256QAM constellations in the DTV receiver. A seventh output port of the sorter 330 connects to the input port of an encoder 337 for the seventh level of concatenated BCH/LDPCCC, to deliver to the encoder 336 the second set of bits of systematic data bits next to most likely to exhibit AWGN-caused error in the results of de-mapping 256QAM constellations in the DTV receiver. An eighth output port of the sorter 330 connects to the input port of an encoder 338 for the eighth level of concatenated BCH/LDPCCC, to deliver to the encoder 338 the second set of bits of systematic data bits most likely to exhibit AWGN-caused error in the results of de-mapping 256QAM constellations in the DTV receiver.

Each of the encoders 331, 332, 333, 334, 335, 336, 337 and 338 can be thought of as comprising a respective encoder for BCH coding of systematic data bits followed in cascade by a respective encoder for LDPC convolutional coding of the BCH coding for that level, although in practice the BCH and LDPC coding procedures for each level are apt to be performed by a respective microprocessor. Each of the encoders 331, 332, 333, 334, 335, 336, 337 and 338 includes a respective random-access buffer memory for temporarily storing, row by row, the bits of BCH coding that one of these encoders generates prior to LDPC convolutional coding during each successive FEC frame. This random-access buffer memory is addressed so as to introduce the column-twist associated with a respective level of the LDPC convolutional coding procedure. Furthermore, this buffer memory temporarily stores rows of LDPCCC parity bits for each successive FEC frame that are generated by the encoder including that buffer memory. Apparatus 339 arranges for time-division-multiplexed reading from the random-access buffer memories included in the encoders 331, 332, 323, 324, 325, 326, 327 and 328 after all those encoders finish LDPC convolutional coding their respective levels of BCH coding in an FEC frame. The apparatus 339 generates or helps generate successive Gray labels for specifying lattice points in a 256QAM symbol constellation. Each Gray label is generated responsive to a bit of a first-level LDPCCC codeword read from the buffer memory of encoder 331, a bit of a second-level LDPCCC codeword read from the buffer memory of encoder 332, a bit of a third-level LDPCCC codeword read from the buffer memory of encoder 333, a bit of a fourth-level LDPCCC codeword read from the buffer memory of encoder 334, a bit of a fifth-level LDPCCC codeword read from the buffer memory of encoder 335, a bit of a sixth-level LDPCCC codeword read from the buffer memory of encoder 336, a bit of a seventh-level LDPCCC codeword read from the buffer memory of encoder 337 and a bit of an eighth-level LDPCCC codeword read from the buffer memory of encoder 338.

In actual practice the apparatus 339 is apt to arrange the addressing of the random-access buffer memories included in the encoders 331, 332, 333, 334, 335, 336, 337 and 338 so as to subsume the function of the bit interleaver 318 within the reading of output bits from those random-access buffer memories. If the bit interleaver 318 is omitted, the apparatus 329 arranges time-division multiplexing to read the LDPCCC parity bits for each FEC frame directly to the input port of the mapper 309 at the conclusion of that FEC frame. In any case, the apparatus 339 arranges the addressing of the random-access buffer memories included in the encoders 331, 332, 333, 334, 335, 336, 337 and 338 such that the LDPCCC parity bits for the first, second, third, fourth, fifth, sixth, seventh and eighth levels of systematic bits and BCH coding parity bits are transmitted in the same levels as the systematic bits and BCH coding parity bits to which those LDPC parity bits respectively pertain.

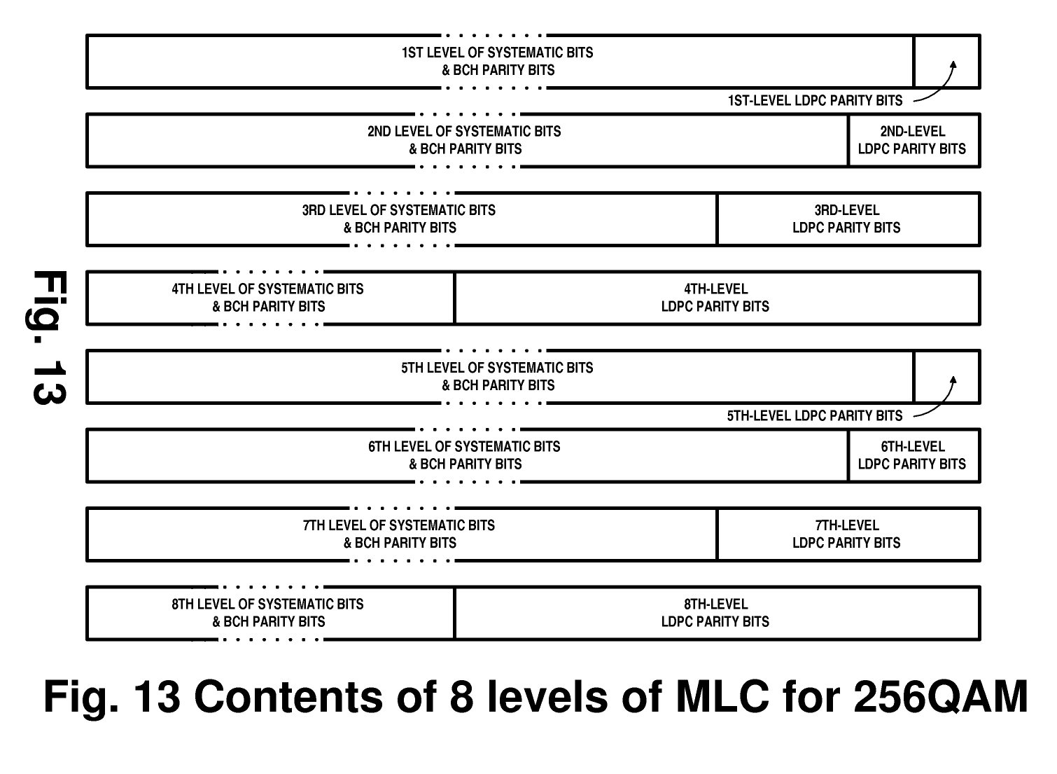

FIG. 13 illustrates one embodiment of such practice. In two-dimensional LDPCCC-MLC per FIG. 12 there are many more LDPCCC parity bits for the fourth and eighth levels of systematic bits and BCH coding parity bits than for the third and seventh levels of systematic bits and BCH coding parity bits. There are many more LDPCCC parity bits for the third and seventh levels of systematic bits and BCH coding parity bits than for the than for the second and sixth levels of systematic bits and BCH coding parity bits, and there are many more LDPCCC parity bits for the second and sixth levels of systematic bits and BCH coding parity bits than for the first and fifth levels of systematic bits and BCH coding parity bits.

The uppermost of the four top blocks in FIG. 13 (as viewed from the right side of the page) shows successive ones of the first level of systematic bits and BCH coding parity bits followed by the first-level LDPCCC parity bits, as arranged for being mapped to a first set of lattice points in each of the point lattices mapped to respective ones of 256QAM constellations for inverse Fourier transformation to a COFDM signal. The one of the four top blocks in FIG. 13 next below the uppermost one shows successive ones of the second level of systematic bits and BCH coding parity bits, followed by the second-level LDPCCC parity bits, as arranged for being mapped to a second set of lattice points in each of the point lattices mapped to respective ones of 256QAM constellations for inverse Fourier transformation to a COFDM signal. The one of the four top blocks in FIG. 13 next above the lowest one shows successive ones of the third level of systematic bits and BCH coding parity bits, followed by the third-level LDPCCC parity bits, as arranged for being mapped to a third set of lattice points in each of the point lattices mapped to respective ones of 256QAM constellations for inverse Fourier transformation to a COFDM signal. The lowest one of the four top blocks in FIG. 13 shows successive ones of the fourth level of systematic bits and BCH coding parity bits, followed by fourth-level LDPCCC parity bits, as arranged for being mapped to a fourth set of lattice points in each of the point lattices mapped to respective ones of 256QAM constellations for inverse Fourier transformation to a COFDM signal.

The uppermost of the four bottom blocks in FIG. 13 (as viewed from the right side of the page) shows successive ones of the fifth level of systematic bits and BCH coding parity bits followed by the fifth-level LDPCCC parity bits, as arranged for being mapped to a fifth set of lattice points in each of the point lattices mapped to respective ones of 256QAM constellations for inverse Fourier transformation to a COFDM signal. The one of the four bottom blocks in FIG. 13 next below the uppermost one shows successive ones of the sixth level of systematic bits and BCH coding parity bits, followed by the sixth-level LDPCCC parity bits, as arranged for being mapped to a sixth set of lattice points in each of the point lattices mapped to respective ones of 256QAM constellations for inverse Fourier transformation to a COFDM signal. The one of the four bottom blocks in FIG. 13 next above the lowest one shows successive ones of the seventh level of systematic bits and BCH coding parity bits, followed by the seventh-level LDPCCC parity bits, as arranged for being mapped to a seventh set of lattice points in each of the point lattices mapped to respective ones of 256QAM constellations for inverse Fourier transformation to a COFDM signal. The lowest one of the four bottom blocks in FIG. 13 shows successive ones of the eighth level of systematic bits and BCH coding parity bits, followed by the eighth-level LDPCCC parity bits, as arranged for being mapped to an eighth set of lattice points in each of the point lattices mapped to respective ones of 256QAM constellations for inverse Fourier transformation to a COFDM signal.

FIG. 13 suggests the number of first-level LDPCCC parity bits, the number of second-level LDPCCC parity bits, the number of third-level LDPCCC parity bits, the number of fourth-level LDPCCC parity bits, the number of fifth-level LDPCCC parity bits, the number of sixth-level LDPCCC parity bits, the number of seventh-level LDPCCC parity bits and the number of eighth-level LDPCCC parity bits being in 1:2:4:8:1:2:4:8 ratio. Indeed, the number of first-level LDPCCC parity bits and the number of fifth-level LDPCCC parity bits preferably are alike. However, the ratios of the number of second-level LDPCCC parity bits, the number of third-level LDPCCC parity bits and the number of fourth-level LDPCCC parity bits to the number of first-level LDPCCC parity bits are apt to differ from 2:1, 4:1 and 8:1 respectively in the course of actual practice. Also, the ratios of the number of sixth-level LDPCCC parity bits, the number of seventh-level LDPCCC parity bits and the number of eighth-level LDPCCC parity bits to the number of fifth-level LDPCCC parity bits are apt to differ from 2:1, 4:1 and 8:1 respectively in the course of actual practice. These ratios are expected to be optimized over the course of time, based on extensive computer simulation of noise conditions in the field.

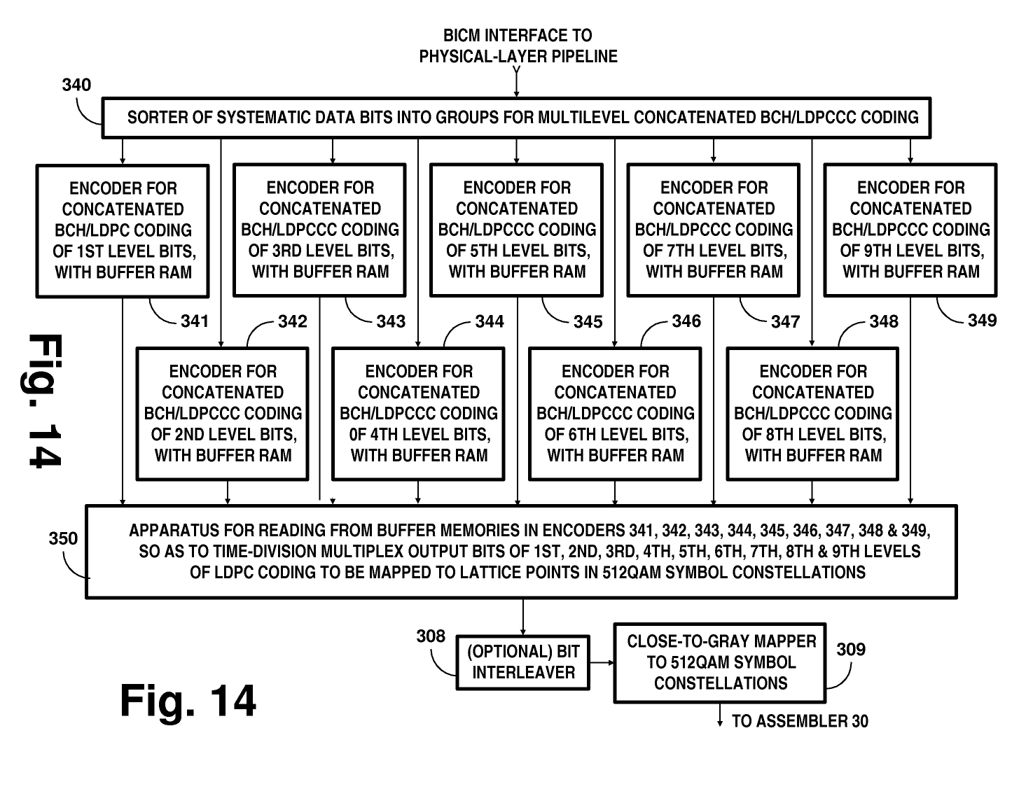

FIG. 14 shows in more detail a fifth embodiment of a part of the FIG. 2 portion of COFDM transmitter apparatus for encoding multilevel BCH/LDPC coding, which coding is designed for being mapped into 512QAM constellations. E. g., the 512QAM constellations are of the same general type as those described by A. L. R. Limberg in patent application US-2013-0028271-A1 published 31 Jan. 2013 titled “COFDM BROADCAST SYSTEMS EMPLOYING TURBO CODING”, which description refers to FIGS. 12A, 12B, 12C, 12D, 13, 14A, 14B, 14C, 14D, 15A, 15D, 15C, 15D, 15E, 15F, 15G, 15H and 151 of the drawing of that patent application. These cruciform 512QAM constellations offer close-to-Gray mapping in which the 9-bit segments of the coding mapped to adjacent lattice points in the cruciform point lattice differ by two bits in 64 instances and otherwise differ by only a single bit in the other 1952 instances.

FIG. 14 indicates that systematic data bits from the BICM interface are supplied to the input port of a sorter 340 for sorting successive bits of the BICM interface into groups cyclically assigned to respective ones of nine levels according to how they will map into 512QAM symbol constellations. A first of nine output ports of the sorter 340 connects to the input port of an encoder 341 for the first level of concatenated BCH/LDPCCC, to deliver to the encoder 341 a first of the two sets of systematic data bits least likely to exhibit AWGN-caused error in the results of de-mapping 512QAM constellations in the DTV receiver. These systematic data bits are those that change least frequently in the in-phase direction as mapped within 512QAM constellations, being 1 in the “left” half of each 512QAM constellation and being 0 in its “right” half. (The bits of the first level of concatenated BCH/LDPCCC correspond to the “ninth” bits of code segments described in US-2013-0028271-A1.) The second output port of the sorter 340 connects to the input port of an encoder 342 for the second level of concatenated BCH/LDPCCC, to deliver to the encoder 342 a second of the two sets of systematic data bits least likely to exhibit AWGN-caused error in the results of de-mapping 512QAM constellations in the DTV receiver. These bits are those that change least frequently in the quadrature-phase direction as mapped within 512QAM constellations, being 1 in the “bottom” half of each 512QAM constellation and being 0 in its “top” half. (The bits of the second level of LDPCCC correspond to the “eighth” bits of code segments described in US-2013-0028271-A1.)

The third output port of the sorter 340 connects to the input port of an encoder 343 for the third level of concatenated BCH/LDPCCC, to deliver to the encoder 343 those systematic data bits next to least likely to exhibit AWGN-caused error in the results of de-mapping 512QAM constellations in the DTV receiver. (The bits of the third level of LDPCCC correspond to the “sixth” bits of code segments described in US-2013-0028271-A1.) The bits of the third level of concatenated BCH/LDPCCC are likely to exhibit about twice as much AWGN-caused error as the bits in the first and second levels of concatenated BCH/LDPCCC do. The fourth output port of the sorter 340 connects to the input port of an encoder 344 for the fourth level of concatenated BCH/LDPCCC, to deliver to the encoder 344 bits of systematic data bits next more likely to exhibit AWGN-caused error in the results of de-mapping 512QAM constellations in the DTV receiver. (The bits of the fourth level of concatenated BCH/LDPCCC correspond to the “seventh” bits of code segments described in US-2013-0028271-A1.) The bits of the fourth level of concatenated BCH/LDPCCC are likely to exhibit about four-thirds as much AWGN-caused error as the bits in the third level of concatenated BCH/LDPCCC do. The fifth output port of the sorter 340 connects to the input port of an encoder 345 for the fifth level of concatenated BCH/LDPCCC, to deliver to the encoder 345 those systematic bits next more likely to exhibit AWGN-caused error in the results of de-mapping 512QAM constellations in the DTV receiver. (The bits of the fifth level of concatenated BCH/LDPCCC correspond to the “third” bits of code segments described in US-2013-0028271-A1.) The bits of the fifth level of concatenated BCH/LDPCCC are likely to exhibit about five-fourths as much AWGN-caused error as the bits in the fourth level of concatenated BCH/LDPCCC do.

The sixth, seventh, eighth and ninth output ports of the sorter 340 respectively connect to the input port of an encoder 346 for the sixth level of concatenated BCH/LDPCCC, to the input port of an encoder 347 for the seventh level of concatenated BCH/LDPCCC, to the input port of an encoder 348 for the eighth level of concatenated BCH/LDPCCC, and to the input port of an encoder 349 for the ninth level of LDPCCC. Via these four connections the sorter 340 delivers to the encoders 346, 347, 348 and 349 four respective sets of systematic data bits most likely to exhibit AWGN-caused error in the results of de-mapping 512QAM constellations in the DTV receiver. (The bits of one of the sixth, seventh, eighth and ninth levels of concatenated BCH/LDPCCC correspond to the “first” bits of code segments described in US-2013-0028271-A1. The bits of another of the sixth, seventh, eighth and ninth levels of concatenated BCH/LDPCCC correspond to the “second” bits of code segments described in US-2013-0028271-A1. The bits of yet another of the sixth, seventh, eighth and ninth levels of concatenated BCH/LDPCCC correspond to the “third” bits of code segments described in US-2013-0028271-A1. The bits of still another of the sixth, seventh, eighth and ninth levels of concatenated BCH/LDPCCC correspond to the “fourth” bits of code segments described in US-2013-0028271-A1.)

Each of the encoders 341, 342, 343, 344, 345, 346, 347, 348 and 349 can be thought of as comprising a respective encoder for BCH coding of systematic data bits followed in cascade by a respective encoder for LDPC convolutional coding of the BCH coding for that level, although in practice the BCH and LDPC convolutional coding procedures are apt to be performed by a respective microprocessor for each level. Each of the encoders 341, 342, 343, 344, 345, 346, 347, 348 and 349 includes a respective random-access buffer memory for temporarily storing, row by row, the bits of BCH coding that one of these encoders receives as input signal during each successive FEC frame. This random-access buffer memory is addressed so as to introduce the column-twist associated with a respective level of the LDPC convolutional coding procedure. Furthermore, this buffer memory temporarily stores rows of LDPCCC parity bits for each successive FEC frame that are generated by the encoder including that buffer memory. Apparatus 350 arranges for time-division-multiplexed reading from the random-access buffer memories included in the encoders 341, 342, 343, 344, 345, 346, 347, 348 and 349 after all those encoders finish LDPC convolutional coding their respective levels of BCH coding in an FEC frame. The apparatus 350 generates or helps generate successive Gray labels for specifying lattice points in a 512QAM symbol constellation. Each Gray label is generated responsive to a bit of a first-level LDPCCC codeword read from the buffer memory of encoder 341, a bit of a second-level LDPCCC codeword read from the buffer memory of encoder 342, a bit of a third-level LDPCCC codeword read from the buffer memory of encoder 343, a bit of a fourth-level LDPCCC codeword read from the buffer memory of encoder 344, a bit of a fifth-level LDPCCC codeword read from the buffer memory of encoder 345, a bit of a sixth-level LDPCC codeword read from the buffer memory of encoder 346, a bit of a seventh-level LDPCCC codeword read from the buffer memory of encoder 347, a bit of an eighth-level LDPCCC codeword read from the buffer memory of encoder 348 and a bit of a ninth-level LDPCCC codeword read from the buffer memory of encoder 349.

In actual practice the apparatus 350 is apt to arrange the addressing of the random-access buffer memories included in the encoders 341, 342, 343, 344, 345, 346, 347, 348 and 349 so as to subsume the function of the bit interleaver within the reading of output bits from those random-access buffer memories for application to the mapper 309 for 512QAM constellations. FIG. 14 indicates that the bit interleaver 308 is optional. If the bit interleaver 308 is omitted, the apparatus 350 arranges time-division multiplexing to read the LDPC parity bits for each FEC frame directly to the input port of the mapper 309 at the conclusion of that FEC frame. In any case, the apparatus 350 arranges the addressing of the random-access buffer memories included in the encoders 341, 342, 343, 344, 345, 346, 347, 348 and 349 such that the LDPCCC parity bits for the first, second, third, fourth, fifth, sixth, seventh, eighth and ninth levels of systematic bits and BCH coding parity bits are transmitted in the same levels as the systematic bits and BCH coding parity bits to which those LDPCCC parity bits respectively pertain.

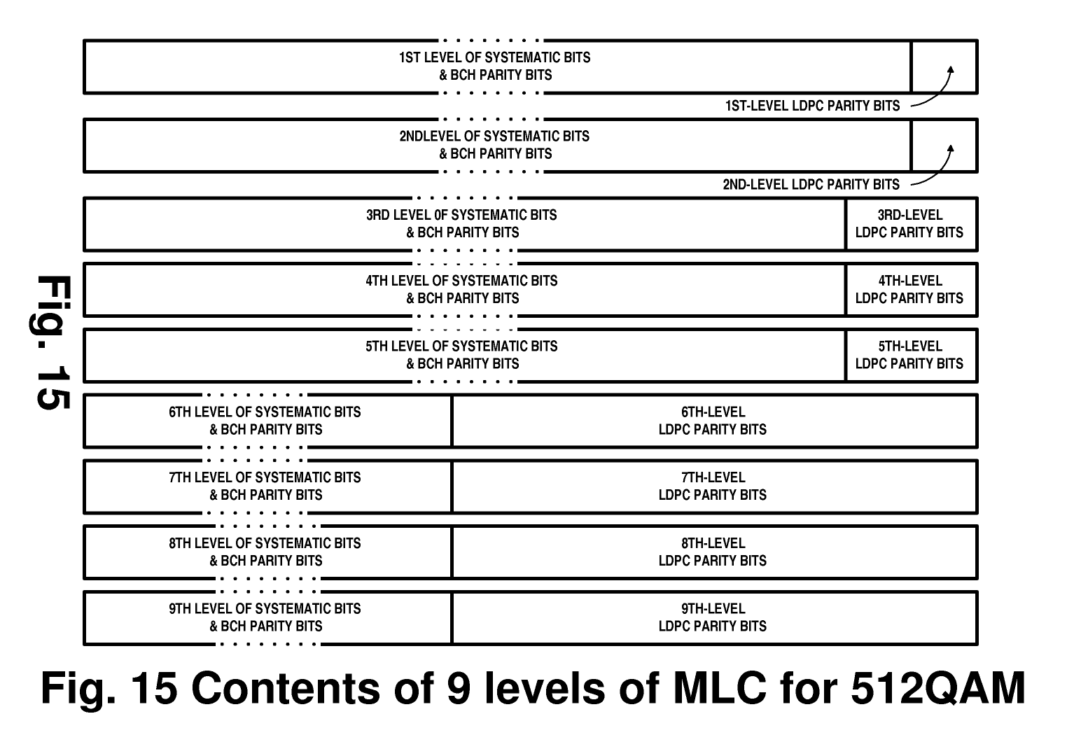

FIG. 15 illustrates one embodiment of such practice. The top block in FIG. 15 (as viewed from the right side of the page) shows successive ones of the first level of systematic bits and BCH coding parity bits followed by the first-level LDPCCC parity bits, as arranged for being mapped to a first set of lattice points in each of the point lattices mapped to respective ones of 512QAM constellations for inverse Fourier transformation to a COFDM signal. The first-below-top block in FIG. 15 shows successive ones of the second level of systematic bits and BCH coding parity bits, followed by the second-level LDPCCC parity bits, as arranged for being mapped to a second set of lattice points in each of the point lattices mapped to respective ones of 512QAM constellations for inverse Fourier transformation to a COFDM signal. The second-below-top block in FIG. 15 shows successive ones of the third level of systematic bits and BCH coding parity bits followed by the third-level LDPCCC parity bits, as arranged for being mapped to a third set of lattice points in each of the point lattices mapped to respective ones of 512QAM constellations for inverse Fourier transformation to a COFDM signal.

The third-below-top block in FIG. 15 shows successive ones of the fourth level of systematic bits and BCH coding parity bits, followed by the fourth-level LDPCCC parity bits, as arranged for being mapped to a fourth set of lattice points in each of the point lattices mapped to respective ones of 512QAM constellations for inverse Fourier transformation to a COFDM signal. The middle or fourth-below-top block in FIG. 15 shows successive ones of the fifth level of systematic bits and BCH coding parity bits, followed by the fifth-level LDPCCC parity bits, as arranged for being mapped to a fifth set of lattice points in each of the point lattices mapped to respective ones of 512QAM constellations for inverse Fourier transformation to a COFDM signal. The third-above-bottom block in FIG. 15 shows successive ones of the sixth level of systematic bits and BCH coding parity bits followed by the sixth-level LDPCCC parity bits, as arranged for being mapped to a sixth set of lattice points in each of the point lattices mapped to respective ones of 512QAM constellations for inverse Fourier transformation to a COFDM signal.

The second-above-bottom block in FIG. 15 shows successive ones of the seventh level of systematic bits and BCH coding parity bits followed by the seventh-level LDPCCC parity bits, as arranged for being mapped to a seventh set of lattice points in each of the point lattices mapped to respective ones of 512QAM constellations for inverse Fourier transformation to a COFDM signal. The first-above-bottom block in FIG. 15 shows successive ones of the eighth level of systematic bits and BCH coding parity bits, followed by the eighth-level LDPCCC parity bits, as arranged for being mapped to an eighth set of lattice points in each of the point lattices mapped to respective ones of 512QAM constellations for inverse Fourier transformation to a COFDM signal. The bottom block in FIG. 15 shows successive ones of the ninth level of systematic bits and BCH coding parity bits, followed by the ninth-level LDPCCC parity bits, as arranged for being mapped to a ninth set of lattice points in each of the point lattices mapped to respective ones of 512QAM constellations for inverse Fourier transformation to a COFDM signal.

FIG. 15 suggests 1:1:2:2:2:8:8:8:8 ratios to each other of the number of first-level LDPCCC parity bits, the number of second-level LDPCCC parity bits, the number of third-level LDPCCC parity bits, the number of fourth-level LDPCCC parity bits, the number of fifth-level LDPCCC parity bits, the number of sixth-level LDPCCC parity bits, the number of seventh-level LDPCCC parity bits, the number of eighth-level LDPCCC parity bits, and the number of ninth-level LDPCCC parity bits. In part, the ratios were selected to suit drafting limitations. These ratios are expected to be optimized over the course of time, based on extensive computer simulation of noise conditions in the field.

The DVB-T2 standard prescribes 64,800 bits in the single-level LDPC block coding of a normal FEC Frame and 16,200 bits in the single-level LDPC block coding of a short FEC Frame used for transmissions to mobile receivers. Multilevel LDPC convolutional coding is more easily accommodated within these FEC Frame sizes than multilevel LDPC block coding is. Decoding of FEC Frames of standard normal size and FEC frames of standard small size, as specified by the DVB-T2 standard, is customarily performed using 360 parallel independent decoders or a submultiple of 360 parallel independent decoders for the LDPC block coding. The parity check (H) matrix used for the LDPC coding in DVB-T2 is designed to be composed of sub-matrices to support respective ones of the 360 parallel independent decoders.

LDPC convolutional coding can be decoded using serially concatenated or “pipelined” decoding techniques, rather than being decoded using parallel independent decoding techniques. Accordingly, LDPC convolutional coding lends itself to being shortened to any length and, if suitably terminated, can perform quite well when corrupted to some degree by AWGN. Performance of LDPC convolutional coding when corrupted to a degree by AWGN can be substantially as good for smaller FEC Frames as the performance for the FEC Frame sizes prescribed by DVB-T2 of LDPC block coding corrupted to similar degree by AWGN.

The 64,800 bits of a normal FEC Frame as specified by the DVB-T2 standard can be divided into three 21,600-bit portions for respective ones of three levels of LDPCCC-MLC for mapping to 64QAM symbol constellations. The 16,200 bits of a short FEC Frame as specified by the DVB-T2 standard can be divided into three 5,400-bit portions for respective ones of three levels of LDPCCC-MLC. The three levels of LDPCCC-MLC can be independently decoded using respective serially concatenated decoding of each level, which reduces latent delay in decoding an FEC Frame by a factor of three compared to serially concatenated decoding of single-level LDPCCC.

The 64,800 bits of a normal FEC Frame as specified by the DVB-T2 standard can be divided into four 16,200-bit portions for respective ones of four levels of LDPCCC-MLC for mapping to 256QAM symbol constellations. The 16,200 bits of a short FEC Frame as specified by the DVB-T2 standard can be divided into four 4,050-bit portions for respective ones of four levels of LDPCCC-MLC. The four levels of LDPCCC-MLC can be independently decoded using respective serially concatenated decoding of each level, which reduces latent delay in decoding an FEC Frame by a factor of four compared to serially concatenated decoding of single-level LDPCCC.

The 64,800 bits of a normal FEC Frame as specified by the DVB-T2 standard can be divided into six 10,800-bit portions for respective ones of six levels of LDPCCC-MLC for mapping to 64QAM symbol constellations. The 16,200 bits of a short FEC Frame as specified by the DVB-T2 standard can be divided into six 2,700-bit portions for respective ones of six levels of LDPCCC-MLC. The six levels of LDPCCC-MLC are independently decoded using respective serially concatenated decoding of each level, which reduces latent delay in decoding an FEC Frame by a factor of six compared to serially concatenated decoding of single-level LDPCCC. This is half the latent delay for independently decoding three levels of LDPCCC-MLC de-mapped from 64QAM symbol constellations. However, the number of bits of BCH coding that can be recovered from an FEC Frame is reduced if the six constituent LDPC convolutional codewords are terminated individually, rather than by pairs. So, coding efficiency is reduced somewhat, particularly when dividing 16,200-bits short FEC Frames each into six 2,700-bit portions.

The 64,800 bits of a normal FEC Frame as specified by the DVB-T2 standard can be divided into eight 8,100-bit portions for respective ones of eight levels of LDPCCC-MLC for mapping to 256QAM symbol constellations. The 16,200 bits of a short FEC Frame as specified by the DVB-T2 standard can be divided into eight 2,025-bit portions for respective ones of eight levels of LDPCCC-MLC. The eight levels of LDPCCC-MLC can be independently decoded using respective serially concatenated decoding of each level, which reduces latent delay in decoding an FEC Frame by a factor of eight compared to serially concatenated decoding of single-level LDPCCC. This is half the latent delay for independently decoding four levels of LDPCCC-MLC de-mapped from 256QAM symbol constellations. However, the number of bits of BCH coding that can be recovered from an FEC Frame is reduced if the eight constituent LDPC convolutional codewords are terminated individually, rather than by pairs. So, coding efficiency is reduced somewhat, particularly when dividing 16,200-bits short FEC Frames each into eight 2,025-bit portions.

The 64,800 bits of a normal FEC Frame as specified by the DVB-T2 standard can be divided into nine 7,200-bit portions for respective ones of nine levels of LDPCCC-MLC for mapping to 512QAM symbol constellations. The 16,200 bits of a short FEC Frame as specified by the DVB-T2 standard can be divided into nine 1,800-bit portions for respective ones of nine levels of LDPCCC-MLC. The nine levels of LDPCCC-MLC are independently decoded using respective serially concatenated decoding of each level. Independent serially concatenated decoding of each of the nine 1,800-bit portions a short FEC Frame as specified by the DVB-T2 standard is not very practical, because so large a fraction of the 1,800 bits would be taken up by parity bits for BCH coding and by bits for terminating the constituent LDPCCC. However, 512QAM symbol constellations are not apt to be used for transmitting to mobile and handheld DTV receivers, which short FEC Frames are designed to accommodate. FEC Frames containing more than 62,800 bits might be used for 6-level, 8-level or 9-level LFPCCC-MLC, so the parity bits for BCH coding and the bits for terminating the constituent LDPCCC would not reduce coding efficiency as much.

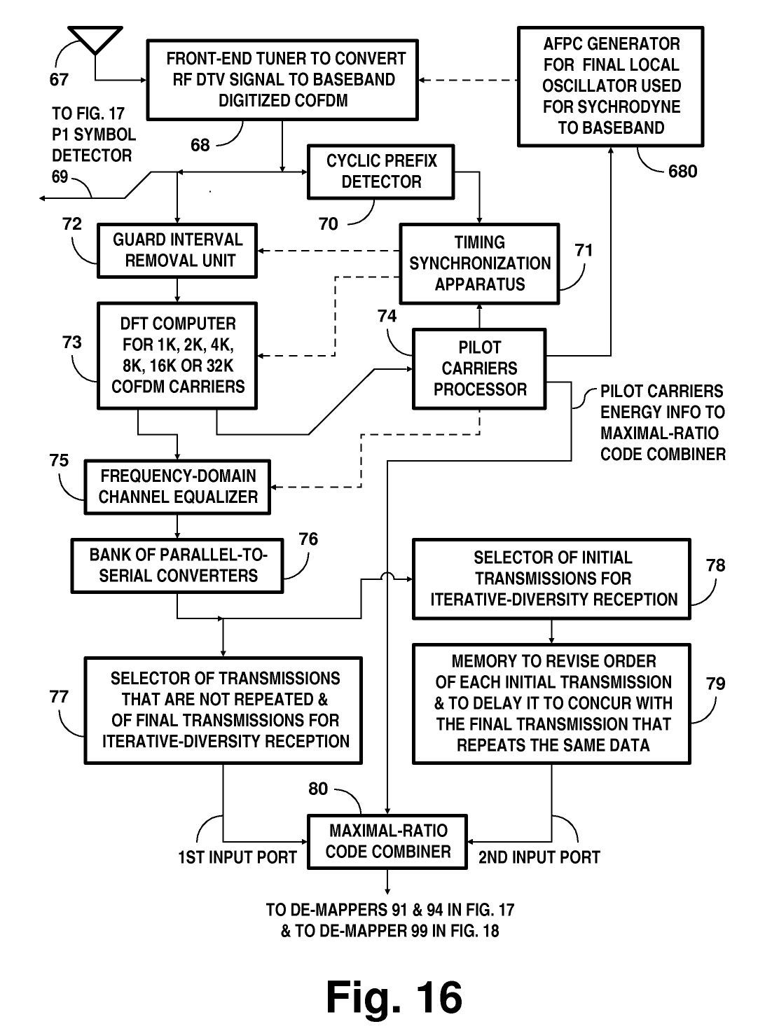

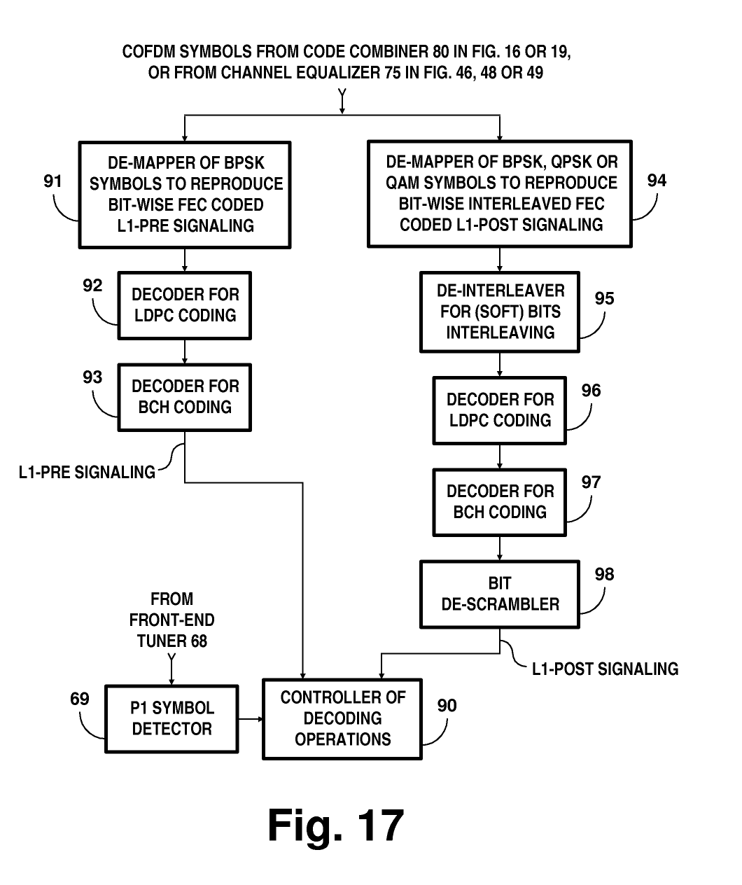

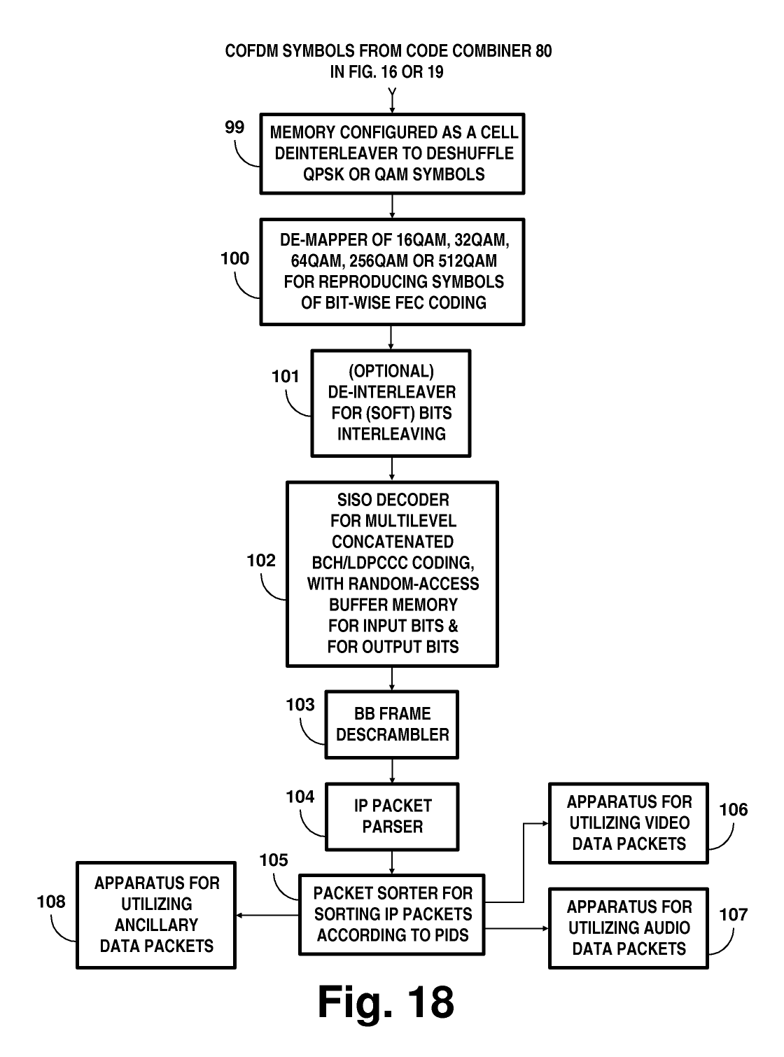

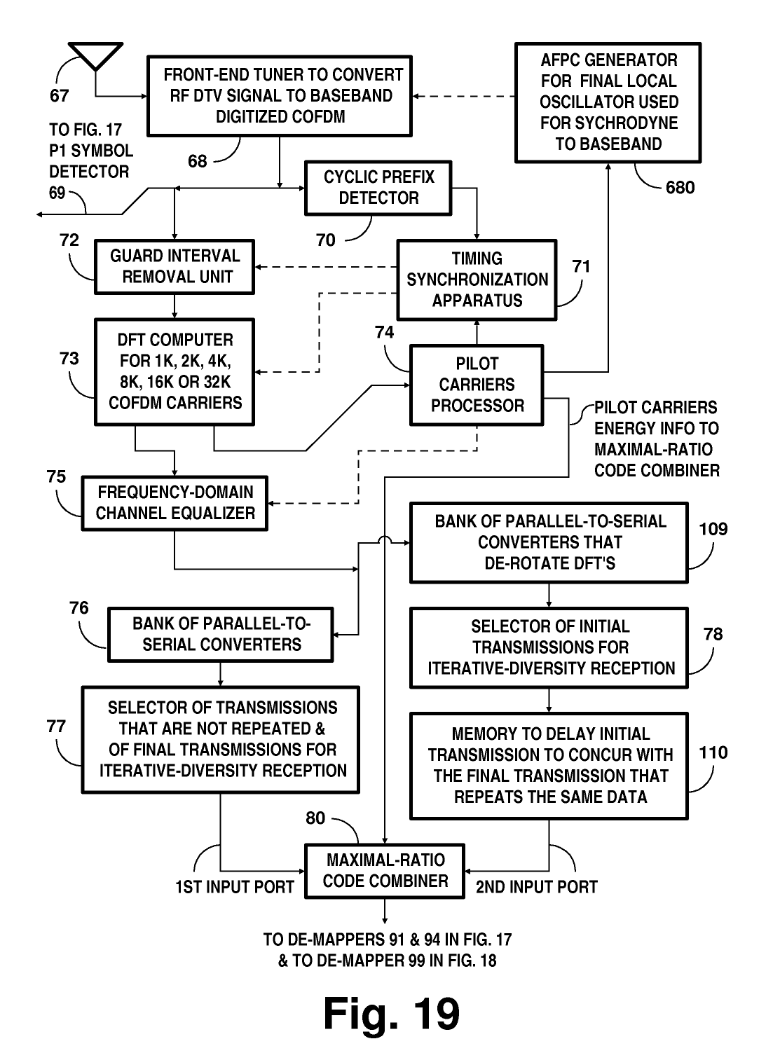

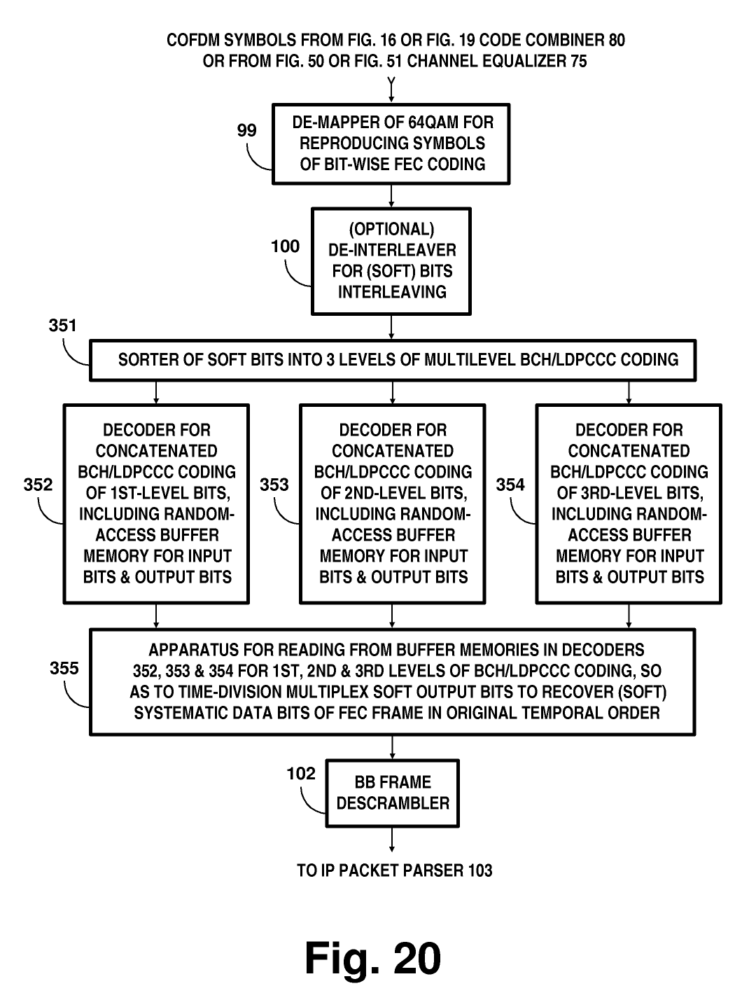

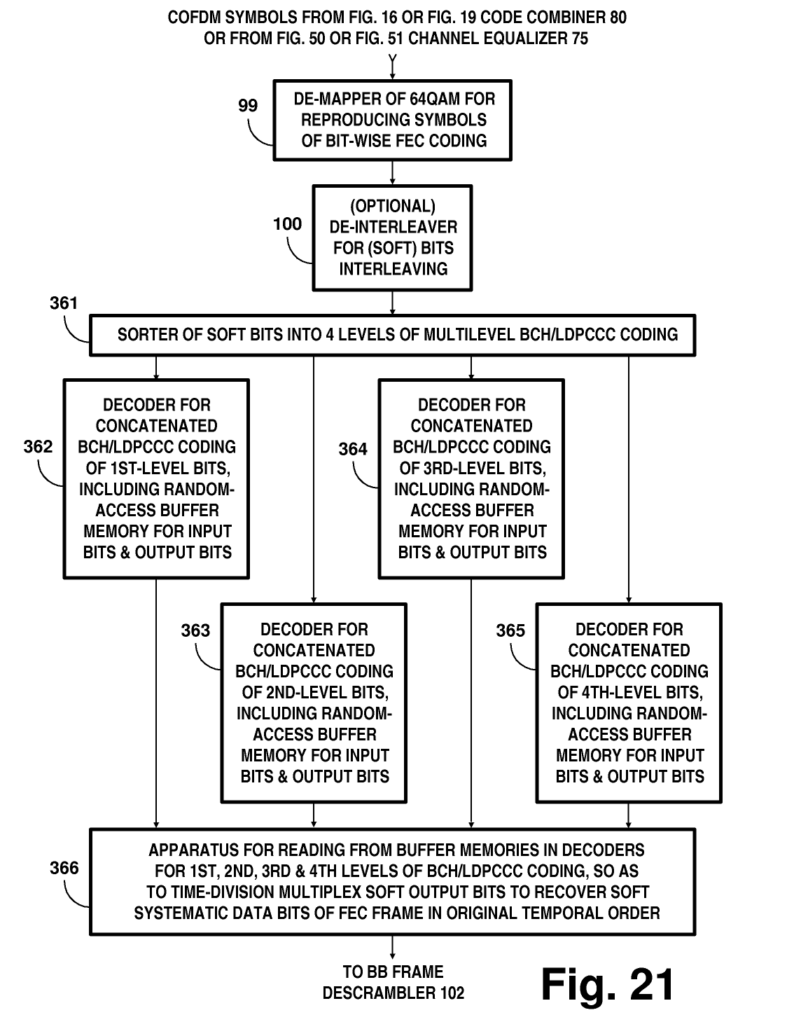

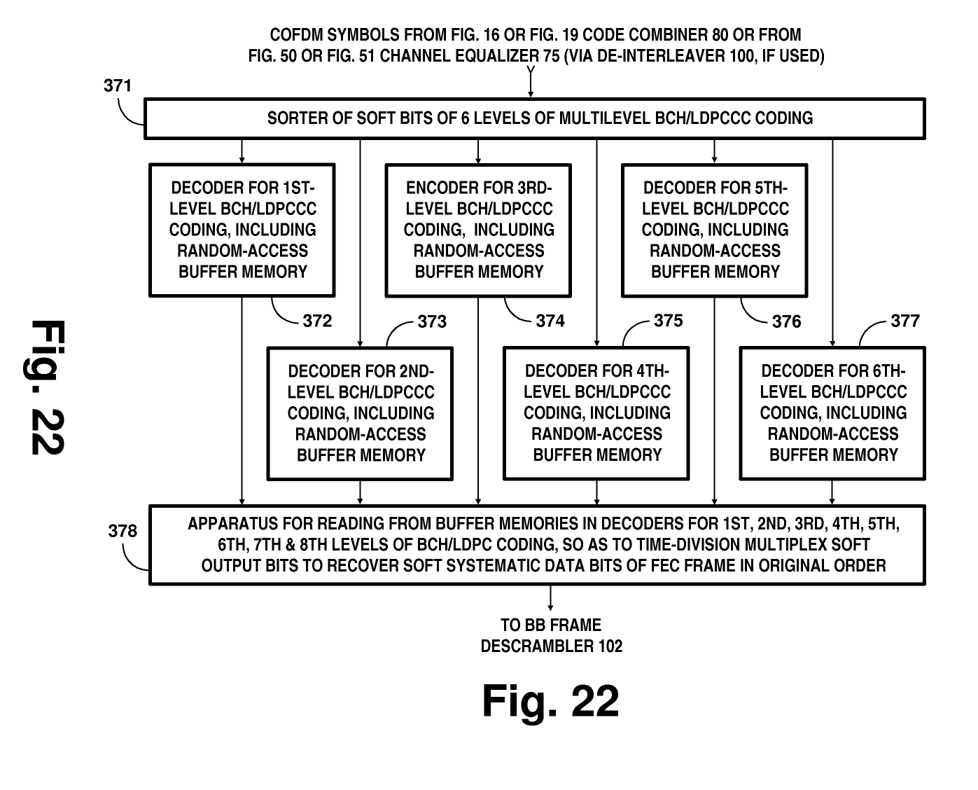

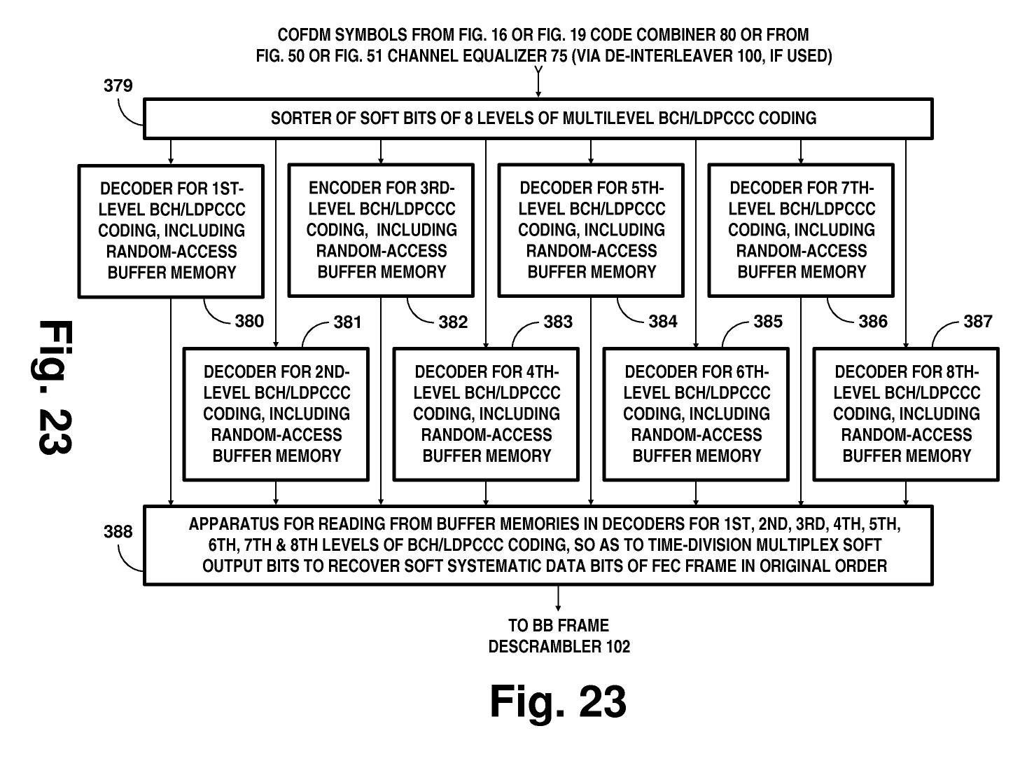

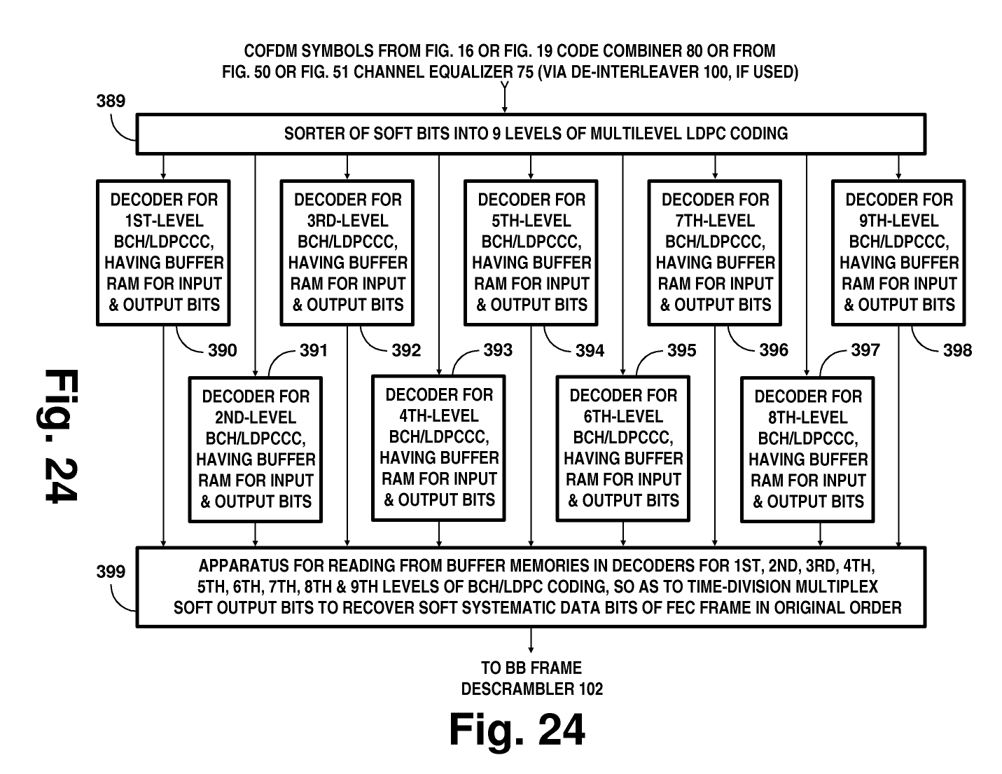

FIG. 16 shows the initial portion of a DTV receiver designed for iterative-diversity reception of COFDM signals as transmitted at VHF or UHF by a DTV transmitter, such as the one depicted in FIGS. 1, 2, 3 and 4. A reception antenna 67 captures the radio-frequency COFDM signal for application as input signal to a front-end tuner 68 of the receiver. The front-end tuner 68 can be of a double-conversion type composed of initial single-conversion super-heterodyne receiver circuitry for converting radio-frequency (RF) COFDM signal to intermediate-frequency (IF) COFDM signal followed by circuitry for performing a final conversion of the IF COFDM signal to baseband COFDM signal. The initial single-conversion receiver circuitry typically comprises a tunable RF amplifier for RF COFDM signal incoming from the reception antenna, a tunable first local oscillator, a first mixer for heterodyning amplified RF COFDM signal with local oscillations from the first local oscillator to obtain the IF COFDM signal, and an intermediate-frequency (IF) amplifier for the IF COFDM signal. Typically, the front-end tuner 68 further includes a synchronous demodulator for performing the final conversion from IF COFDM signal to baseband COFDM signal and an analog-to-digital converter for digitizing the baseband COFDM signal. Synchronous demodulation circuitry typically comprises a final local oscillator with automatic frequency and phase control (AFPC) of its oscillations, a second mixer for synchrodyning amplified IF COFDM signal with local oscillations from the final local oscillator to obtain the baseband COFDM signal, and a low-pass filter for suppressing image signal accompanying the baseband COFDM signal. In some designs of the front-end tuner 68, synchronous demodulation is performed in the analog regime before subsequent analog-to-digital conversion of the resulting complex baseband COFDM signal. In other designs of the tuner 68, analog-to-digital conversion is performed before synchronous demodulation is performed in the digital regime.

Simply stated, the front-end tuner 68 converts radio-frequency COFDM signal received at its input port to digitized samples of baseband COFDM signal supplied from its output port. Typically, the digitized samples of the real component of the baseband COFDM signal are alternated with digitized samples of the imaginary component of the baseband COFDM signal for arranging the complex baseband COFDM signal in a single stream of digital samples. FIG. 16 shows an AFPC generator 680 for generating the automatic frequency and phase control (AFPC) signal for controlling the final local oscillator within the front-end tuner 68.

The output port of the front-end tuner 68 is connected for supplying digitized samples of baseband COFDM signal to the respective input ports of a P1 symbol detector 69 depicted in FIG. 17 and a cyclic prefix detector 70 depicted in FIG. 16. The cyclic prefix detector 70 differentially combines the digitized samples of baseband COFDM signal with those samples as delayed by the duration of an effective COFDM symbol. Nulls in the difference signal so generated should occur, marking the guard intervals of the baseband COFDM signal. The nulls are processed to reduce any corruption caused by noise and to generate better-defined indications of the phasing of COFDM symbols. The output port of the cyclic prefix detector 70 is connected to supply these indications to a first of two input ports of timing synchronization apparatus 71.

A first of two output ports of the timing synchronization apparatus 71 is connected for supplying gating control signal to the control input port of a guard-interval-removal unit 72, the signal input port of which is connected for receiving digitized samples of baseband COFDM signal from the output port of the front-end tuner 67. The output port of the guard-interval-removal unit 72 is connected for supplying the input port of discrete-Fourier-transform computer 73 with windowed portions of the baseband COFDM signal that contain effective COFDM samples. A second of the output ports of the timing synchronization apparatus 71 is connected for supplying the DFT computer 73 with synchronizing information concerning the effective COFDM samples.

The indications concerning the phasing of COFDM symbols that the cyclic prefix detector 70 supplies to the timing synchronization apparatus 71 is sufficiently accurate for initial windowing of a baseband COFDM signal that the guard-interval-removal unit 72 supplies to the DFT computer 73. A first output port of the DFT computer 73 is connected for supplying demodulation results for at least all of the pilot carriers in parallel to the input port of a pilot carriers processor 74, and a second output port of the DFT computer 73 is connected for supplying demodulation results for each of the COFDM carriers to the input port of a frequency-domain channel equalizer 75. The processor 74 selects the demodulation results concerning pilot carriers for processing, part of which processing generates weighting coefficients for channel equalization filtering in the frequency domain. A first of four output ports of the processor 74 that are explicitly shown in FIG. 16 is connected for supplying these weighting coefficients (via wiring depicted as a dashed-line connection) to the frequency-domain channel equalizer 75, uses them for adjusting its responses to the demodulation results for each of the COFDM carriers.

A second of the output ports of the pilot carriers processor 74 that are explicitly shown in FIG. 16 is connected for supplying more accurate window-positioning information to the second input port of the timing synchronization apparatus 71. This window-positioning information is an adjustment generated by a feedback loop that seeks to minimize the noise accompanying pilot carriers, which noise increases owing to intercarrier interference from adjoining modulated carriers when window positioning is not optimal.

A third of the output ports of the pilot carriers processor 74 that are explicitly shown in FIG. 16 is connected for forwarding unmodulated pilot carriers to the input port of the AFPC generator 680. The real components of the unmodulated pilot carriers are multiplied by their respective imaginary components in the AFPC generator 680. The resulting products are summed and low-pass filtered to develop the AFPC signal that the AFPC generator 680 supplies to the front-end tuner 68 for controlling the final local oscillator therein. Other methods to develop AFPC signals for the final local oscillator in the front-end tuner 68 are also known, which can replace or supplement the method described above. One such other method is described in U.S. Pat. No. 5,687,165 titled “Transmission system and receiver for orthogonal frequency-division multiplexing signals, having a frequency-synchronization circuit”, which was granted to Flavio Daffara and Ottavio Adami on 11 Nov. 1997. In that method complex digital samples from the tail of each OFDM symbol are multiplied by the conjugates of corresponding digital samples from the cyclic prefix of the OFDM symbol. The resulting products are summed and low-pass filtered to develop the AFPC signal that the AFPC generator 680 supplies to the front-end tuner 67 for controlling the final local oscillator therein.

A fourth of the output ports of the pilot carriers processor 74 that are explicitly shown in FIG. 16 is connected for supplying information concerning the respective energies of unmodulated pilot carriers. This information is supplied to a maximal-ratio code combiner 80 shown at the foot of FIG. 16 and in more detail in FIG. 26. The code combiner 80 comprises elements 81, 82, 83, 84, 85, 86, 87, 88 and 89. The code combiner 80 is more fully described further on in this specification with reference to drawing FIG. 16. The portions of the pilot carriers processor 74 for generating information concerning the respective energies of unmodulated pilot carriers are shown in FIG. 17 and are described in more detail further on in this specification.

The DFT computer 73 is customarily constructed so it can demodulate any one of the 1K, 2K, 4 k, 8K, 16K and 32K options as to the number of OFDM carriers. If this be the case, the correct option is chosen responsive to information from the P1 symbol detector 69 depicted in FIG. 17. As noted supra, the second output port of the DFT computer 73 is connected to supply demodulated complex digital samples of the complex coordinates of QPSK or QAM constellations in parallel to the input port of the frequency-domain channel equalizer 75. To implement a simple form of frequency-domain channel equalization, the pilot carriers processor 74 measures the amplitudes of the demodulated pilot carriers to determine basic weighting coefficients for various portions of the frequency spectrum. The pilot carriers processor 74 then interpolates among the basic weighting coefficients to generate respective weighting coefficients supplied to the frequency-domain channel equalizer 75 with which to multiply the complex coordinates of QPSK or QAM constellations supplied from the DFT computer 73. Various alternative types of frequency-domain channel equalizer are also known.

The output port of the DFT computer 73 involves a plurality of connections for supplying respective sets of complex coordinates for QPSK or QAM constellations of respective OFDM carriers. The frequency-domain channel equalizer 75 weights each of these respective sets of complex coordinates for QPSK or QAM constellations of respective OFDM carriers received in parallel at its input port and supplies the weighted responses in parallel from its output port to the respective input ports of a bank 76 of parallel-to-series converters. The response of the one of the parallel-to-series converters in this bank 76 of them that is appropriate for the number of OFDM carriers in the DFT and the sort of modulation symbol constellations for those carriers is selected as the response supplied from the bank 76 of parallel-to-series converters for de-mapping of the modulation symbol constellations in that response.

As thusfar described, the FIG. 16 initial portion of a COFDM receiver is similar to the initial portions of COFDM receivers used for DVB in Europe. However, in a departure from customary practice, the response of the bank 76 of parallel-to-series converters is not supplied directly to a de-mapper for the successive QPSK or QAM constellations. Instead, it is supplied to the respective input ports of selectors 77 and 78.

The selector 77 selectively reproduces at its output port complex QPSK, 16QAM, 32QAM, 64QAM, 256QAM or 512QAM symbol map coordinates just for selected ones of those transmissions that are not repeated or for selected final ones of those transmissions that are repeated for iterative-diversity reception. The output port of the selector 77 is connected to a first of two input ports of a maximal-ratio code combiner 80 that combines symbol-map coordinates of delayed QPSK or QAM constellations from later transmissions of time-slices with symbol-map coordinates of QPSK or QAM constellations from earlier transmissions of the same time-slices. The combining is done in ratio determined by the relative root-mean-square (RMS) energies of the unmodulated pilot carriers that respectively accompany the earlier transmissions of the QPSK or QAM constellations and the later transmissions of the same constellations. The output port of the code combiner 80 is connected for supplying complex coordinates for QPSK or QAM constellations to de-mappers for those symbol constellations.

The input port of a selector 78 for initial transmissions is connected for receiving complex coordinates of modulation symbol constellations from the output port of the bank 76 of parallel-to serial converters. The output port of the selector 78 connects to the write-input port of a memory 79, and the read-output port of the memory 79 connects to the second input port of the maximal-ratio code combiner 80. The memory 79 is configured to revise the order of the complex coordinates of modulation symbol constellations initial transmissions for iterative-diversity reception and to delay them as read to the second input port of the code combiner 80, so as to concur in time with the complex coordinates of modulation symbol constellations in corresponding final transmissions applied to the first input port of the code combiner 80. That is, there is an offset between the write addressing and the read addressing of locations in memory 79 for temporarily storing those complex coordinates of modulation symbol constellations that in effect provides for de-rotating the circular DFT specifying those complex coordinates. This de-rotation is complementary to the rotation of circular DFT performed in the memory 57 in the FIG. 4 portion of the COFDM transmitter depicted in FIGS. 1-4.

Presumably the maximal-ratio code combiner 80 is a novel configuration, differing from the ordinary maximal-ratio code-combiner used to combine coding recovered from separate receivers of COFDM signals. An ordinary maximal-ratio code-combiner combines one-dimensional, real-only codes obtained from separately de-mapping paired QAM constellation maps. The maximal-ratio code combiner 80 is a special type of code-combiner, which combines the two-dimensional complex symbol-map coordinates of paired QPSK or QAM constellation maps to synthesize respective single QPSK or QAM constellation maps for de-mapping. When both the earlier transmissions of the QPSK or QAM constellations and the later transmissions of the same constellations are received in strength, the maximal-ratio combining of the two-dimensional coordinates of paired QPSK or QAM constellation maps permits improvement of coordinates estimation in the presence of additive white Gaussian noise (AWGN). This is because the coordinates of the paired QPSK or QAM constellation maps should be correlated, while the AWGN is uncorrelated. Accordingly, errors in de-mapping are less likely to occur, as well as gaps in reception tending to be filled. Maximal-ratio code combining after de-mapping QAM constellations tends to fill gaps in reception, but does not improve coordinates estimation of the paired QAM constellation maps in the presence of AWGN. FIG. 26 described further on in this specification depicts the maximal-ratio code combiner 80 in more detail, as comprising elements 81-89.

FIG. 17 depicts a controller 90 of decoding operations in the DTV receiver, but does not explicitly show the connections to elements of the receiver through which those elements are controlled. FIG. 17 shows the output port of the P1 symbol detector 69 connected to a respective input port of the controller 90. FIG. 17 further indicates that the input port of the P1 symbol detector 69 is connected for receiving baseband digitized COFDM signal from the front-end tuner 68 depicted in FIG. 16. The P1 symbol detector 69 detects each occurrence of a P1 symbol, which is based on a 1K OFDM symbol with frequency-shifted repeats at its beginning and its conclusion. A P1 symbol signals the beginning of a T2 frame, and the P1 symbol detector 69 supplies this important timing information to the controller 90. The structure of the P1 symbol facilitates easy detection thereof, as well as forestalling any possibility of its being imitated by any part of the signal within the ensuing T2 frame. Only a fraction of the 1K OFDM carrier positions convey energy, and these carry one of a set of carefully chosen data patterns to provide some capability for signaling the controller 90 for decoding operations in the DTV receiver. This format of P1 symbol provides (a) a simple and robust mechanism for rapid detection of T2 signals when a receiver scans through the appropriate spectrum band, (b) a fast frequency lock mechanism for the receiver and (c) 6-bits of signaling. E.g., these bits may be used for signaling the FFT size used for symbols in the T2 frame. If the DTV standard prescribes inverting the polarity of T2 frames of OFDM signals during initial transmissions, one of these bits can be reserved to signal such inversion.

FIG. 17 depicts a de-mapper 91 for successive coordinates of BPSK symbol constellations as supplied to its input port from the output port of the maximal-ratio code combiner 90. The de-mapper 91 supplies bits responsive to the respective parities of the COFDM carriers to reproduce bit-wise FEC coded L1-pre signaling, supplied from the output port of the de-mapper 91 to the input port of a decoder 92 for LDPC coding. The output port of the decoder 92 for LDPC coding is connected for supplying reproduced BCH coding to the input port of a decoder 93 for BCH coding, the output port of which is connected for supplying reproduced L1-pre signaling to a respective input port of the controller 90 of decoding operations within the DTV receiver.

FIG. 17 depicts a de-mapper 94 for successive complex coordinates of QPSK or QAM constellations as supplied to its input port from the output port of the maximal-ratio code combiner 80. ETSI standard EN 302 755 V1.3.1 prescribes BPSK, QPSK, 16QAM, or 64QAM constellations be used for L1-post signaling in DVB-T2. The de-mapper 94 responds to the complex coordinates descriptive of successive BPSK symbol constellations to recover a single soft bit of FEC coding from each constellation. The de-mapper 94 responds to the complex coordinates descriptive of successive QPSK constellations to recover two soft bits of FEC coding from each constellation. The de-mapper 94 responds to the complex coordinates descriptive of successive 16QAM constellations to recover four soft bits of FEC coding from each constellation. The de-mapper 94 responds to the complex coordinates descriptive of successive 64QAM constellations to recover six soft bits of FEC coding from each constellation. In any one of these four cases, the de-mapper 94 supplies the soft bits of FEC coding from its output port to the input port of a de-interleaver 95 of the interleaving of those soft bits, introduced by the bit interleaver 49 in the FIG. 3 portion of the DTV transmitter. The design of the interleaver 95 is different for different ones of these four cases. The output port of the de-interleaver 95 connects to the input port of a soft-input/soft-output decoder 96 for decoding LDPC coding. The output port of the SISO decoder 96 is connected for supplying soft bits of BCH coding to the input port of a soft-input decoder 97 for decoding BCH coding.

FIG. 17 shows the output port of the BCH decoder 97 connected to the input port of a bits descrambler 98. The output port of the bits descrambler 98 is connected for supplying L1-post signaling to a respective input port of the controller 90 of decoding operations within the DTV receiver. The L1-post signaling has CRC-8 coding, which coding can be decoded within the controller 90 to verify whether or not the L1-post signaling received by the controller 90 is correct.

FIG. 18 depicts a de-mapper 99 for successive complex coordinates of 16QAM, 32QAM, 64QAM, 256QAM or 512QAM constellations as supplied to its input port from the output port of the maximal-ratio code combiner 80. The de-mapper 99 responds to the complex QAM coordinates descriptive of successive 16QAM constellations to recover four soft bits of FEC coding from each constellation. Alternatively, the de-mapper 99 responds to the soft complex QAM coordinates descriptive of successive 32QAM constellations to recover five soft bits of FEC coding from each constellation. Alternatively, the de-mapper 99 responds to the soft complex QAM coordinates descriptive of successive 64QAM constellations to recover six soft bits of FEC coding from each constellation. Alternatively, the de-mapper 99 responds to the soft complex QAM coordinates descriptive of successive 256QAM constellations to recover eight soft bits of FEC coding from each constellation. Alternatively, the de-mapper 99 responds to the soft complex QAM coordinates descriptive of successive 512QAM constellations to recover nine soft bits of FEC coding from each constellation. In any one of these five cases, the de-mapper 99 supplies the soft bits of FEC coding from its output port to the input port of a de-interleaver 100 of the interleaving of those soft bits, introduced by the bit interleavers 33, 43, 53 etc. in the FIG. 2 portion of the DTV transmitter. The output port of the de-interleaver 100 connects to the input port of a soft-input/soft-output decoder 101 for decoding multilevel concatenated BCH/LDPCCC in accordance with an aspect of the invention. FIG. 18 indicates the de-interleaver 100 to be optional. If the bit interleavers 33, 43, 53 etc. are replaced by respective direct connections in the FIG. 2 transmitter apparatus, the de-interleaver 100 is replaced by direct connection from the output port of the de-mapper 99 to the SISO decoder 101.

FIG. 18 shows the output port of the SISO decoder 101 connected to the input port of a baseband-frame (BBFRAME) descrambler 102, the output port of which connects to the input port of an IP packet parser 103. The IP packet parser 103 locates the start of the first IP packet that begins in a BBFRAME responsive to indications in the BBFRAME header and then locates the start of any further IP packet that begins in the same BBFRAME by daisy-chaining from indications in the header of the immediately preceding IP packet. Also, daisy-chaining from indications in the header of the immediately preceding IP packet can be used to verify the location of the start of the first IP packet that begins in a BBFRAME.

FIG. 18 shows the output port of the IP packet parser 103 connected to supply IP packets to the input port of a packet sorter 104 for sorting them according to their packet identification sequences (PIDs). FIG. 18 shows a first output port of the IP packet sorter 104 connected for supplying video data packets to the input port of apparatus 105 for utilizing video data packets, which apparatus typically includes a video-data-packet decoder at the outset thereof. FIG. 18 shows a second output port of the IP packet sorter 104 connected for supplying audio data packets to the input port of apparatus 106 for utilizing audio data packets, which apparatus typically includes an audio-data-packet decoder at the outset thereof. FIG. 18 shows a third output port of the IP packet sorter 104 connected for supplying ancillary data packets to the input port of apparatus 107 for utilizing ancillary data packets, which apparatus typically includes an ancillary-data-packet decoder at the outset thereof. In practice, the packet sorter 104 is likely to be subsumed within respective packet-selection input circuitry of the apparatus 105 for utilizing video data packets, of the apparatus 106 for utilizing audio data packets and of the apparatus 107 for utilizing ancillary data packets.

The IP packets supplied from the IP packet parser 103 include CRC-8 coding in their headers. This CRC-8 coding could be decoded before the IP packets are sorted according to their PIDs, thus to determine whether or not each IP packet reproduced at the output port of the IP packet parser 103 is presumably free of error. In usual designs, however, this CRC-8 coding is decoded within the apparatus 105 for utilizing video data packets, within the apparatus 106 for utilizing audio data packets, and within the apparatus 107 for utilizing ancillary data packet decoders. Such decoding of CRC-8 coding confirms whether or not each IP packet sorted to the apparatus 105, to the apparatus 106 or to the apparatus 107 is correct or is erroneous.

FIG. 19 depicts a modification of the FIG. 16 portion of the COFDM receiver apparatus further depicted in FIGS. 17 and 18. As noted supra, the frequency-domain channel equalizer 75 weights each of respective sets of complex coordinates for QPSK or QAM constellations of respective OFDM carriers received in parallel at its input port. The channel equalizer 75 supplies the weighted responses in parallel from its output port to the respective input ports of a bank 76 of parallel-to-series converters. The output port of the bank 76 of parallel-to-series converters is connected for supplying complex QPSK or QAM symbol map coordinates to the input port of the selector 77. The selector 77 selectively reproduces at its output port complex QPSK or QAM symbol map coordinates just for transmissions that are not subsequently repeated and for transmissions repeated for iterative-diversity reception. The output port of the selector 77 is connected to the first input port of the maximal-ratio code combiner 80.

In a departure from customary practice and from what FIG. 16 depicts, the connections to the input ports of a bank 109 of parallel-to-series converters are arranged so as in effect to de-rotate the circular DFT components computed by the DFT computer 73. The response of the one of the parallel-to-series converters in this bank 109 of them that is appropriate for the number of OFDM carriers in the DFT and the sort of modulation symbol constellations for those carriers is selected as the response supplied from the bank 109 of parallel-to-series converters. The output port of the bank 109 of parallel-to-series converters is connected for supplying complex QPSK or QAM symbol map coordinates to the input port of the selector 78. The selector 78 selectively reproduces at its output port complex QPSK or QAM symbol map coordinates just for initial transmissions that are subsequently repeated for iterative-diversity reception. The output port of the selector 78 is connected to the write input port of a memory 110 configured to delay the selected initial ones of those transmissions subsequently repeated for iterative-diversity reception so as to concur in timing with corresponding final ones of those transmissions as repeated for iterative-diversity reception.

The memory 110 is operable for delaying the PSK or QAM symbol map coordinates read in normal time-sequential order from a read-output port thereof to the second input port of the code combiner 80. The delay is for N super-frame periods plus a time-slice interval. This delay can be prescribed fixed delay or, alternatively, can be programmable responsive to delay specified by bits in L1-pre signaling. Were it not for corruption caused by noise and fading, the PSK or QAM symbol map coordinates read from the memory 110 to the second input port of the code combiner 80 would concur with the PSK or QAM symbol map coordinates supplied by the selector 77 to the first input port of the code combiner 80. Since the memory 110 simply provides delay and is not used for de-rotating components from rotated circular DFT, it can be serial memory. If the memory 110 be random-access memory, its read addressing can be generated simply by adding a constant offset to its write addressing, which is generally provided from a counter. That is, the addressing of a random-access memory 110 as configured for FIG. 19 is simpler to provide than is the addressing of a random-access memory configured, not only to delay the COFDM symbols of initial transmissions of the DTV data, but also to de-rotate them, as required of the memory 79 depicted in FIG. 16.

The decoder 101 for decoding multilevel concatenated BCH/LDPCCC depicted in FIG. 18 is apt to be a microprocessor having its own memory, which microprocessor responds to commands derived from the configurable portion of L1-post signaling to implement decoding of one of the types of LDPCCC that are transmitted in accordance with a broadcast standard. The de-interleaver 100 for bit interleaving is apt to be subsumed into the addressing of that memory when soft bits are written thereto.

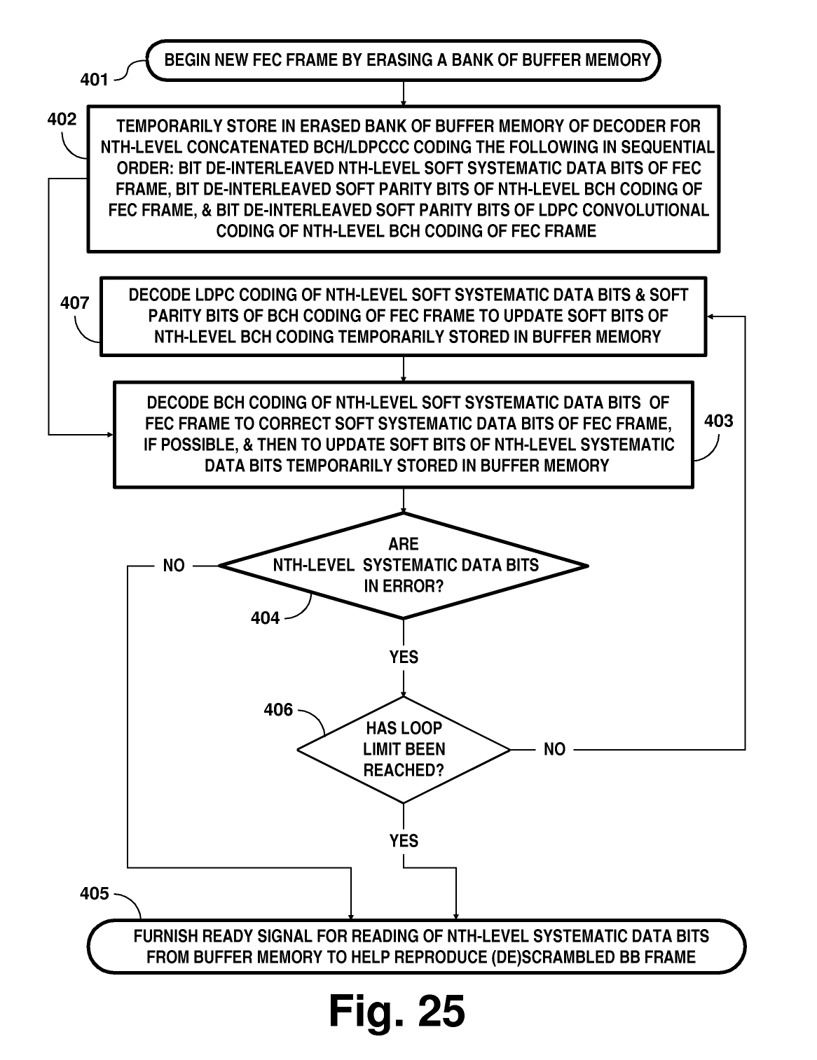

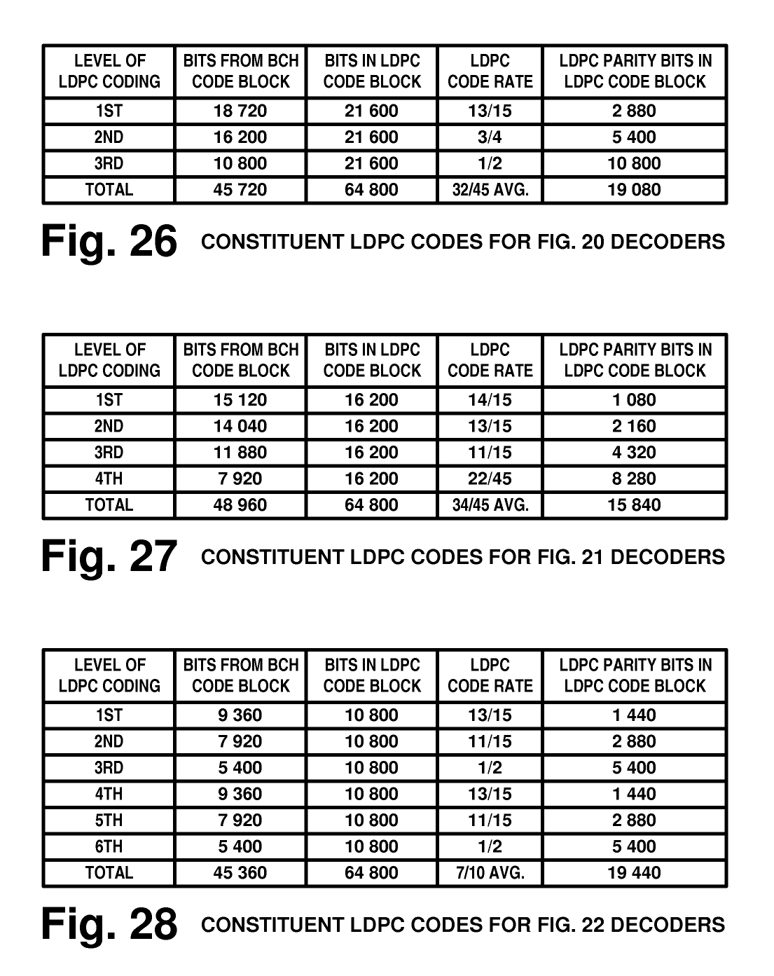

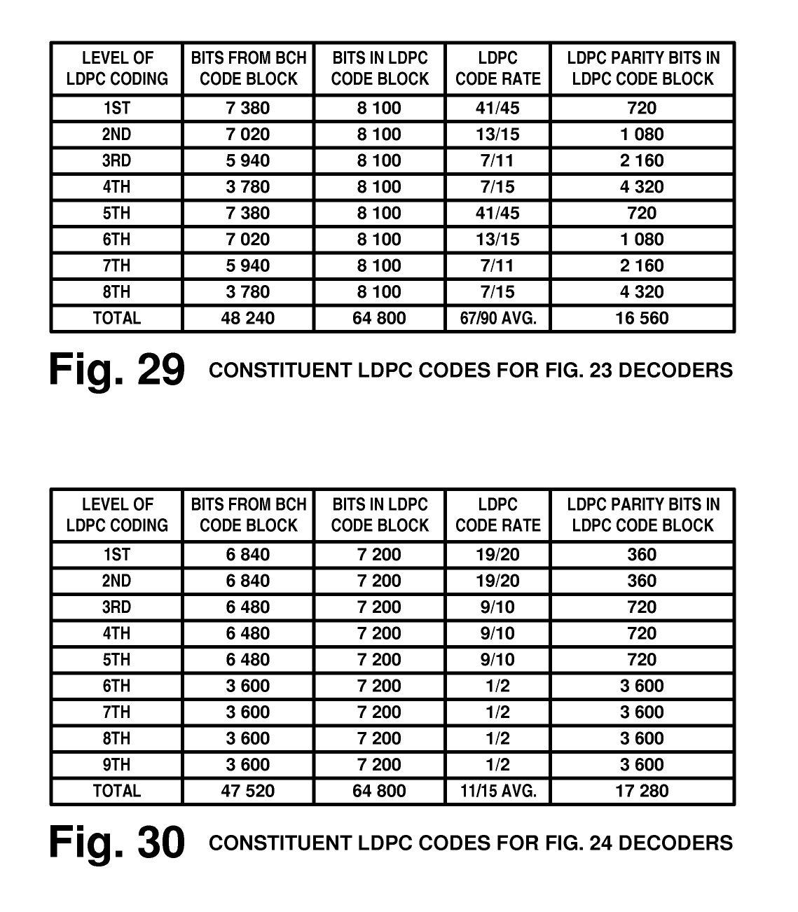

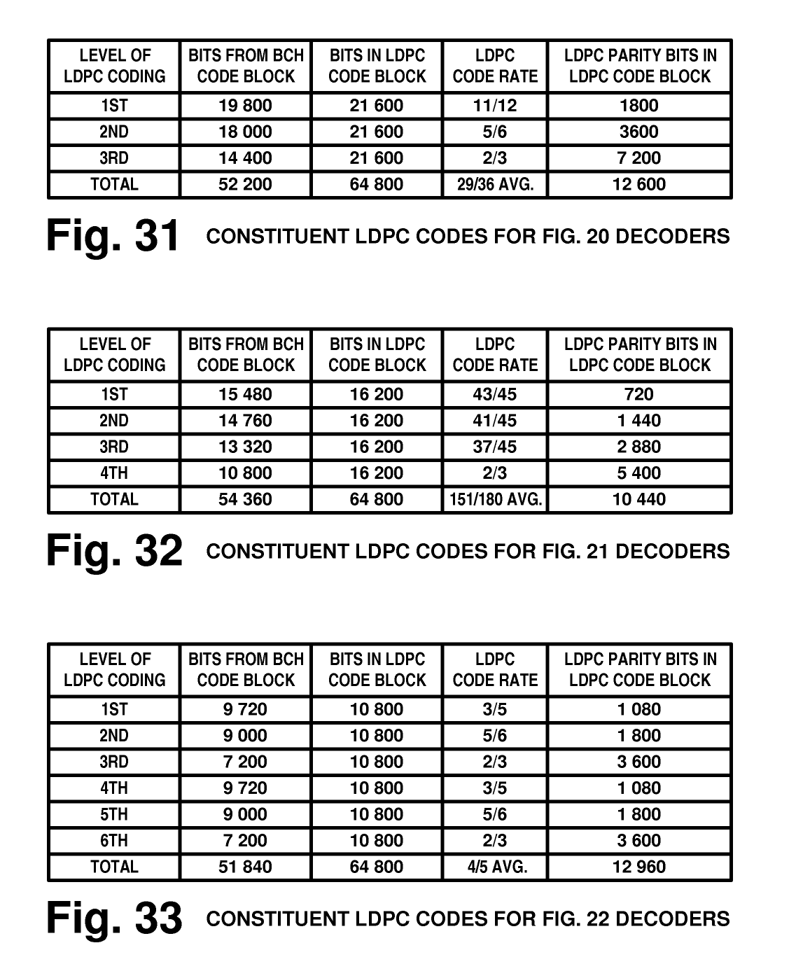

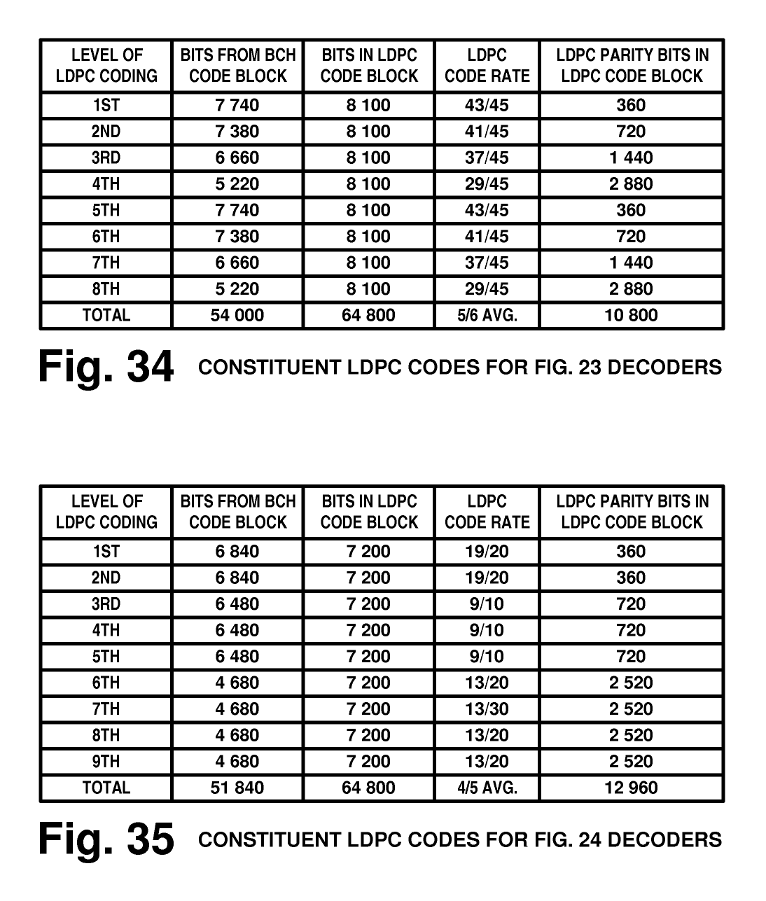

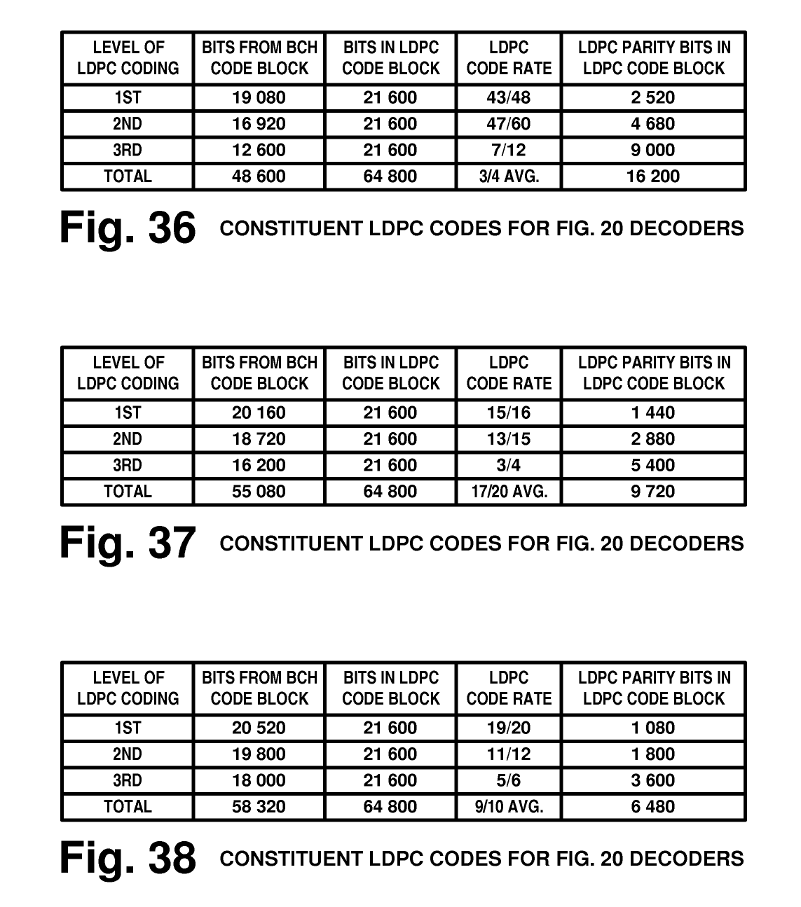

FIG. 20 is a schematic diagram for conceptually illustrating a first way in which the decoder 101 is configured for decoding multilevel concatenated BCH/LDPCCC recovered by de-mapping 64QAM constellations. FIG. 20 shows the output port of the de-interleaver 100 for bit interleaving connected to the input port of a sorter 351 of the soft bits received from the de-interleaver into three levels of multilevel concatenated BCH/LDPCCC. I. e., the multilevel concatenated BCH/LDPCCC is of the form illustrated in FIG. 8. FIG. 20 shows the sorter 351 having first, second and third output ports connected for supplying the first, second and third levels of multilevel concatenated BCH/LDPC coding to the input port of a decoder 352 for first-level concatenated BCH/LDPCCC, to the input port of a decoder 353 for second-level concatenated BCH/LDPCCC and to the input port of a decoder 354 for third-level concatenated BCH/LDPCCC, respectively. The sorter 351 is typically realized by suitable write and read addressing of plural-bank memory associated with a microprocessor construction of the decoder 101. A plural-bank memory comprising separate buffer memories for the decoders 352, 353 and 354 facilitates concurrent decoding of the three levels of concatenated BCH/LDPCCC. FIG. 20 shows apparatus 355 for reading to the input port of the BBFRAME descrambler 102 from the separate buffer memories for the decoders 352, 353 and 354 after iterative concatenated BCH/LDPCCC decoding procedures are completed. This reading is done so as to time-division multiplex output bits generated by the decoders 352, 353 and 354 so as to recover systematic data bits of the FEC frame in the same temporal order they had originally in the BICM interface signal supplied to the input port of the sorter 300 in the portion of the transmitter apparatus depicted in FIG. 6. Unless there is need to support still further FEC coding of the systematic data bits, these bits can be hard bits, which simplifies the structure required of the BBFRAME descrambler 102.

In actual practice the function of the BBFRAME descrambler 102 depicted in FIG. 20 is apt to be subsumed into the separate buffer memories for the decoders 352, 353 and 354. The apparatus 355 is modified to supply suitable addressing for reading from storage locations within those memories to the input port of the IP packet parser 103 after iterative concatenated BCH/LDPC decoding procedures are completed.

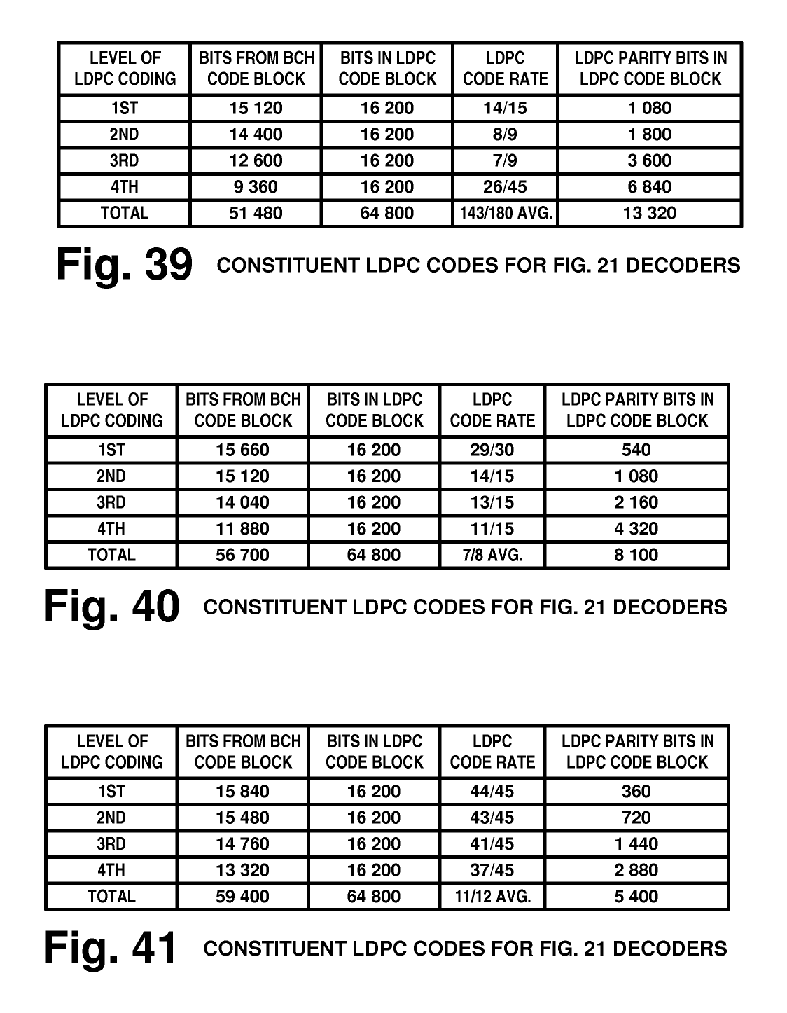

FIG. 21 is a schematic diagram for conceptually illustrating a first way in which the decoder 101 is configured for decoding multilevel concatenated BCH/LDPCCC recovered by de-mapping 256QAM constellations. FIG. 21 shows the output port of the de-interleaver 100 for bit interleaving connected to the input port of a sorter 361 of the soft bits received from the de-interleaver into four levels of multilevel concatenated BCH/LDPCCC. I. e., the multilevel concatenated BCH/LDPCCC is of the form illustrated in FIG. 9. FIG. 21 shows the sorter 361 having first, second, third and fourth output ports connected for supplying the first, second, third and fourth levels of multilevel concatenated BCH/LDPCCC to the input port of a decoder 362 for first-level concatenated BCH/LDPCCC, to the input port of a decoder 363 for second-level concatenated BCH/LDPCCC, to the input port of a decoder 364 for third-level concatenated BCH/LDPCCC and to the input port of a decoder 365 for fourth-level concatenated BCH/LDPCCC, respectively. The sorter 361 is typically realized by suitable write and read addressing of the plural-bank memory associated with a microprocessor construction of the decoder 101. A plural-bank memory comprising separate buffer memories for the decoders 362, 363, 364 and 365 facilitates concurrent decoding of the four levels of concatenated BCH/LDPCCC. FIG. 21 shows apparatus 366 for reading to the input port of the BBFRAME descrambler 102 from the separate buffer memories for the decoders 362, 363, 364 and 365 after iterative concatenated BCH/LDPC decoding procedures are completed. This reading is done so as to time-division multiplex soft output bits generated by the decoders 362, 363, 364 and 365 so as to recover systematic data bits of the FEC frame in the same temporal order they had originally in the BICM interface signal supplied to the input port of the sorter 310 in the portion of the transmitter apparatus depicted in FIG. 7. Unless there is need to support still further FEC coding of the systematic data bits, these bits can be hard bits, which simplifies the structure required of the BBFRAME descrambler 102.

In actual practice the function of the BBFRAME descrambler 102 depicted in FIG. 21 is apt to be subsumed into the separate buffer memories for the decoders 362, 363, 364 and 365. The apparatus 366 is modified to supply suitable addressing for reading from storage locations within those memories to the input port of the IP packet parser 103 after iterative concatenated BCH/LDPCCC decoding procedures are completed.

FIG. 22 is a schematic diagram for conceptually illustrating a second way in which the decoder 101 is configured for decoding multilevel concatenated BCH/LDPCCC recovered by de-mapping 64QAM constellations. FIG. 22 shows the output port of the de-interleaver 100 for bit interleaving connected to the input port of a sorter 371 of the soft bits received from the de-interleaver into six levels of multilevel concatenated BCH/LDPCCC, rather than just three levels. I. e., the multilevel coding is of the form illustrated in FIG. 11. FIG. 22 shows the sorter 371 having first, second, third, fourth, fifth and sixth output ports connected for supplying the first, second, third, fourth, fifth and sixth levels of multilevel LDPC coding to the input port of a decoder 372 for first-level concatenated BCH/LDPCCC, to the input port of a decoder 373 for second-level concatenated BCH/LDPCCC, to the input port of a decoder 374 for third-level concatenated BCH/LDPCCC, to the input port of a decoder 375 for fourth-level concatenated BCH/LDPCCC, to the input port of a decoder 376 for fifth-level concatenated BCH/LDPCCC and to the input port of a decoder 377 for sixth-level concatenated BCH/LDPCCC, respectively. The sorter 371 is typically realized by suitable write and read addressing of the plural-bank memory associated with a microprocessor construction of the decoder 101. A plural-bank memory comprising separate buffer memories for the decoders 372, 373, 374, 375, 376 and 377 facilitates concurrent decoding of the six levels concatenated BCH/LDPCCC. FIG. 22 shows apparatus 378 for reading to the input port of the BBFRAME descrambler 102 from the separate buffer memories for the decoders 372, 373, 374, 375, 376 and 377 after iterative concatenated BCH/LDPCCC decoding procedures are completed. This reading is done so as to time-division multiplex soft output bits generated by the decoders 372, 373, 374, 375, 376 and 377 so as to recover systematic data bits of the FEC frame in the same temporal order they had originally in the BICM interface signal supplied to the input port of the sorter 322 in the portion of the transmitter apparatus depicted in FIG. 10. Unless there is need to support still further FEC coding of the systematic data bits, these bits can be hard bits, which simplifies the structure required of the BBFRAME descrambler 102.

In actual practice the function of the BBFRAME descrambler 102 depicted in FIG. 22 is apt to be subsumed into the separate buffer memories for the decoders 372, 373, 374, 375, 376 and 377. The apparatus 378 is modified to supply suitable addressing for reading from storage locations within those memories to the input port of the IP packet parser 103 after iterative concatenated BCH/LDPCCC decoding procedures are completed.

FIG. 23 is a schematic diagram for conceptually illustrating a second way in which the decoder 101 is configured for decoding multilevel concatenated BCH/LDPCCC recovered by de-mapping 256QAM constellations. FIG. 23 shows the output port of the de-interleaver 100 for bit interleaving connected to the input port of a sorter 379 of the soft bits received from the de-interleaver into eight levels of multilevel concatenated BCH/LDPCCC, rather than just four levels. I. e., the multilevel coding is of the form illustrated in FIG. 13. FIG. 23 shows the sorter 379 having first, second, third, fourth, fifth, sixth, seventh and eighth output ports connected for supplying the first, second, third, fourth, fifth, sixth, seventh and eighth levels of multilevel concatenated BCH/LDPCCC to the input port of a decoder 380 for first-level concatenated BCH/LDPCCC, to the input port of a decoder 381 for second-level LDPCCC, to the input port of a decoder 382 for third-level concatenated BCH/LDPCCC, to the input port of a decoder 383 for fourth-level concatenated BCH/LDPCCC, to the input port of a decoder 384 for fifth-level concatenated BCH/LDPCCC, to the input port of a decoder 385 for sixth-level concatenated BCH/LDPCCC, to the input port of a decoder 386 for seventh-level concatenated BCH/LDPCCC and to the input port of a decoder 387 for eighth-level concatenated BCH/LDPCCC, respectively. The sorter 379 is typically realized by suitable write and read addressing of the plural-bank memory associated with a microprocessor construction of the decoder 101. A plural-bank memory comprising separate buffer memories for the decoders 380, 381, 382, 383, 384, 385, 386 and 387 facilitates concurrent decoding of the eight levels of concatenated BCH/LDPCCC. FIG. 23 shows apparatus 388 for reading to the input port of the BBFRAME descrambler 102 from the separate buffer memories for the decoders 380, 381, 382, 383, 384, 385, 386 and 387 after iterative LDPC decoding procedures are completed. This reading is done so as to time-division multiplex soft output bits generated by the decoders 380, 381, 382, 383, 384, 385, 386 and 387 so as to recover systematic data bits of the FEC frame in the same temporal order they had originally in the BICM interface signal supplied to the input port of the sorter 330 in the portion of the transmitter apparatus depicted in FIG. 12. Unless there is need to support still further FEC coding of the systematic data bits, these bits can be hard bits, which simplifies the structure required of the BBFRAME descrambler 102.

In actual practice the function of the BBFRAME descrambler 102 depicted in FIG. 23 is apt to be subsumed into the separate buffer memories for the decoders 380, 381, 382, 383, 384, 385, 386 and 387. The apparatus 388 is modified to supply suitable addressing for reading from storage locations within those memories to the input port of the IP packet parser 103 after iterative concatenated BCH/LDPCCC decoding procedures are completed.

FIG. 24 is a schematic diagram for conceptually illustrating how the decoder 101 is configured for decoding multilevel concatenated BCH/LDPCCC recovered by de-mapping 512QAM constellations. FIG. 24 shows the output port of the de-interleaver 100 for bit interleaving connected to the input port of a sorter 389 of the soft bits received from the de-interleaver into nine levels of multilevel concatenated BCH/LDPCCC. I. e., the multilevel coding is of the form illustrated in FIG. 15. FIG. 24 shows the sorter 389 having first, second, third, fourth, fifth, sixth, seventh, eighth and ninth output ports connected for supplying the first, second, third, fourth, fifth, sixth, seventh, eighth and ninth levels of multilevel concatenated BCH/LDPCCC to the input port of a decoder 390 for first-level concatenated BCH/LDPCCC, to the input port of a decoder 391 for second-level concatenated BCH/LDPCCC, to the input port of a decoder 392 for third-level concatenated BCH/LDPCCC, to the input port of a decoder 393 for fourth-level concatenated BCH/LDPCCC, to the input port of a decoder 394 for fifth-level concatenated BCH/LDPCCC, to the input port of a decoder 395 for sixth-level concatenated BCH/LDPCCC, to the input port of a decoder 396 for seventh-level concatenated BCH/LDPCCC, to the input port of a decoder 397 for eighth-level concatenated BCH/LDPCCC and to the input port of a decoder 398 for ninth-level concatenated BCH/LDPCCC, respectively. The sorter 389 is typically realized by suitable write and read addressing of the plural-bank memory associated with a microprocessor construction of the decoder 101. A plural-bank memory comprising separate buffer memories for the decoders 390, 391, 392, 393, 394, 395, 396, 397 and 398 facilitates concurrent decoding of the nine levels of concatenated BCH/LDPCCC. FIG. 24 shows apparatus 399 for reading to the input port of the BBFRAME descrambler 102 from the separate buffer memories for the decoders 390, 391, 392, 393, 394, 395, 396, 397 and 398 after iterative concatenated BCH/LDPCCC decoding procedures are completed. This reading is done so as to time-division multiplex soft output bits generated by the decoders 390, 391, 392, 393, 394, 395, 396, 397 and 398 so as to recover systematic data bits in the same temporal order they had originally in the BICM interface signal supplied to the input port of the sorter 340 in the portion of the transmitter apparatus depicted in FIG. 14. Unless there is need to support still further FEC coding of the systematic data bits, these bits can be hard bits, which simplifies the structure required of the BBFRAME descrambler 102.

In actual practice the function of the BBFRAME descrambler 102 depicted in FIG. 24 is apt to be subsumed into the separate buffer memories for the decoders 390, 391, 392, 393, 394, 395, 396, 397 and 398. The apparatus 399 is modified to supply suitable addressing for reading from storage locations within those memories to the input port of the IP packet parser 103 after iterative concatenated BCH/LDPCCC decoding procedures are completed.

FIG. 25 is a flow chart illustrating operation of a decoder for Nth-level concatenated BCH/LDPCCC. The FIG. 25 flow chart illustrates the operation of each of the three decoders 352, 353 and 354 depicted in FIG. 20. The FIG. 25 flow chart illustrates the operation of each of the four decoders 362, 363, 364 and 365 depicted in FIG. 21. The FIG. 25 flow chart illustrates the operation of each of the six decoders 372, 373, 374, 375, 376 and 377 depicted in FIG. 22. The FIG. 25 flow chart illustrates the operation of each of the eight decoders 380, 381, 382, 383, 384, 385, 386 and 387 depicted in FIG. 23. The FIG. 25 flow chart illustrates the operation of each of the nine decoders 390, 391, 392, 393, 394, 395, 396, 397 and 398 depicted in FIG. 24.

Preferably, the buffer memory associated with each decoder for Nth-level concatenated BCH/LDPCCC is divided into two (or more) banks. This allows one of the banks to be loaded with one of the levels of multilevel concatenated BCH/LDPCCC from a new FEC frame, while the central processing unit (CPU) of the decoder processes a level of BCH/LDPCCC from a prior FEC frame temporarily stored in another bank of the buffer memory. Each cycle of operation of the soft-input/soft-output (SISO) decoder for an Nth one of the levels of multilevel concatenated BCH/LDPCCC starts with a step 401 of beginning a new FEC frame with bulk erasure of a bank of the buffer memory associated with that decoder. In a subsequent step 402 the following elements of the Nth level of the multilevel concatenated BCH/LDPCCC are written into storage locations in the buffer memory for temporary storage therein. The bit de-interleaved soft systematic data bits are followed by soft parity bits for BCH coding, all of which bits are extracted from that Nth level of the multilevel concatenated BCH/LDPCCC from the current FEC frame. The soft parity bits of BCH coding of that Nth level are followed by soft parity bits of the constituent LDPCCC of that Nth level. The substeps of extracting these sets of bits concerning the Nth level are carried out by using appropriate write addressing of the storage locations in the buffer memory, in conjunction with controlling bit selection procedures with suitable write-enable commands for the buffer memory generated by the decoder CPU. The write addressing of the storage locations in the buffer memory are typically generated by a write-address counter included in the decoder CPU.

The step 402 of temporarily storing the Nth level of the multilevel concatenated BCH/LDPC coding of an FEC frame is followed by a step 403 of decoding the BCH coding of that Nth level, so as to reproduce soft bits of the BCH coding of that Nth level. In a substep of the step 403 the decoder CPU can analyze the respective confidence levels of the soft bits of the BCH coding of that Nth level in order to locate bit errors for decoding the BCH coding, which allows decoding algorithms that correct more bit errors in the Nth-level bits of each FEC frame to be used. A part of the result of the step 403 of decoding the BCH coding of the Nth level is an indication of whether or not the systematic data bits in the Nth level have been found to be in error.

This indication is input for a decision step 404 as to whether or not the systematic data bits in the Nth level are in error. If the decision in step 404 is that the systematic data bits in the Nth level are not in error, the concatenated BCH/LDPCCC decoding procedures for the Nth level are concluded with the step 405, in which step 405 the BCH/LDPCCC decoder furnishes the apparatus 355, 366, 378, 388 or 399 a signal to indicate that the systematic data bits in its buffer memory are ready to be read therefrom.

If the decision in step 404 is that the systematic data bits in the Nth level are in error, this decision is input for a subsequent decision step 406 as to whether a loop limit has been reached in regard to iterative decoding of the Nth level of concatenated BCH/LDPCCC. If the decision in step 406 is that the loop limit has been reached, the concatenated BCH/LDPCCC decoding procedures for the Nth level are concluded with the step 405, in which step 405 the BCH/LDPCCC decoder furnishes the apparatus 355, 366, 378, 388 or 399 a signal to indicate that the systematic data bits in its buffer memory are ready to be read therefrom even though some of those bits are likely be in error.

If the decision in step 406 is that the loop limit has not yet been reached, a subsequent cycle of iterative decoding of the Nth level of concatenated BCH/LDPCCC is begun, with operation looping back to a step 407 of decoding the LDPCCC of that Nth level. This step 407 is followed by another step 403 of decoding the BCH coding of that Nth level, so as to reproduce soft bits of the BCH coding of that Nth level. The step 407 of decoding the LDPCCC changes with each iteration thereof, per customary iterative decoding procedure for LDPCCC.

The initial cycle of iterative decoding of the Nth level of concatenated BCH/LDPCCC omits the step 407 of decoding the LDPCCC of that level and proceeds directly to an initial step 403 of decoding the BCH coding of that level. If it is decided in that initial step 403 that the Nth level of concatenated BCH/LDPCCC is correctly received, decoding the LDPCCC of that level can be skipped so as to avoid the drain of operating power for a subsequent step 407 of decoding the LDPCCC. This saving in power consumption is primarily of concern for battery-powered DTV receivers, where the saving can help extend battery life.

The various configurations of the decoder 101 for decoding multilevel LDPCCC depicted in FIGS. 20, 21, 22, 23 and 24 each show separate levels of multilevel concatenated BCH/LDPCCC decoded by respective ones of a plurality of parallel independent decoders. Preferably, each of the parallel independent decoders depicted in FIGS. 20, 21, 22, 23 and 24 serially decodes the constituent LDPCCC for a particular level of the multilevel concatenated BCH/LDPCCC. Interestingly, the component parallel independent decoders included in all of the parallel independent decoders depicted in each one of the FIGS. 20, 21, 22, 23 and 24 can be the same as the component parallel independent decoders included in any other one of the parallel independent decoders depicted in each one of the FIGS. 20, 21, 22, 23 and 24. This facilitates practical construction of a DTV receiver that can receive multilevel LDPCCC whether it be transmitted using 16QAM, 32QAM, 64QAM, 256QAM or 512QAM of the OFDM carriers.

FIG. 26 is a table of characteristics of constituent LDPC codes in three levels of LDPCCC-MLC in a 64,800-bit FEC Frame de-mapped from 64QAM symbol constellations in a COFDM signal, the third level of LDPCCC most likely to exhibit error in an AWGN channel having a code rate of one-half. This LDPCCC-MLC is expected to have performance in the presence of AWGN slightly better than that of single-level LDPC block coding having a code rate of one-half, but the LDPCCC-MLC has an average code rate of thirty-two forty-fifths or 0.711. Single-level LDPC block coding having a code rate of one-half would have 32,208 systematic data bits in each 64,800-bit FEC Frame, presuming there were 192 parity bits per BCH code block. The LDPCCC-MLC tabulated in FIG. 26 has 45,720−3(192)=45,144 systematic data bits in each 64,800-bit FEC Frame, presuming there are 192 parity bits per each of the three levels of LDPCCC coding. The LDPCCC-MLC tabulated in FIG. 26 has 12, 396 more systematic data bits per 64,800-bit FEC Frame than single-level LDPC block coding having a one-half code rate. However, a number of these systematic data bits in each level of the LDPCCC are terminating bits, rather than bits of DTV IP packets. Assuming there are 360 terminating bits in each of the three levels of the LDPCCC-MLC tabulated in FIG. 26, that LDPCCC-MLC conveys 44,064 bits of DTV IP packets per 64,800-bit FEC Frame. So, the digital payload of the LDPC-MLC tabulated in FIG. 26 is slightly more than 36.8% greater than the single-level LDPC block coding having a one-half code rate.

The ratio of the number of LDPCCC parity bits in the first of the three levels of the LDPCCC-MLC tabulated in FIG. 26 to the numbers of LDPCCC parity bits in the second and third of those three levels is somewhat larger than 1:2:4. This is so the number of LDPCCC parity bits in that first level is a multiple of 360, to accommodate properly terminating the first-level constituent LDPCCC.

FIG. 27 is a table of characteristics of constituent LDPC convolutional codes in four levels of LDPCCC-MLC in a 64,800-bit FEC Frame de-mapped from 256QAM symbol constellations in a COFDM signal, the fourth level of LDPCCC most likely to exhibit error in an AWGN channel having a code rate of a little more than one-half. This LDPCCC-MLC is expected to have performance in the presence of AWGN somewhat better than that of single-level LDPC block coding having a code rate of one-half, but the LDPC-MLC has an average code rate of thirty-four forty-fifths or 0.756. The LDPCCC-MLC tabulated in FIG. 27 has 48,960−4(192)=48,192 systematic data bits in each 64,800-bit FEC Frame, presuming there are 192 parity bits per each of the four levels of LDPCCC. The LDPCCC-MLC tabulated in FIG. 27 has 15,984 more systematic data bits per 64,800-bit FEC Frame than the single-level LDPC block coding having a one-half code rate. However, a number of these systematic data bits in each level of the LDPCCC are terminating bits, rather than bits of DTV IP packets. Assuming there are 360 terminating bits in each of the four levels of the LDPCCC-MLC tabulated in FIG. 27, that LDPCCC-MLC conveys 46,752 bits of DTV IP packets per 64,800-bit FEC Frame. So, the digital payload of the LDPCCC-MLC tabulated in FIG. 27 is slightly less than 45.2% greater than the single-level LDPC block coding having a one-half code rate.

The ratio of the number of LDPCCC parity bits in the four levels of the LDPCCC-MLC tabulated in FIG. 27 differs somewhat from 1:2:4:8, being 1:2:4:(23/3). This is so the number of LDPCCC parity bits in each of the four levels is a multiple of 360, to accommodate properly terminating the constituent LDPC convolutional codes.

FIG. 28 is a table of characteristics of constituent LDPC convolutional codes in six levels of LDPCCC-MLC in a 64,800-bit FEC Frame de-mapped from 64QAM symbol constellations in a COFDM signal, the levels of LDPCCC most likely to exhibit error in an AWGN channel having a code rate of one-half. This LDPCCC-MLC has an average code rate of seven tenths or 0.700, but is expected to have performance in the presence of AWGN substantially equal to that of single-level LDPC block coding having a code rate of one-half. The ratio of the number of LDPCCC parity bits in the six levels of the LDPCCC-MLC tabulated in FIG. 28 differs somewhat from 1:2:4:1:2:4 so the number of LDPCCC parity bits in each of the six levels is a multiple of 360, to accommodate properly terminating the constituent LDPC convolutional codes. The LDPCCC-MLC tabulated in FIG. 28 has 45,360−6(192)=44,208 systematic data bits in each 64,800-bit FEC Frame, presuming there are 192 parity bits per each of the six levels of LDPCCC. The LDPCCC-MLC tabulated in FIG. 28 has 12,000 more systematic data bits per 64,800-bit FEC Frame than the single-level LDPC block coding having a one-half code rate. Assuming there are 360 terminating bits in each of the six levels of the LDPCCC-MLC tabulated in FIG. 28, that LDPCCC-MLC conveys 42,048 bits of DTV IP packets per 64,800-bit FEC Frame. So, the digital payload of the LDPCCC-MLC tabulated in FIG. 28 is slightly less than 30.6% greater than the single-level LDPC block coding having a one-half code rate.

FIG. 29 is a table of characteristics of constituent LDPC convolutional codes in eight levels of LDPCCC-MLC in a 64,800-bit FEC Frame de-mapped from 256QAM symbol constellations in a COFDM signal, the levels of LDPCCC most likely to exhibit error in an AWGN channel having a one-half code rate. This LDPCCC-MLC has an average code rate of sixty-seven ninetieths or 0.744, but is expected to have performance in the presence of AWGN somewhat better than that of single-level LDPC block coding having a code rate of one-half. The ratio of the number of LDPCCC parity bits in the eight levels of the LDPCCC-MLC tabulated in FIG. 29 differs somewhat from 1:2:4:8:1:2:4:8 so the number of LDPCCC parity bits in each of the eight levels is a multiple of 360, to accommodate properly terminating the constituent LDPC convolutional codes. The LDPCCC-MLC tabulated in FIG. 29 has 48,240−8(192)=46,704 systematic data bits in each 64,800-bit FEC Frame, presuming there are 192 parity bits per each of the eight levels of LDPC coding. The LDPCCC-MLC tabulated in FIG. 29 has 14,496 more systematic data bits per 64,800-bit FEC Frame than the single-level LDPC block coding having one-half code rate. Assuming there are 360 terminating bits in each of the eight levels of the LDPCCC-MLC tabulated in FIG. 29, that LDPCCC-MLC conveys 43,8244 bits of DTV IP packets per 64,800-bit FEC Frame. So, the digital payload of the LDPCCC-MLC tabulated in FIG. 29 is slightly less than 36.1% greater than the single-level LDPC block coding having one-half code rate.

FIG. 30 is a table of characteristics of constituent LDPC convolutional codes in nine levels of LDPCCC-MLC in a 64,800-bit FEC Frame de-mapped from 512QAM symbol constellations in a COFDM signal, the levels of LDPCCC most likely to exhibit error in an AWGN channel having a code rate of one-half. This LDPCCC-MLC is expected to have performance in the presence of AWGN substantially equal to that of single-level LDPC block coding having a code rate of one-half, but the LDPCCC-MLC has an average code rate of eleven fifteenths or 0.733. The LDPCCC-MLC tabulated in FIG. 30 has 47,520−9(192)=45,792 systematic data bits in each 64,800-bit FEC Frame, presuming there are 192 parity bits per each of the nine levels of LDPCCC. The LDPCCC-MLC tabulated in FIG. 30 has 13,584 more systematic data bits per 64,800-bit FEC Frame than the single-level LDPC block coding having one-half code rate. Assuming there are 360 terminating bits in each of the nine levels of the LDPCCC-MLC tabulated in FIG. 30, that LDPCCC-MLC conveys 42,552 bits of DTV IP packets per 64,800-bit FEC Frame. So, the digital payload of the LDPCCC-MLC tabulated in FIG. 30 is slightly more than 32.1% greater than the single-level block LDPC coding having one-half code rate.

FIG. 31 is a table of characteristics of constituent LDPC codes in three levels of LDPCCC-MLC in a 64,800-bit FEC Frame de-mapped from 64QAM symbol constellations in a COFDM signal, the third level of LDPCCC most likely to exhibit error in an AWGN channel having a code rate of two-thirds. This LDPCCC-MLC is expected to have performance in the presence of AWGN substantially equal to that of single-level LDPC block coding having a code rate of two-thirds, but the LDPCCC-MLC has an average code rate of twenty-nine thirty-sixths or 0.806. Single-level LDPC block coding having a code rate of two-thirds has 43,200 systematic data bits in each 64,800-bit FEC Frame, presuming there are 192 parity bits per BCH code block. The LDPCCC-MLC tabulated in FIG. 31 has 52,200−3(192)=51,624 systematic data bits in each 64,800-bit FEC Frame, presuming there are 192 parity bits per each of the three levels of LDPCCC. The LDPCCC-MLC tabulated in FIG. 31 has 8,424 more systematic data bits per 64,800-bit FEC Frame than the single-level LDPC block coding having a two-thirds code rate. Assuming there are 360 terminating bits in each of the three levels of the LDPCCC-MLC tabulated in FIG. 31, that LDPCCC-MLC conveys 44,064 bits of DTV IP packets per 64,800-bit FEC Frame. So, the digital payload of the LDPCCC-MLC tabulated in FIG. 31 is slightly more than 17.5% greater than the single-level LDPC block coding having a two-thirds code rate.

FIG. 32 is a table of characteristics of constituent LDPC convolutional codes in four levels of LDPCCC-MLC in a 64,800-bit FEC Frame de-mapped from 256QAM symbol constellations in a COFDM signal, the fourth level of LDPCCC most likely to exhibit error in an AWGN channel having a code rate of 151/180. This LDPCCC-MLC is expected to have performance in the presence of AWGN somewhat better than that of single-level LDPC block coding having a two-thirds code rate, but the LDPCCC-MLC has an average code rate of 151/180 or 0.839. The LDPCCC-MLC tabulated in FIG. 32 has 54,360−4(192)=54,592 systematic data bits in each 64,800-bit FEC Frame, presuming there are 192 parity bits per each of the four levels of LDPC coding. The LDPC-MLC tabulated in FIG. 32 has 10,584 more systematic data bits per 64,800-bit FEC Frame than the single-level LDPC block coding having a two-thirds code rate. Assuming there are 360 terminating bits in each of the four levels of the LDPCCC-MLC tabulated in FIG. 32, that LDPCCC-MLC conveys 53,152 bits of DTV IP packets per 64,800-bit FEC Frame. So, the digital payload of the LDPC-MLC tabulated in FIG. 32 is slightly less than 23.6% greater than the single-level LDPC block coding having a two-thirds code rate.

FIG. 33 is a table of characteristics of constituent LDPC codes in six levels of LDPCCC-MLC in a 64,800-bit FEC Frame de-mapped from 64QAM symbol constellations in a COFDM signal, the levels of LDPCCC that are most likely to exhibit error in an AWGN channel having a code rate a little over two-thirds. This LDPCCC-MLC has an average code rate of ⅘ or 0.8, but is expected to have performance in the presence of AWGN somewhat better than that of single-level LDPC block coding having a two-thirds code rate. The LDPCC-MLC tabulated in FIG. 33 has 51,840−6(192)=50,688 systematic data bits in each 64,800-bit FEC Frame, presuming there are 192 parity bits per each of the six levels of LDPCCC. The LDPCCC-MLC tabulated in FIG. 33 has 7,680 more systematic data bits per 64,800-bit FEC Frame than the single-level LDPC block coding having two-thirds code rate. Assuming there are 360 terminating bits in each of the six levels of the LDPCCC-MLC tabulated in FIG. 33, that LDPCCC-MLC conveys 48,528 bits of DTV IP packets per 64,800-bit FEC Frame. So, the digital payload of the LDPCCC-MLC tabulated in FIG. 33 is slightly more than 12.8% greater than the single-level LDPC block coding having two-thirds code rate.

FIG. 34 is a table of characteristics of constituent LDPC convolutional codes in eight levels of LDPCCC-MLC in a 64,800-bit FEC Frame de-mapped from 256QAM symbol constellations in a COFDM signal, the levels of LDPCCC most likely to exhibit error in an AWGN channel having a little less than two-thirds code rate. This LDPCCC-MLC has an average code rate of ⅚ or 0.833, but is expected to have performance in the presence of AWGN somewhat better than that of single-level LDPC block coding having two-thirds code rate. The LDPCCC-MLC tabulated in FIG. 34 has 54,000−8(192)=52,464 systematic data bits in each 64,800-bit FEC Frame, presuming there are 192 parity bits per each of the eight levels of LDPC coding. The LDPCCC-MLC tabulated in FIG. 34 has 9,456 more systematic data bits per 64,800-bit FEC Frame than the single-level LDPC block coding having two-thirds code rate. Assuming there are 360 terminating bits in each of the eight levels of the LDPCCC-MLC tabulated in FIG. 34, that LDPCCC-MLC conveys 49,584 bits of DTV IP packets per 64,800-bit FEC Frame. So, the digital payload of the LDPCCC-MLC tabulated in FIG. 34 is a little less than 15.3% greater than the single-level LDPC block coding having two-thirds code rate.

FIG. 35 is a table of characteristics of constituent LDPC convolutional codes in nine levels of LDPCCC-MLC in a 64,800-bit FEC Frame de-mapped from 512QAM symbol constellations in a COFDM signal, the four levels of LDPCCCC most likely to exhibit error in an AWGN channel having a little less than two-thirds code rate. This LDPCCC-MLC is expected to have performance in the presence of AWGN somewhat better than that of single-level LDPC block coding having two-thirds code rate, but the LDPCCC-MLC has an average code rate of four-fifths or 0.8. The LDPCCC-MLC tabulated in FIG. 35 has 51,480−9(192)=49,752 systematic data bits in each 64,800-bit FEC Frame, presuming there are 192 parity bits per each of the nine levels of LDPC coding. The LDPC-MLC tabulated in FIG. 35 has 6,744 more systematic data bits per 64,800-bit FEC Frame than the single-level LDPC block coding having two-thirds code rate. Assuming there are 360 terminating bits in each of the nine levels of the LDPCCC-MLC tabulated in FIG. 35, that LDPCCC-MLC conveys 46,332 bits of DTV IP packets per 64,800-bit FEC Frame. So, the digital payload of the LDPC-MLC tabulated in FIG. 35 is 7.73% greater than the single-level LDPC block coding having two-thirds code rate.

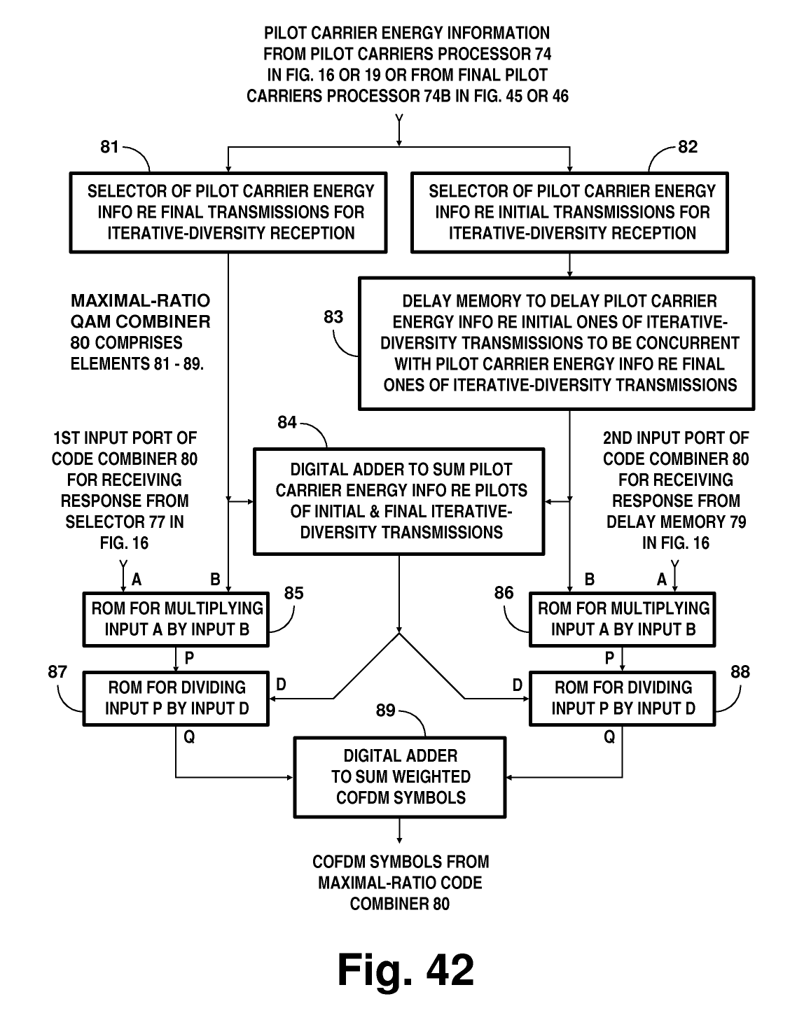

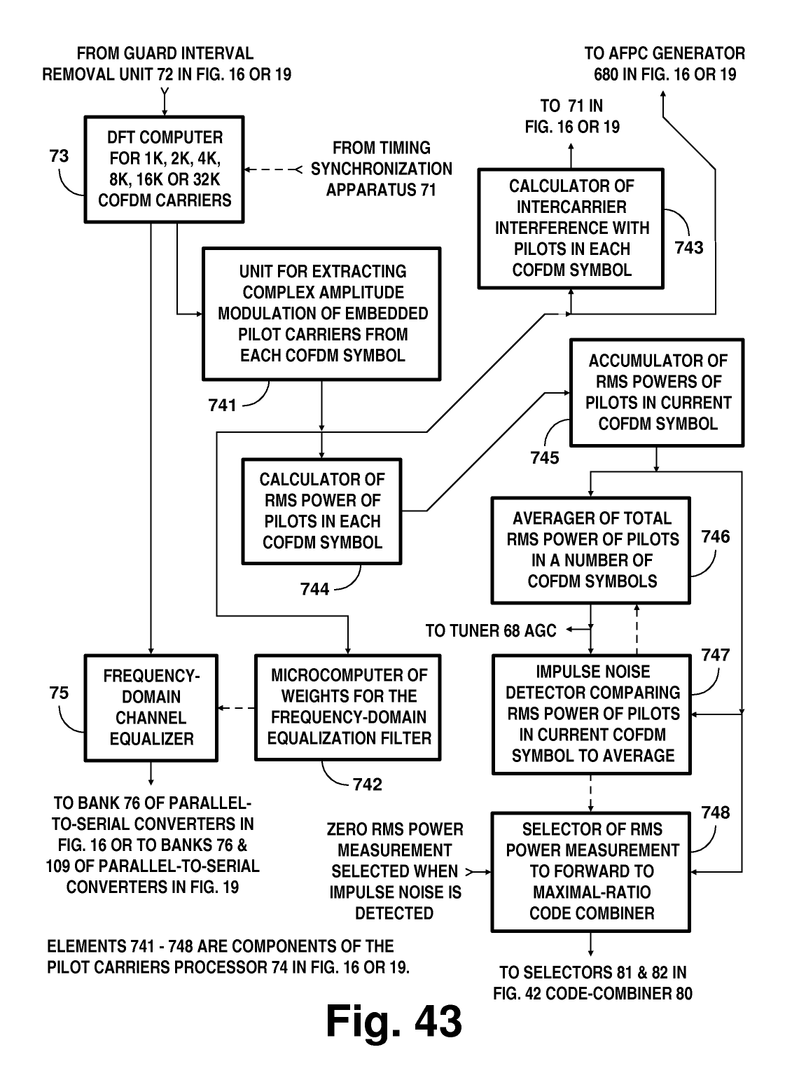

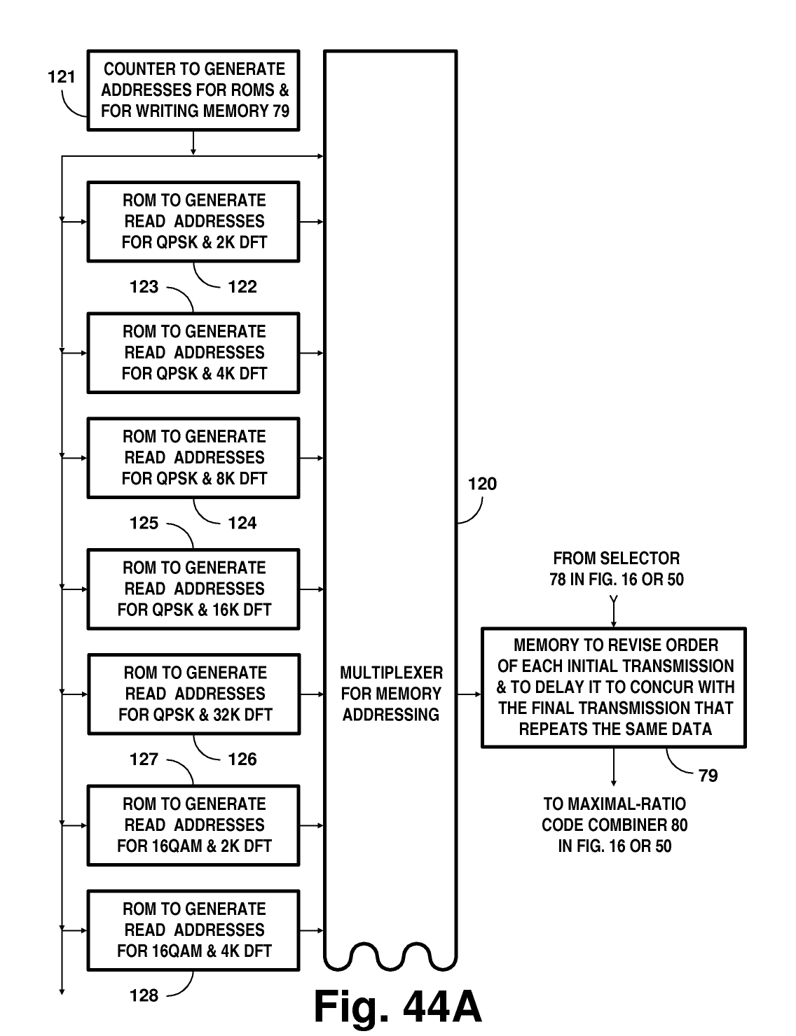

FIGS. 36, 37 and 38 are tables of characteristics of constituent LDPC convolutional codes in three levels of LDPCCC-MLC having 0.750, 0.850 and 0.900 respective average code rates in a 64,800-bit FEC Frame de-mapped from 64QAM symbol constellations in a COFDM signal. These average code rates augment the 0.711 and 0.806 average code rates of the LDPCCC-MLC tabulated in FIGS. 26 and 31. FIGS. 39, 40 and 41 are tables of characteristics of constituent LDPC convolutional codes in four levels of LDPCCC-MLC of 0.794, 0.875 and 0.917 respective average code rates in a 64,800-bit FEC Frame de-mapped from 256QAM symbol constellations in a COFDM signal. These average code rates augment the 0.756 and 0.839 average code rates of the LDPCCC-MLC tabulated in FIGS. 27 and 32. The tables in FIGS. 36-41 illustrate that, for an FEC Frame size of 64,800 bits, a range of average code rates is available from multilevel LDPCCC designed to support parallel independent decoding of each code level de-mapped from 64QAM or 256QAM symbol constellations in a COFDM signal.

The constituent LDPC convolutional codewords of LDPCCC-MLC are rather short when fitted into a 16,200-bit FEC Frame, particularly when there are more than three or four levels in the MLC. The terminating bits for each such codeword reduce coding efficiency significantly, owing to the codeword being short. The constituent LDPC convolutional codewords of LDPCCC-MLC are not constrained by coding procedure to fitting within any particular size block, so FEC Frame sizes may be selected to allow better coding efficiencies. If a variety of FEC Frame sizes are permitted in a DTV broadcast standard, transmitters should be equipped for signaling DTV receivers as to which FEC Frame size is being used in current broadcasting. DTV receivers should then be equipped for responding to such signaling to select suitable decoding procedures for the LDPCCC-MLC.

As thusfar described, the constituent LDPC convolutional codewords of LDPCCC-MLC are designed to permit parallel independent decoding of those constituent codewords using respective serial decoders. The DTV transmitter encodes each of the constituent codewords commencing from an all-zeroes preset condition and concluding that constituent codeword with respective set of terminating bits that returns to the all-zeroes preset condition. A respective register in each of the serial decoders is preset to an all-zeroes condition before commencing the decoding of a respective constituent LDPCCC codeword, and each constituent LDPCCC codeword is separately terminated to return its respective register to an all-zeroes condition at the conclusion of a cycle of decoding. These operations allow the LDPCCC-MLC to be broken up into consecutive FEC Frames similar in duration, with the all-zeroes conditions of the respective FEC Frames of the constituent LDPCCC-MLC codewords bunching together when mapped in parallel to QAM symbol constellations that modulate the OFDM carriers. This facilitates the DTV transmitter indexing the beginnings of the constituent LDPCCC-MLC codewords for the DTV receivers. An advantage of this design is that the parallel independent decoding of the constituent LDPC convolutional codewords using respective serial decoders can be performed concurrently, with the respective decoding results being time-division multiplexed together after a prescribed number of iterations of the decoding cycles of the serial decoders. That is, the serial decoders need not perform their respective decoding operations one at a time, which would increase latency in the decoding procedure. The shortcoming of this design is that each of the constituent LDPC convolutional codewords has to include its own set of terminating bits, which reduces coding efficiency.

Alternatively, the constituent LDPC convolutional codewords of LDPCCC-MLC are designed to be consecutively decoded using a single serial decoder. Only the one of the constituent LDPC convolutional codewords to be decoded initially begins from an all-zeroes preset condition, and only the one of the constituent LDPC convolutional codewords to be decoded last concludes with terminating bits to return to an all-zeroes condition at the conclusion of a cycle of decoding. The constituent LDPC convolutional codewords other than the one to be initially decoded begin from the condition at the conclusion of the previous constituent LDPC convolutional codewords to be decoded. The serial decoder decodes the constituent LDPC convolutional codewords one after the other, which results in increased latency in the decoding procedure.

If the constituent LDPC convolutional codewords of LDPCCC-MLC are designed to be consecutively decoded using a single serial decoder, the LDPCCC-MLC tabulated in FIG. 26 will have a little more than 39.0% greater digital payload than the single-level LDPC block coding having one-half code rate. The LDPCCC-MLC tabulated in FIG. 27 will have a little more than 48.5.0% greater digital payload than the single-level LDPC block coding having one-half code rate. The LDPCCC-MLC tabulated in FIG. 28 will have a little more than 36.1% greater digital payload than the single-level LDPC block coding having one-half code rate. The LDPCCC-MLC tabulated in FIG. 29 will have a little less than 43.9% greater digital payload than the single-level LDPC block coding having one-half code rate. The LDPCCC-MLC tabulated in FIG. 30 will have a little less than 41.1% greater digital payload than the single-level LDPC block coding having one-half code rate. These increases in payload presume there are 360 terminating bits in each LDPCCC-MLC.

If the constituent LDPC convolutional codewords of LDPCCC-MLC are designed to be consecutively decoded using a single serial decoder, the LDPCCC-MLC tabulated in FIG. 31 will have a little less than 19.2% greater digital payload than the single-level LDPC block coding having two-thirds code rate. The LDPCCC-MLC tabulated in FIG. 32 will have a little less than 26.1.0% greater digital payload than the single-level LDPC block coding having two-thirds code rate. The LDPCCC-MLC tabulated in FIG. 33 will have a little more than 17.0% greater digital payload than the single-level LDPC block coding having two-thirds code rate. The LDPCCC-MLC tabulated in FIG. 34 will have a little more than 21.1% greater digital payload than the single-level LDPC block coding having two-thirds code rate. The LDPCCC-MLC tabulated in FIG. 35 will have a little more than 14.8% greater digital payload than the single-level LDPC block coding having two-thirds code rate. These increases in payload presume there are 360 terminating bits in each LDPCCC-MLC.

FIG. 42 shows in detail the basic structure of the maximal-ratio code combiner 80 depicted in FIG. 16 and in FIG. 19. The code combiner 80 is connected for receiving pilot-carrier-energy information from the pilot carriers processor 74 shown in FIG. 16 and in FIG. 19. The pilot carriers processor 74 squares the real and imaginary terms of each unmodulated pilot carrier, sums the resulting squares and square-roots the sum to determine the root-mean-square (RMS) energy of that unmodulated pilot carrier. This procedure can be carried out for each pilot carrier using read-only memory addressed by the real and imaginary terms of each successively considered unmodulated pilot carrier. The RMS energies of the pilot carriers are then summed by an accumulator, which determines the total RMS energy of the pilot carriers for each OFDM symbol epoch.

The value of the total RMS energy supplied from the pilot carriers processor 74 is applied to the respective input ports of selectors 81 and 82 in the maximal-ratio code combiner 80 as shown in FIG. 42. The selector 81 selectively reproduces at its output port the total energy of the pilot carriers during those transmissions that are not repeated and the final ones of those transmissions repeated for iterative-diversity reception. The selector 82 selectively reproduces at its output port the total energy of the pilot carriers during the initial ones of those transmissions repeated for iterative-diversity reception. These operations of the selectors 81 and 82 are controlled responsive to indications conveyed in the L1 signaling. These operations support the complex coordinates of QPSK or QAM symbols from transmissions that are not repeated, which coordinates are supplied to a first of the two input ports of the code combiner 80, being reproduced without modification from its output port.

A delay memory 83 is connected for delaying the selector 82 response to supply a delayed selector 82 response that is concurrent with the selector 81 response. The delay memory 83 is preferably a random-access memory (RAM) with write addressing and read addressing configuring the RAM to provide delay. The length of delay afforded by the delay memory 83 is essentially the same as the length of delay afforded by the memory 110 depicted in FIG. 19 or the length of delay that would be afforded by the memory 79 depicted in FIG. 16 were it not relied upon to de-rotate DFT components.

A digital adder 84 is connected for adding the selector 81 response and the delayed selector 82 response read from the delay memory 83. The sum output response from the adder 84 combines the total energies of the initial and final transmissions for iterative-diversity reception, to be used for normalizing the weighting of the selector 80 response and the weighting of the delayed selector 82 response read from the RAM 83. A read-only memory 85 is connected for multiplying soft complex QAM coordinates in the response from the selector 80 by the total energy of a final transmission for iterative-diversity reception. (FIG. 42 indicates final transmissions for iterative-diversity reception are received from the selector 77 in FIG. 16, but alternatively they may be received from the selector 77 in FIG. 19.) A read-only memory 86 is connected for multiplying the soft complex QAM coordinates read from the RAM 83 by the total energy of the corresponding initial transmission for iterative-diversity reception.

The soft complex product from the ROM 85 is a weighted response to soft complex QAM coordinates in transmissions that are not repeated and in the final ones of those transmissions repeated for iterative-diversity reception. A read-only memory 87 is connected for normalizing this weighted response with respect to the total energies of the initial and final transmissions for iterative-diversity reception, by dividing the complex product from the ROM 85 by the sum output response from the adder 84.

The soft complex product from the ROM 86 is a weighted response to soft complex QAM coordinates in the initial ones of those transmissions subsequently repeated for iterative-diversity reception. (FIG. 42 indicates initial transmissions for iterative-diversity reception are received from the memory 79 in FIG. 16, but alternatively they may be received from the memory 110 in FIG. 19.) A read-only memory 88 is connected for normalizing this weighted response with respect to the total energies of the initial and final transmissions for iterative-diversity reception, by dividing the complex product from the ROM 86 by the sum output response from the adder 84.

A digital complex adder 89 is connected for summing the respective complex quotients from the ROMs 87 and 88 to synthesize soft-decision COFDM symbols that are the maximal-ratio code combiner 80 response supplied to the input ports of the de-mappers 91, 94 and 99. One skilled in digital design is apt to perceive that, alternatively, normalization of the coefficients for weighting of the selector 81 response and for weighting of the inverted-in-polarity and delayed selector 82 response read from the delay memory 84 can be performed before such weighting, rather than after. A single read-only memory can be designed to perform the combined functions of the ROMs 85 and 87; and a single read-only memory can be designed to perform the combined functions of the ROMs 86 and 88. Alternatively, the ROMs 85, 86, 87 and 88 could be combined with the complex adder 89 in a very large ROM. The computations can be performed by digital circuitry other than ROMs, but problems with proper timing are considerably more difficult.

The operation of the maximal-ratio code combiner 80 following a change in RF channel or sub-channel is of interest. Following such a change, a DTV receiver as described supra will not have foregoing initial transmissions for iterative-diversity reception temporarily stored in its RAM 86. Therefore, the DTV receiver bulk-erases the contents of storage locations in the RAM 83. The pilot carriers processor 74 will not have supplied the maximal-ratio code combiner 80 with information concerning the RMS-energy of pilot carriers accompanying the foregoing initial transmissions for iterative-diversity reception. Accordingly, the DTV receiver erases the contents of the delay memory 83 within the code combiner 80 that stores such information. This erasure conditions the maximal-ratio code combiner 80 for single-transmission reception until the delay memory 83 therein refills with information concerning the RMS-energy of pilot carriers accompanying the foregoing initial transmissions for iterative-diversity reception. During this delay in the code combiner 80 beginning iterative-diversity reception, the storage locations in the RAM 86 fill with complex coordinates of modulation symbol constellations in initial transmissions for iterative-diversity reception. These complex coordinates are supplied with delay to the second input port of the code combiner 80 when iterative-diversity reception begins.

FIG. 43 depicts more specifically elements 741-748 in a representative embodiment of the pilot carriers processor 74 as shown in each of FIGS. 16 and 19. The first output port of the DFT computer 73 connects to the input port of a unit 741 for extracting complex amplitude-modulation components of pilot carriers embedded in each successive COFDM symbol according to one of a number of prescribed patterns. The unit 741 comprises a plurality of parallel-to-serial converters for converting to serial format the complex amplitude-modulation components of pilot carriers available in parallel from the DFT computer 73 according to respective ones of those prescribed patterns. This implements a procedure referred to as “embedded signal recovery” in some of the technical literature concerning DVB-T and DVB-T2 practices. The complex components of the amplitude modulation of pilot carriers are supplied in serial format from a selected one of the parallel-to-serial converters in the unit 741 to the AFPC generator 680 as shown in FIGS. 16 and 19. The AFPC generator 680 multiplies the imaginary coordinates of the pilot carriers by their real coordinates and averages the resulting products to provide a basis for developing automatic frequency and phase control (AFPC) of the final local oscillator in the front-end tuner 68 shown in FIGS. 16 and 19. Also, the complex components of the amplitude modulation of pilot carriers are supplied in serial format from that selected one of the parallel-to-serial converters in the unit 741 to a microcomputer 742 of weighting coefficients for the frequency-domain channel equalizer 75. Furthermore, the complex components of the amplitude modulation of pilot carriers are supplied in serial format from that selected one of the parallel-to-serial converters in the unit 741 to a calculator 743 of intercarrier interference with pilot carriers caused by proximate data-modulated OFDM carriers. The calculator 743 accumulates intercarrier interference measurements for all the pilot carriers in each COFDM symbol and transmits the total from an output port thereof to the timing synchronization apparatus 71, there to implement fine adjustment of the DFT window positioning in time in a feedback loop that attempts to minimize the total intercarrier interference from data-modulated OFDM carriers.

ETSI standard EN 302 755 V1.3.1 prescribes eight different patterns of scattered pilots. The number and location of continual pilots depends both on the FFT size and on the scattered pilot pattern in use. The continual pilot locations are taken from one or more of six “CP groups” depending on the FFT mode. So the unit 741 for extracting complex amplitude-modulation components of pilot carriers embedded in each successive COFDM symbol according to each combination of patterns of pilot carriers prescribed by EN 302 755 V1.3.1 contains a considerable number of parallel-to-serial converters for processing single-time transmissions or the final transmissions for iterative-diversity reception. The patterns of scattered pilots prescribed by EN 302 755 V1.3.1 are modified by the rotation of circular DFT by one-half revolution in the initial transmissions for iterative-diversity reception, so another considerable number of parallel-to-serial converters must be included in the unit 741 for processing the pilots in the initial transmissions. It should be possible to design patterns of pilot carriers for an improved broadcast standard that are the same whether or not the circular DFT is rotated half a revolution.

A function of the pilot carriers processor 74 that is of principal concern is the generation of measurements of the total RMS power of pilot carriers that the maximal-ratio code combiner 80 depicted in FIG. 42 utilizes to control combining the results of demodulating initial and final transmissions of COFDM signals during iterative-diversity reception. Man-made noise (MMN) generated close to the DTV reception site tends to cause interference within a radio-frequency channel selected for reception, which interference is apt to be many times larger than the DTV signal sought after. If only one of the similar initial and final transmissions of the coded DTV signal transmitted for iterative-diversity reception is corrupted by the MMN, it is desirable to keep the corrupted transmission from generating measurements of the total RMS power of pilot carriers that will condition the maximal-ratio code-combiner 80 to respond primarily to that corrupted transmission rather than responding primarily to the other of the initial and late transmissions that is not corrupted by MMN. This avoids the stronger MMN capturing the results of the combining procedures owing to its greater signal strength. It is preferable that reception of the coded DTV signal relies exclusively on the transmission uncorrupted by strong MMN.

Complex amplitude-modulation components of pilot carriers embedded in each successive COFDM symbol are supplied in serial format to a calculator 744 from parallel-to-serial converters in the unit 741 for extracting those components. The calculator 744 calculates the RMS power of the pilot carriers in each COFDM symbol. In effect the calculator 744 squares the real and imaginary components of each pilot carrier, sums the squares and then square roots the sum to calculate the root-mean-square (RMS) power of that particular pilot carrier. The calculator 744 can be replaced by read-only memory addressed by the real and imaginary amplitude-modulation components of each pilot carrier for supplying the RMS power of that particular pilot carrier in shorter time than required for real-time calculation. Since the DFT-window-adjustment feedback loop including the timing synchronization apparatus 71 seeks to minimize the imaginary amplitude-modulation components of each pilot carrier, being aided by the AFPC feedback loop including the AFPC generator 680, the real amplitude-modulation components of pilot carriers can be considered by themselves to provide sufficient description of the RMS powers of the pilot carriers. In any case, indications of the RMS powers of the pilot carriers are supplied to the input port of an accumulator 745 that generates a summation of the RMS powers of pilot carriers in each successive COFDM symbol being currently considered, which summation is supplied from an output port of the accumulator 745 to the respective input ports of elements 746-748 of the pilot carriers processor 74 as depicted in FIG. 43.

The total RMS power of pilot carriers in each successive COFDM symbol, as supplied from an output port of the accumulator 745, is supplied to a first of two input ports of a selector 746 of the RMS power measurement to be supplied from an output port of that selector 746. FIG. 43 shows the second input port of the selector 746 connected to receive a zero RMS power measurement, which the selector 746 is to select when impulse noise is detected that would cause the calculation of the total RMS power of pilot carriers in the current COFDM symbol to be erroneous. FIG. 43 indicates that the output port of the selector 746 connects to the input ports of the selectors 81 and 82 of the maximal-ratio code combiner 80 depicted in FIG. 42. The selection of which of the RMS power measurements supplied to the two input ports of the selector 746 is reproduced at its output port is controlled by indications supplied to the selector 746 from the output port of an impulse noise detector 747.

The energy in MMN or impulse noise is wide-spectrum in nature insofar as the 6-MHz-wide to 8-MHz-wide radio-frequency (RF) channel is concerned, containing all frequencies within the channel. The respective phasings of those frequency components are random in nature. Large-energy noise components close in frequency to pilot carriers combine with the pilot carriers to cause the imaginary coordinates ascribed to those pilot carriers by the DFT computer 73 to be greatly increased from their usual low values. Ideally, these imaginary coordinates would be zero-valued, since the binary phase-shift-keying (BPSK) of the pilot carriers is real-only. In actual practice, Johnson noise will cause these imaginary coordinates to have some values that are low compared to the real coordinates ascribed to those pilot carriers by the DFT computer 73. The impulse noise detector 747 generates an indication of MMN or impulse noise only when the summed absolute values of the imaginary coordinates ascribed to each of the pilot carriers in the currently considered COFDM symbol exceeds a threshold value. This threshold value is greater than the summed absolute values of the imaginary coordinates ascribed to each of the pilot carriers in a COFDM symbol when receiving additive white Gaussian noise (AWGN) at the largest levels at which data-slicing of the complex coordinates of the pilot carriers is still valid.

When the impulse noise detector 747 generates an indication that MMN or impulse noise corrupts the current COFDM symbol, this indication conditions the selector 746 to reproduce at its output port the zero RMS power measurement that FIG. 43 shows applied to its second input port. Absent the impulse noise detector 747 generating such indication, the selector 746 is conditioned to reproduce at its output port the RMS power measurement supplied to its first input port from the output port of the accumulator 745. When the selector 746 reproduces the zero RMS power measurement for application to the input ports of the selectors 81 and 82 of the maximal-ratio code combiner 80 depicted in FIG. 42, the complex coordinates of QAM constellations from the current COFDM symbol will be disregarded in the code combining performed by the code combiner 80. Accordingly, the complex coordinates of QAM constellations supplied from the code combiner 80 will not be affected by MMN or impulse noise.

The total RMS power of pilot carriers in each successive COFDM symbol, as supplied from an output port of the accumulator 745, is supplied to the input port of an averager 748 that averages the total RMS power of pilot carriers for a number of COFDM symbols. FIG. 43 indicates that the output port of the averager 748 supplies this averaged total RMS power of pilot carriers to the front-end tuner 68 for use in automatic gain control (AGC) of amplifiers therein. FIG. 43 shows a connection from the impulse noise detector 747 to the averager 748, which connection is used for supplying the averager 748 with indications of the occurrence of MMN or impulse noise. Such indications are used by the averager 748 to exclude the total RMS power of pilot carriers in the current COFDM symbol from being included in its running average of the total RMS power of pilot carriers in number of COFDM symbols. Although not shown in FIG. 43, the impulse noise detector 747 preferably has connections to the AFPC generator 680 and to the calculator 743 for providing them with indications of the occurrence of MMN or impulse noise. These indications allow the AFPC generator 680 and the calculator 743 to modify their respective operations so as to avoid at least in substantial degree adverse effects of MMN or impulse noise on those operations.

Impulse noise accompanying COFDM signals can be detected in the frequency domain by other methods. Hosein Asjadi discloses one such alternative method in U.S. Pat. No. 7,418,026 issued 26 Aug. 2008 and titled “Receiver for a multi-carrier modulated symbol”. Hosein Asjadi discloses another alternative method in U. S. Pat. App. US-2010-0246726-A1 published 30 Sep. 2010 and titled “Receiver and method of receiving”. Alternatively, impulse noise accompanying COFDM signals can be detected in the time domain rather than in the frequency domain. U.S. Pat. App. Ser. No. 61/760,285 filed for A. L. R. Limberg on 4 Feb. 2013 and titled “COFDM broadcasting of DTV signals twice in different ordering of frequency spectra” is incorporated herein by reference. That patent application describes detecting impulse noise starting with peak detection of intermediate-frequency COFDM signals in the front-end tuner of the DTV receiver.

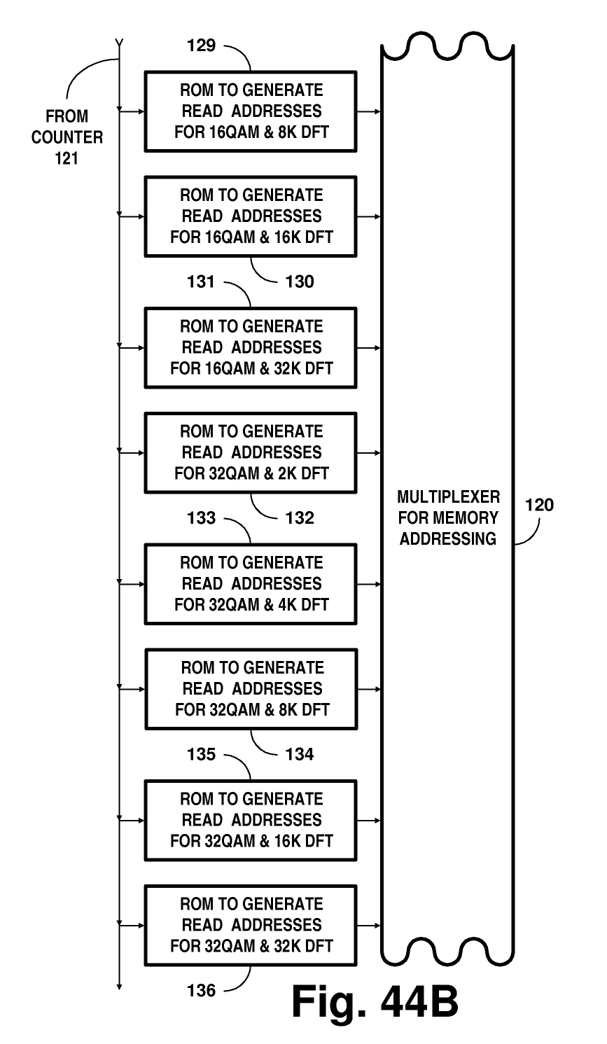

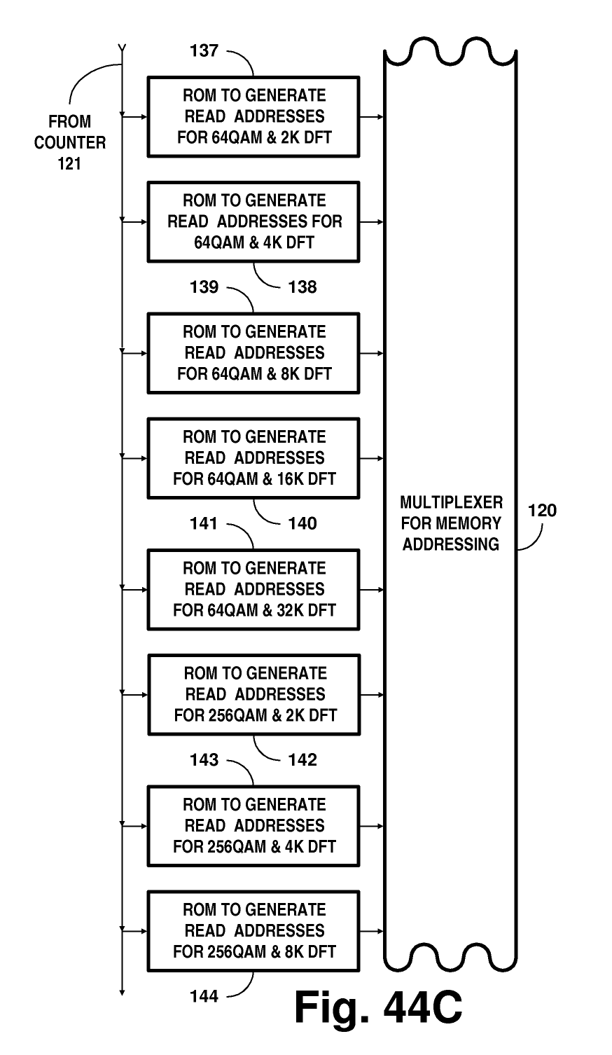

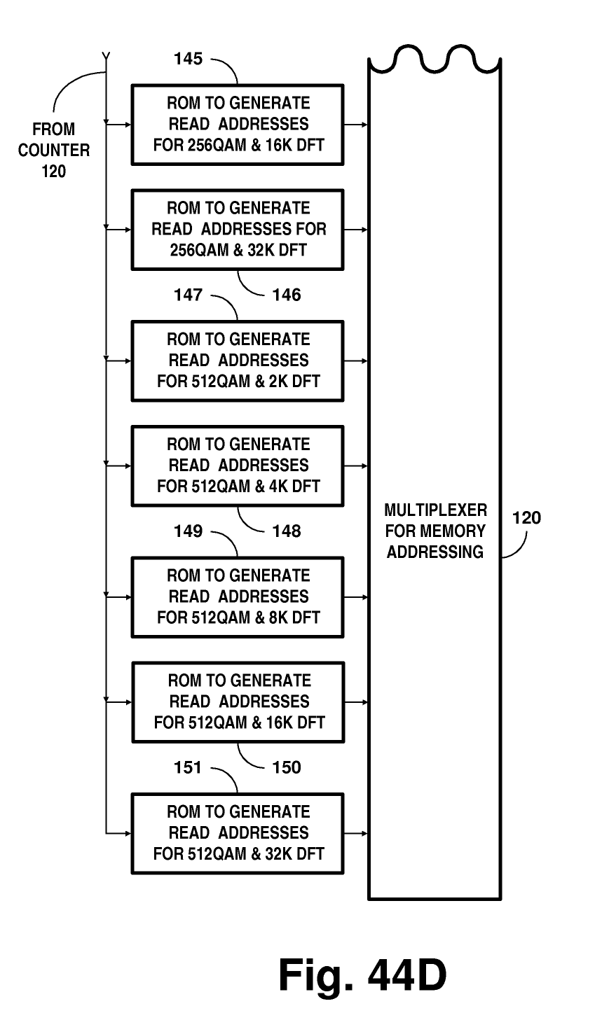

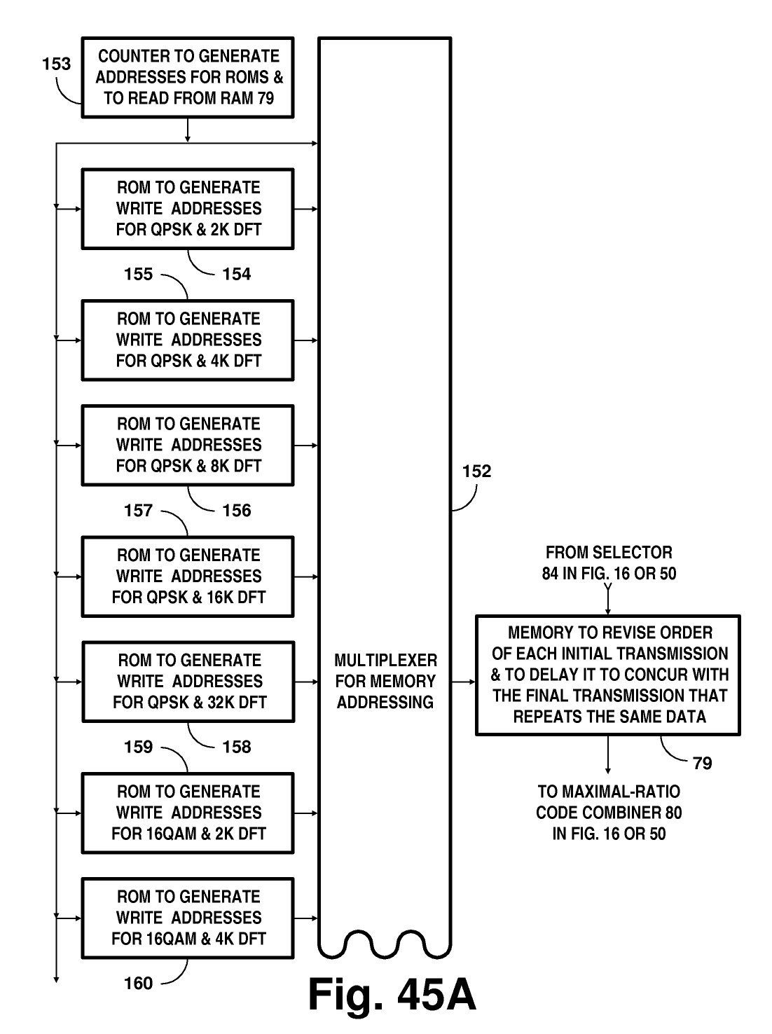

FIGS. 44A, 44B, 44C and 44D together form FIG. 44, which depicts in some detail an arrangement for addressing the memory 79 also depicted in the FIG. 16 portion of the COFDM receiver apparatus. The output port of a multiplexer 120 is connected for applying selected addressing to the memory 79. A counter 121 counts the bit epochs of successive complex coordinates of modulation symbols, supplying that bit count to a first input port of the multiplexer 120 to be selectively reproduced at the output port of the multiplexer 72 as write addressing for the RAM 79. The counter 121 is capable of counting all the bits in the successive COFDM symbols of any time-slice and is reset to zero count at the beginning of each time-slice. The number of bits in the successive COFDM symbols of a time-slice will be different for different time-slices, depending on the size of the DFT and the type of modulation symbol constellation used in the time-slice.

The bit count from the counter 121 is further applied as input addressing to each one of a plurality of read-only memories 122-151, each of which large ROMs generates possible read addressing for the RAM 79 at its output port. The output ports of the ROMs 122-151 connect to respective ones of second through thirty-first input ports of the multiplexer 120 to be selectively reproduced at the output port of the multiplexer 120 as read addressing for the RAM 79.

The ROMs 122-126 generate read addressing for the RAM 78 when 2K, 4K, 8K, 16K and 32K OFDM carriers respectively generate DFTs and the COFDM symbols are based on QPSK modulation symbol constellations. Separate ROMs 122-125 are dispensed with in a modification of the arrangement for addressing the memory 78 depicted in FIG. 44, the functions of the ROMs 122-125 being provided by curtailed input addressing of the ROM 126.

The ROMs 127-131 generate read addressing for the RAM 78 when 2K, 4K, 8K, 16K and 32K OFDM carriers respectively generate DFTs and the COFDM symbols are based on 16QAM modulation symbol constellations. Separate ROMs 127-130 are dispensed with in a modification of the arrangement for addressing the memory 79 depicted in FIG. 44, the functions of the ROMs 127-130 being provided by curtailed input addressing of the ROM 131.

The ROMs 132-136 generate read addressing for the RAM 79 when 2K, 4K, 8K, 16K and 32K OFDM carriers respectively generate DFTs and the COFDM symbols are based on 32QAM modulation symbol constellations. Separate ROMs 132-135 are dispensed with in a modification of the arrangement for addressing the memory 79 depicted in FIG. 44, the functions of the ROMs 132-135 being provided by curtailed input addressing of the ROM 136.

The ROMs 137-141 generate read addressing for the RAM 79 when 2K, 4K, 8K, 16K and 32K OFDM carriers respectively generate DFTs and the COFDM symbols are based on 64QAM modulation symbol constellations. Separate ROMs 137-140 are dispensed with in a modification of the arrangement for addressing the memory 79 depicted in FIG. 44, the functions of the ROMs 137-140 being provided by curtailed input addressing of the ROM 141.

The ROMs 142-146 generate read addressing for the RAM 79 when 2K, 4K, 8K, 16K and 32K OFDM carriers respectively generate DFTs and the COFDM symbols are based on 256QAM modulation symbol constellations. Separate ROMs 142-145 are dispensed with in a modification of the arrangement for addressing the memory 79 depicted in FIG. 44, the functions of the ROMs 142-145 being provided by curtailed input addressing of the ROM 146.

The ROMs 147-151 generate read addressing for the RAM 79 when 2K, 4K, 8K, 16K and 32K OFDM carriers respectively generate DFTs and the COFDM symbols are based on 512QAM modulation symbol constellations. Separate ROMs 147-150 are dispensed with in a modification of the arrangement for addressing the memory 79 depicted in FIG. 44, the functions of the ROMs 147-150 being provided by curtailed input addressing of the ROM 151.

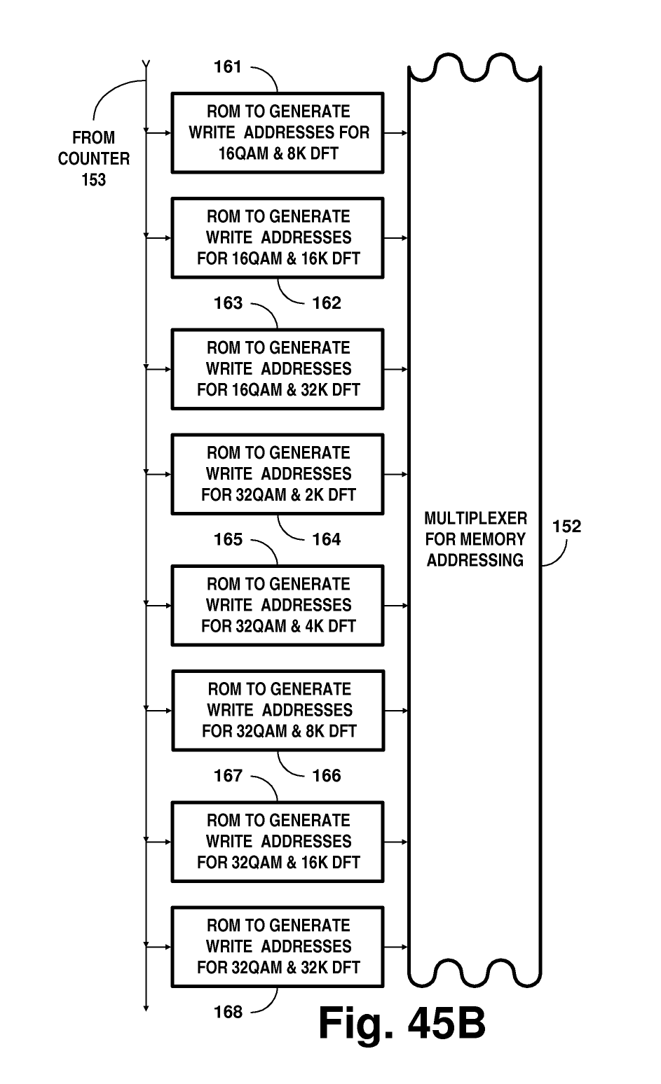

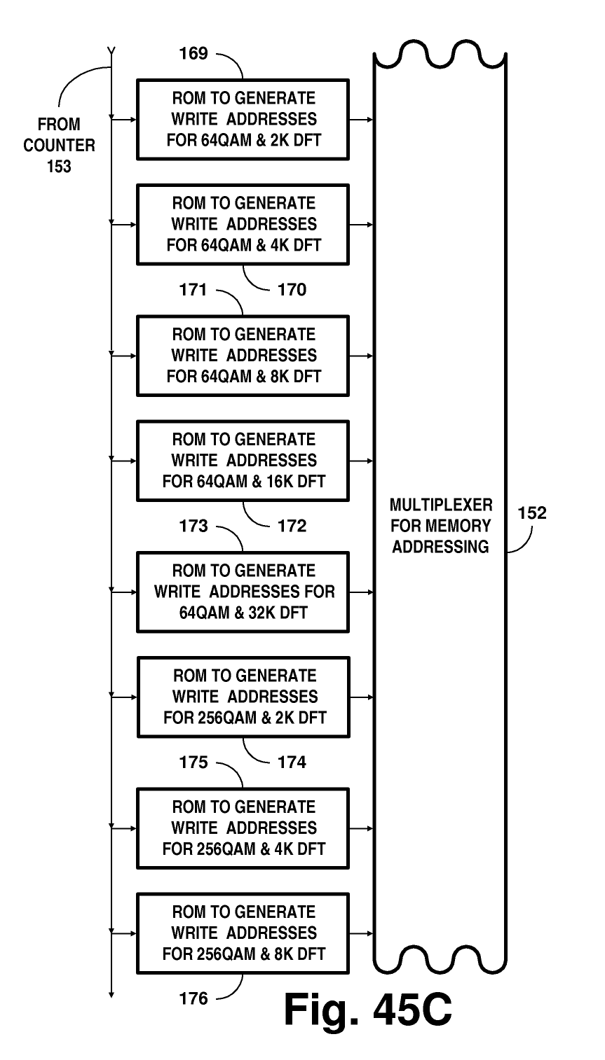

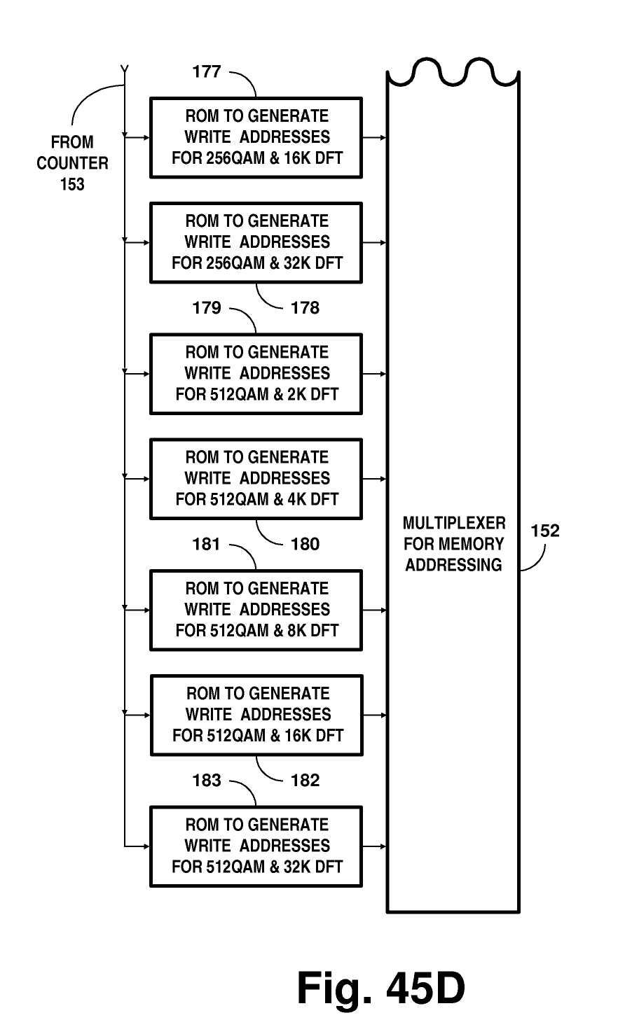

FIGS. 45A, 45B, 45C and 45D together form FIG. 45, which depicts in some detail an alternative arrangement for addressing the memory 79 depicted in the FIG. 16 portion of the COFDM receiver apparatus. The output port of a multiplexer 152 is connected for applying selected addressing to the memory 79. A counter 153 counts the bit epochs of successive complex coordinates of modulation symbols, supplying that bit count to a first input port of the multiplexer 152 to be selectively reproduced at the output port of the multiplexer 120 as read addressing for the RAM 79. The counter 153 is capable of counting all the bits in the successive COFDM symbols of any time-slice and is reset to zero count at the beginning of each time-slice. The number of bits in the successive COFDM symbols of a time-slice will be different for different time-slices, depending on the size of the DFT and the type of modulation symbol constellation used in the time-slice.

The bit count from the counter 153 is further applied as input addressing to each one of a plurality of read-only memories 154-183, each of which large ROMs generates possible write addressing for the RAM 79 at its output port. The output ports of the ROMs 154-183 connect to respective ones of second through thirty-first input ports of the multiplexer 152 to be selectively reproduced at the output port of the multiplexer 152 as write addressing for the RAM 79.

The ROMs 154-158 generate write addressing for the RAM 78 when 2K, 4K, 8K, 16K and 32K OFDM carriers respectively generate DFTs and the COFDM symbols are based on QPSK modulation symbol constellations. Separate ROMs 154-157 are dispensed with in a modification of the arrangement for addressing the memory 79 depicted in FIG. 45, the functions of the ROMs 154-157 being provided by curtailed input addressing of the ROM 158.

The ROMs 159-163 generate write addressing for the RAM 79 when 2K, 4K, 8K, 16K and 32K OFDM carriers respectively generate DFTs and the COFDM symbols are based on 16QAM modulation symbol constellations. Separate ROMs 159-162 are dispensed with in a modification of the arrangement for addressing the memory 79 depicted in FIG. 45, the functions of the ROMs 159-162 being provided by curtailed input addressing of the ROM 163.

The ROMs 164-168 generate write addressing for the RAM 79 when 2K, 4K, 8K, 16K and 32K OFDM carriers respectively generate DFTs and the COFDM symbols are based on 32QAM modulation symbol constellations. Separate ROMs 164-167 are dispensed with in a modification of the arrangement for addressing the memory 79 depicted in FIG. 45, the functions of the ROMs 164-167 being provided by curtailed input addressing of the ROM 168.

The ROMs 169-173 generate write addressing for the RAM 79 when 2K, 4K, 8K, 16K and 32K OFDM carriers respectively generate DFTs and the COFDM symbols are based on 64QAM modulation symbol constellations. Separate ROMs 169-172 are dispensed with in a modification of the arrangement for addressing the memory 79 depicted in FIG. 45, the functions of the ROMs 169-172 being provided by curtailed input addressing of the ROM 173.

The ROMs 174-178 generate write addressing for the RAM 79 when 2K, 4K, 8K, 16K and 32K OFDM carriers respectively generate DFTs and the COFDM symbols are based on 256QAM modulation symbol constellations. Separate ROMs 174-177 are dispensed with in a modification of the arrangement for addressing the memory 79 depicted in FIG. 45, the functions of the ROMs 174-177 being provided by curtailed input addressing of the ROM 178.

The ROMs 179-183 generate write addressing for the RAM 79 when 2K, 4K, 8K, 16K and 32K OFDM carriers respectively generate DFTs and the COFDM symbols are based on 512QAM modulation symbol constellations. Separate ROMs 179-182 are dispensed with in a modification of the arrangement for addressing the memory 79 depicted in FIG. 45, the functions of the ROMs 179-182 being provided by curtailed input addressing of the ROM 183.

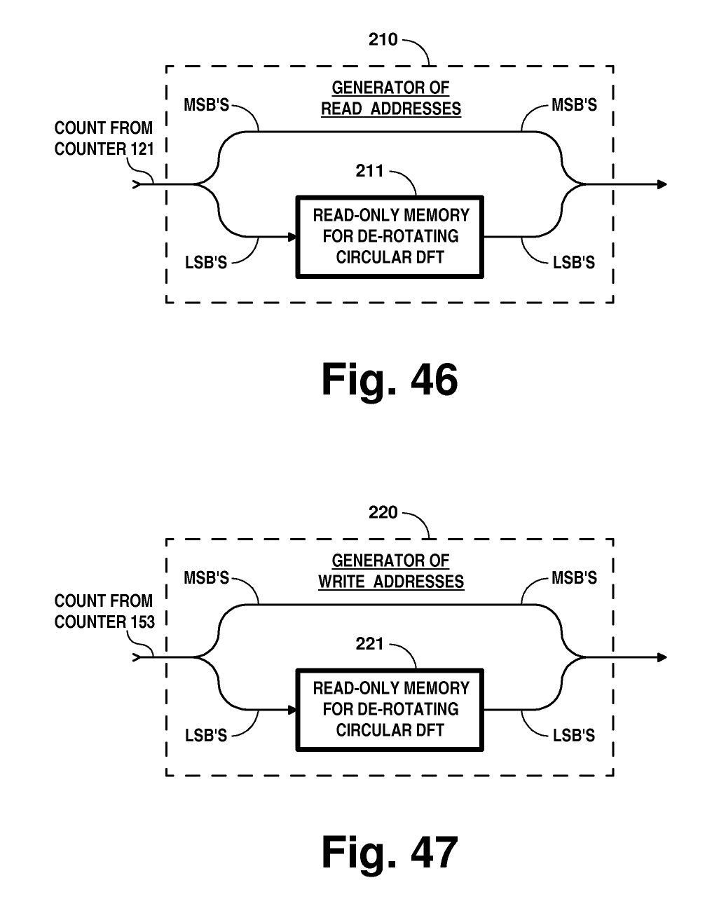

FIG. 46 is a schematic diagram of a structure 210 for each one of respective replacements for read-only memories 122-151 used as read address generators within the portions of COFDM receiver apparatus depicted in FIGS. 44A, 44B, 44C and 44D. The less significant bits of the count from the counter 121 that describe RAM 79 addressing for each successive COFDM symbol with rotated circular DFT are applied as input addressing to a read-only memory 211 within this structure 210. The ROM 211 responds to its input addressing to generate revised less significant bits descriptive of each successive COFDM symbol with one-half revolution de-rotation of its circular DFT. The more significant bits of the count from the counter 121 that specify the position of each successive COFDM symbol in their serial ordering by-pass the ROM 211 to be joined with the revised less significant bits from the output port of the ROM 211 to generate read addresses for the RAM 79 that condition the RAM 79 for reading from its output port successive COFDM symbols with non-rotated circular DFTs. The ROM 211 in any structure 210 is many times smaller than the one of the ROMs 122-151 replaced by that structure 210. A preferred arrangement for addressing the RAM 79 is a modification of the FIG. 44 arrangement that dispenses with the ROMs 122-125, the ROMs 127-130, the ROMs 132-135, the ROMs 137-140, the ROMs 142-145 and the ROMs 147-150 and that replaces the ROMs 126, 131, 136, 141, 146 and 151 with respective read-address generators each having structure 210 as depicted in FIG. 46.

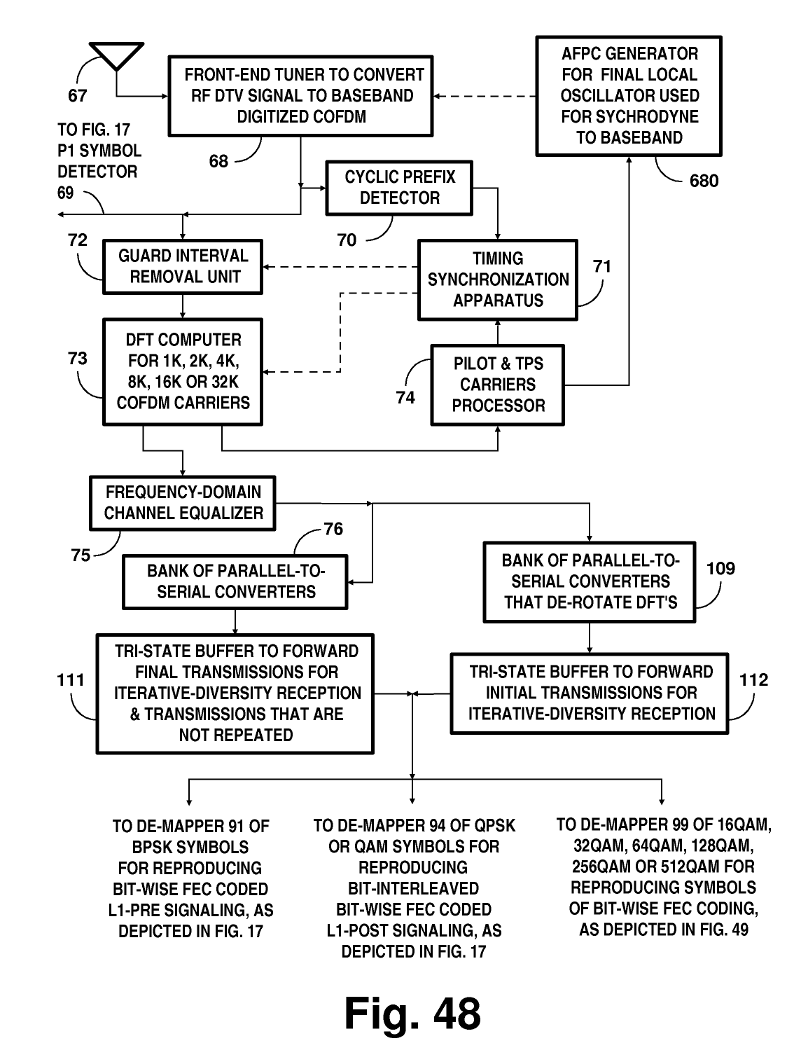

FIG. 47 is a schematic diagram of a structure 220 for each one of respective replacements for read-only memories 154-183 used as write address generators within the portions of COFDM receiver apparatus depicted in FIGS. 45A, 45B, 45C and 45D. The less significant bits of the count from the counter 153 that describe RAM 79 addressing for each successive COFDM symbol with non-rotated circular DFT are applied as input addressing to a read-only memory 221 within this structure 220. The ROM 221 responds to its input addressing to generate revised less significant bits descriptive of each successive COFDM symbol with one-half revolution de-rotation of its circular DFT. The more significant bits of the count from the counter 153 that specify the position of each successive COFDM symbol in their serial ordering by-pass the ROM 221 to be joined with the revised less significant bits from the output port of the ROM 221 to generate write addresses for the RAM 79 that condition the RAM 79 for temporarily storing successive COFDM symbols written thereto with no rotation of their circular DFTs. Subsequent reading from the ROM 79 using the count from the counter 153 as read addressing will supply stream of COFDM symbols without rotation of their circular DFTs, suitable for code-combining with a stream of COFDM symbols supplied from the output port of the selector 76. The ROM 221 in any structure 220 is many times smaller than the one of the ROMs 154-183 replaced by that structure 220. A preferred arrangement for addressing the RAM 79 is a modification of the FIG. 45 arrangement that dispenses with the ROMs 154-157, the ROMs 159-162, the ROMs 164-167, the ROMs 169-172, the ROMs 174-177 and the ROMs 179-183 and that replaces the ROMs 158, 163, 168, 173, 178 and 183 with respective read-address generators each having structure 220 as depicted in FIG. 47.

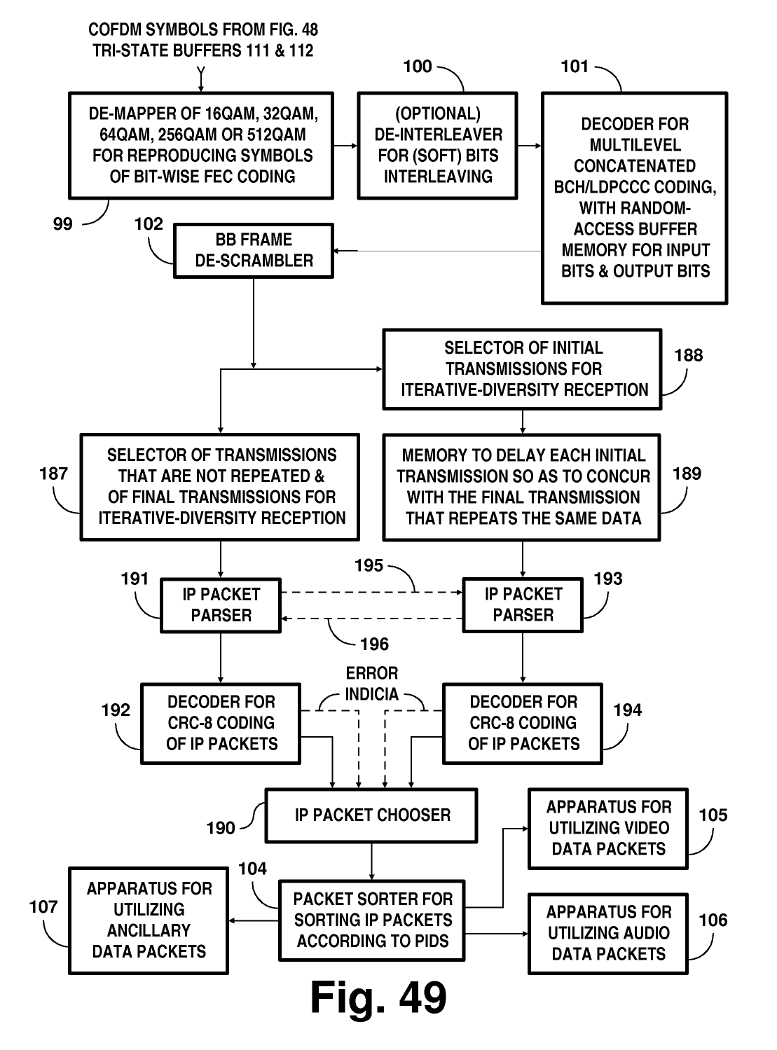

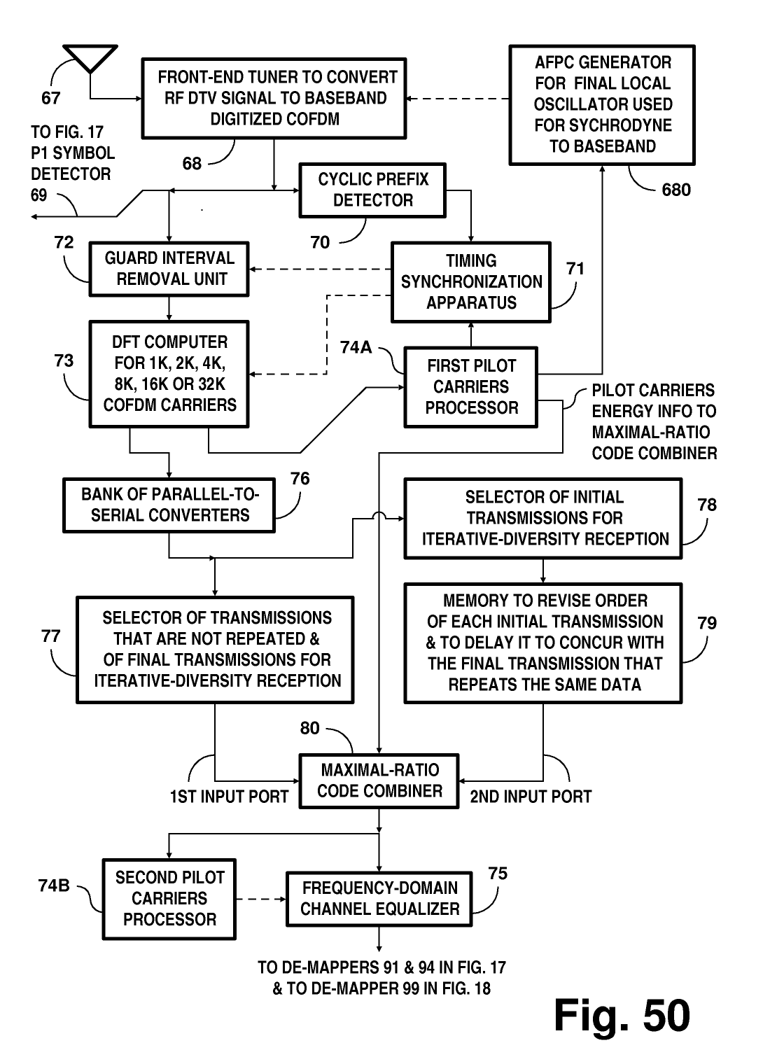

FIGS. 48, 17 and 49 combine to form a schematic diagram of COFDM receiver apparatus configured for iterative-diversity reception of COFDM signals, the FIG. 49 portion of which receiver apparatus is configured for choosing correct IP packets from initial transmissions of COFDM signals and from final transmissions of COFDM signals. Elements 67-68, 70-76, 109 and 680 in the FIG. 48 portion of this COFDM receiver apparatus are similar in their structure and operation to correspondingly numbered elements in the FIG. 19 portion of the receiver apparatus depicted in FIGS. 19, 17 and 18, which receiver apparatus is described supra in this specification. FIG. 48 shows the output port of the bank 76 of parallel-to-serial converters connected for supplying a succession of complex coordinates of modulation symbol constellations to the input port of a tri-state buffer amplifier 111. FIG. 48 further shows the output port of the bank 109 of parallel-to-serial converters connected for supplying a succession of complex coordinates of modulation symbol constellations to the input port of another tri-state buffer amplifier 112. The tri-state buffer amplifiers 111 and 112 are configured to cooperate for providing a time-division multiplexer, their output ports connecting to a common juncture point and thence to the input ports of the de-mappers 91 and 94 in FIG. 17 and to the input port of the de-mapper 99 in FIG. 49. The tri-state buffer amplifier 111 is configured for applying successions of complex coordinates of modulation symbol constellations from the final transmissions for iterative-diversity reception and from single-time transmissions to that common juncture point from a relatively low source impedance, so as to be forwarded to the respective input ports of the de-mappers 91 and 94 in FIG. 17 and to the input port of the de-mapper 99 in FIG. 49. The tri-state buffer amplifier 112 is configured for applying successions of complex coordinates of modulation symbol constellations from the initial transmissions for iterative-diversity reception to that common juncture point from a relatively low source impedance, so as to be forwarded to the respective input ports of the de-mappers 91 and 94 in FIG. 17 and to the input port of the de-mapper 99 in FIG. 49.

FIG. 49 depicts elements 99-103 configured similarly to the way in which correspondingly numbered elements are configured in FIG. 44. The de-mapper 99 responds to the complex coordinates of QAM constellations to supply soft bits of FEC coding from its output port to the input port of the de-interleaver 100 of the interleaving of those soft bits. The output port of the de-interleaver 100 connects to the input port of the SISO decoder 101 for LDPC coding. The output port of the SISO decoder 101 is connected for supplying soft bits of BCH coding to the input port of the soft-input decoder 102 for decoding BCH coding. The output port of the BCH decoder 102 connected to the input port of the BBFRAME descrambler 103, the output port of which connects to the respective input ports of selectors 187 and 188.

The selector 187 is configured for selectively reproducing from its output port the BBFRAMEs from the final transmissions for iterative-diversity reception and from single-time transmissions, which are supplied to its input port from the output port of the BBFRAME descrambler 103. The selector 188 is configured for selectively reproducing from its output port the BBFRAMEs from the initial transmissions for iterative-diversity reception, which are supplied to its input port from the output port of the BBFRAME descrambler 103. The output port of the selector 188 connects to the write-input port of a delay memory 189. The delay memory 189 is configured for supplying from its read-output port a response composed of delayed BBFRAMEs from the initial transmissions for iterative-diversity reception, which delayed BBFRAMEs are concurrent with BBFRAMEs from the final transmissions for iterative-diversity reception supplied from the output port of the selector 187.

FIG. 49 shows the output port of an internet-protocol packet chooser 190 connected for supplying IP packets to the input port of the packet sorter 105 for sorting them according to their PIDs. FIG. 14 shows a first output port of the IP packet sorter 105 connected for supplying video data packets to the input port of apparatus 106 for utilizing video data packets, a second output port of the IP packet sorter 105 connected for supplying audio data packets to the input port of apparatus 107 for utilizing audio data packets, and a third output port of the IP packet sorter 105 connected for supplying ancillary data packets to the input port of apparatus 108 for utilizing ancillary data packets.

The BBFRAMEs from single-time transmissions and from the final transmissions for iterative-diversity reception supplied from the output port of the selector 187 are applied to the input port of a first parser 191 for internet-protocol (IP) packets, the output port of which connects to the input port of a decoder 192 for the CRC-8 coding of the IP packets supplied from the output port of the parser 191. After a delay for as much time as to complete decoding of the CRC-8 coding of the longest permissible IP packet in the BBFRAMEs, the CRC-8 decoder 192 reproduces from a first output port thereof those BBFRAMEs for application to a first of two IP-packet-input ports of the IP packet chooser 190. FIG. 49 also shows a connection from a second output port of the CRC-8 decoder 192 to a first of two error-indicia-input ports of the IP packet chooser 190. This connection conveys an indication as to whether CRC-8 decoding determined that the IP packet currently supplied from the first output port of the CRC-8 decoder 192 is correct or is in error.

The delayed BBFRAMEs from the initial transmissions for iterative-diversity reception, supplied from the read-output port of the delay memory 189 are supplied to the input port of a second parser 193 for internet-protocol (IP) packets, the output port of which connects to the input port of a decoder 194 for the CRC-8 coding of the IP packets supplied from the output port of the parser 193. After further delay for as much time as needed to complete decoding of the CRC-8 coding of the longest permissible IP packet in the delayed BBFRAMEs, the CRC-8 decoder 194 reproduces from a first output port thereof those delayed BBFRAMEs for application to the second IP-packet-input port of the IP packet chooser 190. FIG. 49 also shows a connection from a second output port of the CRC-8 decoder 194 to the second of the error-indicia-input ports of the IP packet chooser 190. This connection conveys an indication as to whether CRC-8 decoding determined that the IP packet currently supplied from the first output port of the CRC-8 decoder 194 is correct or is in error.

If the error indicia that the CRC-8 decoders 192 and 194 supply the IP packet chooser 190 indicate that only one of the IP packets that the CRC-8 decoders 192 and 194 concurrently supply to the IP packet chooser 190 has been determined to be correct, the IP packet chooser 190 is conditioned by these error indicia inputs to reproduce from its output port that IP packet determined to be correct. If the error indicia that the CRC-8 decoders 192 and 194 supply the IP packet chooser 190 indicate that both of the IP packets that the CRC-8 decoders 192 and 194 concurrently supply to the IP packet chooser 190 have been determined to be correct, the IP packet chooser 190 is conditioned by these error indicia inputs to reproduce from its output port an arbitrarily selected one of the IP packets determined to be correct. If the error indicia that the CRC-8 decoders 192 and 194 supply the IP packet chooser 190 indicate that neither of the IP packets that the CRC-8 decoders 192 and 194 concurrently supply to the IP packet chooser 190 has been determined to be correct, the IP packet chooser 190 is conditioned by these error indicia inputs to reproduce from its output port one of the IP packets. This IP packet can be arbitrarily selected.

Alternatively, one or more other conditions is taken into account by the IP packet chooser 190 for determining the choice between the two incorrect IP packets. Pilot carriers energy information in regard to the two incorrect IP packets is apt to be helpful in deciding which of the two incorrect IP packets is to be forwarded to the packet sorter 105. I. e., an incorrect IP packet associated with an apparently normal level of energy of pilot carriers from the selector 249 in the FIG. 21 pilot energy assessment arrangement is chosen, rather than an incorrect IP packet associated with an abnormally low level of energy of pilot carriers.

The contemporaneous operation of the two IP packet parsers 191 and 193 facilitates exchange of information between them concerning when IP packets start. FIG. 49 shows a connection 195 from the IP packet parser 191 to the IP packet parser 193 through which connection 195 the parser 191 can transmit to the parser 193 information concerning when IP packets start. This information is useful to the IP packet parser 193 if a BBFRAME header read thereto from the delay memory 189 has been corrupted so as to destroy indication of the start of the initial IP packet in that BBFRAME, presuming that such indication remains intact in the BBFRAME header supplied to the IP packet parser 191 from the selector 187. Information from the IP packet parser 191 concerning the start of subsequent IP packets in an BBFRAME is useful to the IP packet parser 193 when its daisy-chain computation of the start of a subsequent IP packet in the BBFRAME is disrupted by the header of the preceding IP packet read thereto from the delay memory 189 having been corrupted so as to destroy indication of the start.

FIG. 49 further shows a connection 196 from the IP packet parser 193 to the IP packet parser 191 through which connection 196 the parser 193 can transmit to the parser 191 information concerning when IP packets start. This information is useful to the IP packet parser 191 if a BBFRAME header supplied thereto via the selector 187 has been corrupted so as to destroy indication of the start of the initial IP packet in that BBFRAME, presuming that such indication remains intact in the BBFRAME header read to the IP packet parser 193 from the delay memory 189. Information from the IP packet parser 193 concerning the start of subsequent IP packets in an BBFRAME is useful to the IP packet parser 191 when its daisy-chain computation of the start of a subsequent IP packet in the BBFRAME is disrupted by the header of the preceding IP packet supplied thereto via the selector 187 having been corrupted so as to destroy indication of the start.

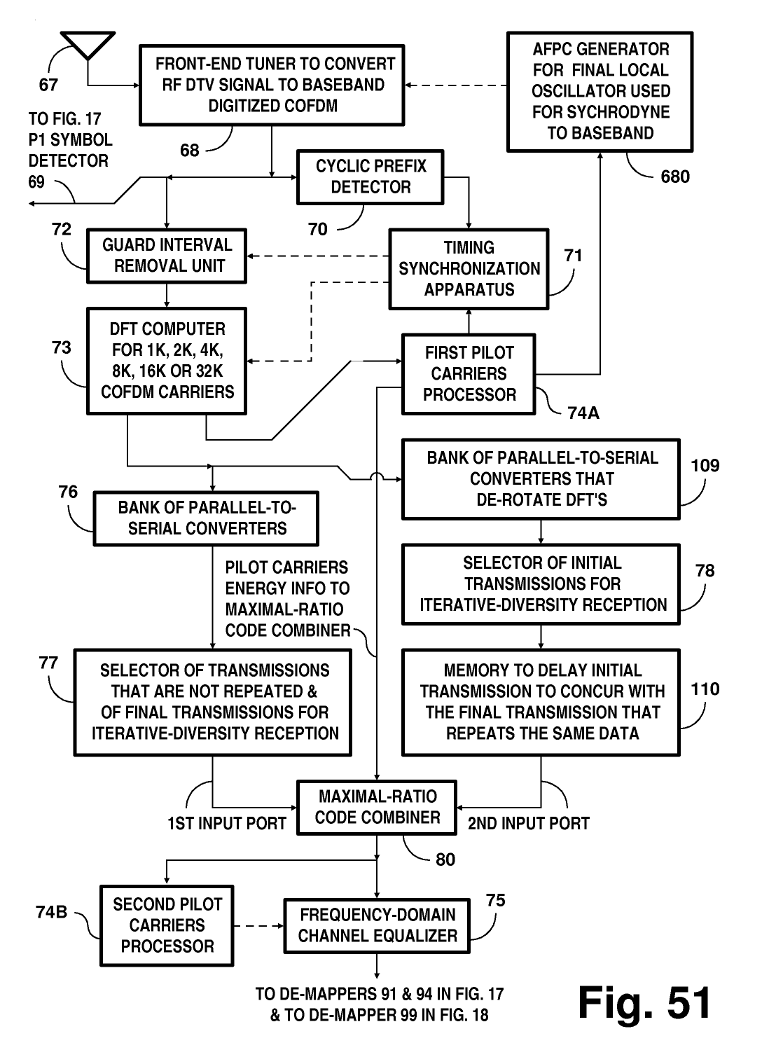

FIG. 50 shows a modification of the FIG. 16 portion of the COFDM receiver apparatus further depicted in FIGS. 17 and 18, which modification differs from what FIG. 16 depicts in the following ways. The pilot carriers processor 74 is replaced by a first pilot carriers processor 74A and a second pilot carriers processor 74B. FIG. 50 shows the first output port of the DFT computer 73 pilot carriers processor connected to the input port of the first pilot carriers processor 74A. The first pilot carriers processor 74A performs all the functions performed by the pilot carriers processor 74 of FIG. 16, except for computing weighting coefficients for the frequency-domain channel equalizer 75B, which the second pilot carriers processor 74B does.

FIG. 50 shows the second output port of the DFT computer 73 connected directly to the input port of the bank 76 of parallel-to-serial converters, rather than to the input port of the frequency-domain channel equalizer 75. The frequency-domain channel equalizer 75 is moved to later in the processing of the complex coordinates of QAM constellations. FIG. 50 shows the output port of the maximal-ratio code combiner 80 connected to the input port of the second pilot carriers processor 74B and to the input port of the frequency-domain channel equalizer 75. FIG. 50 indicates that the output port of the frequency-domain channel equalizer 75 connects to the input ports of the de-mappers 91, 94 and 99, rather than the output port of the maximal-ratio code combiner 80 connecting directly to them. FIG. 50 shows the output port of the second pilot carriers processor 74B connected for supplying weighting coefficients to the frequency-domain channel equalizer 75.

FIG. 51 shows a modification of the FIG. 45 portion of the COFDM receiver apparatus further depicted in FIGS. 17 and 18, which modification differs from what FIG. 16 depicts in the following ways. The pilot carriers processor 74 is replaced by the first pilot carriers processor 74A and the second pilot carriers processor 74B. FIG. 51 shows the first output port of the DFT computer 73 connected to the input port of the first pilot carriers processor 74A. FIG. 51 shows the second output port of the DFT computer 73 connected directly to the input ports of the banks 76 and 109 of parallel-to-serial converters, rather than to the input port of the frequency-domain channel equalizer 75.

FIG. 51 like FIG. 50 shows the frequency-domain channel equalizer 75 moved to later in the processing of the complex coordinates of QAM constellations. FIG. 51 shows the output port of the maximal-ratio code combiner 80 connected to the input port of the second pilot carriers processor 74B and to the input port of the frequency-domain channel equalizer 75. FIG. 51 indicates that the output port of the frequency-domain channel equalizer 75 connects to the input ports of the de-mappers 91, 94 and 99, rather than the output port of the maximal-ratio code combiner 80 connecting directly to them. FIG. 51 shows the output port of the second pilot carriers processor 74B connected for supplying weighting coefficients to the frequency-domain channel equalizer 75.

Code combining the respective soft complex coordinates of QAM constellations from the two transmissions of the same coded data before channel equalization tends to “fill in” nulls in the transmissions attributable to frequency-selective fading. Accordingly, there is less tendency for noise to be boosted by channel equalization than if the respective soft complex coordinates of QAM constellations from the two transmissions of the same coded data are code combined after channel equalization. The avoidance of noise being boosted in the soft complex coordinates of QAM constellations tends to reduce error in the two-dimensional data-slicing of those coordinates that is part of the procedure for de-mapping those QAM constellations. Receiver configurations in which code combining is done before channel equalization are preferred for somewhat better performance when frequency selective fading affects DTV signal reception. However, receiver configurations in which code combining is done after channel equalization are simpler to implement and may impose slightly less drain on battery power.

The foregoing description has described the complex coordinates of modulation symbol constellations being processed in a single bit stream that alternates in-phase coordinates with quadrature-phase coordinates. In practice, alternative embodiments of the DTV receiver apparatus are apt to be used that process the in-phase coordinates and quadrature-phase coordinates of two-dimensional modulation symbol constellations in parallel in respective bit streams. These alternative embodiments of DTV receiver apparatus are to be considered as embodying aspects of the invention disclosed herein. Also, alternative embodiments of the DTV transmitter apparatus are apt to be used that process the in-phase coordinates and quadrature-phase coordinates of two-dimensional modulation symbol constellations in parallel in respective bit streams. These alternative embodiments of DTV transmitter apparatus are to be considered as embodying aspects of the invention disclosed herein. These alternative embodiments are to be considered to be equivalents included within the scopes of claims accompanying this specification in accordance with the court-established doctrine of equivalency.

The DTV systems described supra may be modified to include further error correction coding. Less preferred DTV systems that embody some of the aspects of the invention modify the DTV systems described supra to omit rotation of the DFT of COFDM symbols during single-time retransmissions. Such modifications sacrifice capability to overcome severe frequency-selective fading, but preserve capability to overcome man-made-noise (MMN) and drop-outs in received signal strength that span the full frequency spectrum of the RF channel. Persons skilled in the art of designing DTV systems are apt to discern that various other modifications and variations can be made in the specifically described apparatus without departing from the spirit or scope of the invention in some of its aspects.

1. Transmitter apparatus for generating modulated radio-frequency carrier waves each comprising in time-division multiplex time-slices of coded orthogonal frequency-division multiplexed (COFDM) transmissions of quadrature-amplitude-modulated (QAM) carrier waves conveying bit-interleaved multilevel low-density parity-check convolutional (LDPCC) coding of digital television information, said transmitter apparatus comprising in each of a number of physical layer pipelines:
a respective inner encoder for multilevel LDPCC coding of outer-coded internet-protocol (IP) packets of digital information in that said physical layer pipeline, said multilevel LDPCC coding encoding each level of LDPCC coding in accordance with the likelihood of error in subsequent mapping to QAM constellations of said carrier waves in said COFDM transmissions; and
a respective mapper for mapping the results of multilevel LDPCC coding of said outer-coded IP packets in that said physical layer pipeline to QAM constellations of said carrier waves in said COFDM transmissions.

2. Transmitter apparatus as set forth in claim 1, further comprising in each of said number of physical layer pipelines:
a respective outer encoder for outer coding internet-protocol (IP) packets of digital information.

3. Transmitter apparatus as set forth in claim 2, wherein each said respective outer encoder is configured for performing multilevel Bose-Chaudhuri-Hocquenghem (BCH) coding of said IP packets of digital information, in accordance with the likelihood of error in subsequent mapping to QAM constellations of said carrier waves in said COFDM transmissions.

4. Transmitter apparatus as set forth in claim 1, wherein said respective encoder for multilevel LDPCC coding within a first of said number of physical layer pipelines generates a respective level of multilevel LDPCC coding for each bit place in labeling of lattice points in QAM constellations to which the results of multilevel LDPCC coding are mapped by said respective mapper within said first of said number of physical layer pipelines.

5. Transmitter apparatus as set forth in claim 1, wherein said respective encoder for multilevel LDPCC coding within a first of said number of physical layer pipelines generates fewer levels of multilevel LDPCC coding than bit places in labeling of lattice points in QAM constellations to which the results of multilevel LDPCC coding are mapped by said respective mapper within said first of said number of physical layer pipelines.

6. Transmitter apparatus as set forth in claim 1, wherein said respective encoder for multilevel LDPCC coding within a first of said number of physical layer pipelines generates half as many levels of multilevel LDPCC coding as bit places in Gray labeling of lattice points in square QAM constellations to which the results of multilevel LDPCC coding are mapped by said respective mapper within said first of said number of physical layer pipelines.

7. Transmitter apparatus as set forth in claim 1, said transmitter apparatus further comprising:
an assembler for assembling a serial stream of incomplete COFDM symbols composed of complex coordinates of said QAM constellations of said carrier waves in said COFDM transmissions, as supplied from the respective mapper in each of said number of physical layer pipelines;
a pilot carriers insertion and dummy tones reservation unit for inserting complex coordinates of pilot carriers and reserved dummy tones into said serial stream of incomplete COFDM symbols, thus to generate a serial stream of complete COFDM symbols; and
an OFDM modulator for generating a baseband COFDM signal responsive to said serial stream of complete COFDM symbols.

8. Transmitter apparatus as set forth in claim 7, further comprising:
a respective interleaver for shuffling the order of complex coordinates of said QAM constellations as supplied from said respective mapper in each of said number of physical layer pipelines to said assembler for assembling a serial stream of incomplete COFDM symbols.

9. Transmitter apparatus as set forth in claim 7, further comprising:
memory for temporarily storing said serial stream of complete COFDM symbols generated by said pilot carriers insertion and dummy tones reservation unit, said memory configured for initially reading each successive COFDM symbol in “rotate-circular-inverse-discrete-Fourier-transform-by-one-half-revolution” temporal order to said OFDM modulator, and said memory configured for finally reading each said successive COFDM symbol in normal temporal order to said OFDM modulator a prescribed time interval after being initially read to said OFDM modulator.

10. A receiver for a selected one of modulated radio-frequency carrier waves each comprising in time-division multiplex time-slices of coded orthogonal frequency-division multiplexed (COFDM) transmissions of quadrature-amplitude-modulated (QAM) subcarriers conveying multilevel low-density parity-check convolutional (LDPCC) coding of digital television information, said receiver comprising:
a tuner for receiving and demodulating said selected one of said modulated radio-frequency carrier waves to generate a baseband digitized COFDM signal;
a unit for removing the guard interval from said baseband digitized COFDM signal;
a computer for computing the discrete Fourier transform (DFT) of said baseband digitized COFDM signal from which said guard interval thereof has been removed;
a frequency-domain channel equalizer connected for equalizing components of said DFT to counteract irregularities in the response of the transmission channel to these respective components;
parallel-to-serial conversion apparatus for converting equalized components of said DFT to serially supplied complex coordinates of QAM symbol constellations;
a de-mapper responsive to said serially supplied complex coordinates of QAM symbol constellations to recover said multilevel LDPCC coding; and
apparatus for decoding said multilevel LDPCC coding to recover said digital television information.

11. A receiver as set forth in claim 10, wherein said apparatus for decoding multilevel LDPCC coding comprises:
a respective decoder for decoding each level of said multilevel LDPCC coding as concatenated with respective outer coding to supply a respective decoding result composed soft systematic data bits; and
apparatus for time-division multiplexing said respective decoding results from said respective decoders for decoding each level of said multilevel LDPCC coding as concatenated with respective outer coding, thus to recover systematic data bits in an original order.

12. A receiver as set forth in claim 11, wherein said outer coding is Bose-Chaudhuri-Hocquenghem (BCH) coding.

13. A receiver as set forth in claim 10, equipped for providing combined reception of initial transmissions of segments of said digital television information and final transmissions of segments of corresponding said digital television information some time later, said receiver further comprising:
memory for delaying said serially supplied complex coordinates of QAM symbol constellations recovered from said initial transmissions of segments of said digital television information to concur in time with corresponding said serially supplied complex coordinates of QAM symbol constellations recovered from said final transmissions of segments of said digital television information; and
a maximal-ratio code combiner for combining said complex coordinates of QAM symbol constellations recovered from said initial transmissions of segments of said digital television information, as delayed by said memory, with corresponding said complex coordinates of QAM symbol constellations recovered from said final transmissions of segments of said digital television information, thus to generate said complex coordinates of QAM symbol constellations serially supplied to said de-mapper responsive to those said complex coordinates of QAM symbol constellations to recover said multilevel LDPCC coding.

14. A receiver as set forth in claim 10, equipped for providing combined reception of initial transmissions of segments of said digital television information and final transmissions of segments of corresponding said digital television information some time later, wherein said parallel-to-serial conversion apparatus is configured for converting said equalized components of said DFT recovered from said initial transmissions of segments of said digital television information to serially supplied complex coordinates of QAM symbol constellations after rotating that DFT as circularly considered by one-half revolution, wherein said parallel-to-serial conversion apparatus is configured for converting said equalized components of said DFT recovered from said final transmissions of segments of said digital television information to serially supplied complex coordinates of QAM symbol constellations without rotating said equalized components of said DFT recovered from said final transmissions of segments of said digital television information as circularly considered, said receiver further comprising:
memory for delaying said serially supplied complex coordinates of QAM symbol constellations recovered from said initial transmissions of segments of said digital television information to concur in time with corresponding said serially supplied complex coordinates of QAM symbol constellations recovered from said final transmissions of segments of said digital television information; and
a maximal-ratio code combiner for combining said complex coordinates of QAM symbol constellations recovered from said initial transmissions of segments of said digital television information, as delayed by said memory, with corresponding said complex coordinates of QAM symbol constellations recovered from said final transmissions of segments of said digital television information, thus to generate said complex coordinates of QAM symbol constellations serially supplied to said de-mapper responsive to those said complex coordinates of QAM symbol constellations to recover said multilevel LDPCC coding.

15. A receiver as set forth in claim 10, equipped for providing combined reception of initial transmissions of segments of said digital television information and final transmissions of segments of corresponding said digital television information some time later, said digital television information being conveyed in internet-protocol packets each with cyclic redundancy check (CRC) coding, wherein said parallel-to-serial conversion apparatus is configured for converting said equalized components of said DFT recovered from said initial transmissions of segments of said digital television information to serially supplied complex coordinates of QAM symbol constellations after rotating that DFT as circularly considered by one-half revolution, wherein said parallel-to-serial conversion apparatus is configured for converting said equalized components of said DFT recovered from said final transmissions of segments of said digital television information to serially supplied complex coordinates of QAM symbol constellations without rotating said equalized components of said DFT recovered from said final transmissions of segments of said digital television information as circularly considered, said receiver further comprising:
memory for delaying said digital television information recovered from said initial transmissions of segments of said digital television information to concur in time with corresponding said digital television information recovered from said final transmissions of segments of said digital television information;
a first CRC decoder for CRC coding of IP packets of said digital television information recovered from said initial transmissions of segments of said digital television information as delayed to concur in time with corresponding said digital television information recovered from said final transmissions of segments of said digital television information, said first CRC decoder configured for generating indications of whether or not each IP packet of said digital television information recovered from delayed said initial transmissions of segments of said digital television information is correct;
a second CRC decoder for CRC coding of IP packets of said digital television information recovered from said corresponding final transmissions of segments of said digital television information, said second CRC decoder configured for generating indications of whether or not each IP packet of said digital television information recovered from said final transmissions of segments of said digital television information is correct; and
an IP packet chooser for reproducing IP packets of said digital television information each selected from a pair of said IP packets of said digital television information concurrently decoded by said first and said second CRC decoders, said selection based on indications from said first and said second CRC decoders as to which IP packets are correct so as to select a correct one of concurrent IP packets for reproduction insofar as possible.

16. A method for conveying a bitstream of successive bits of systematic data to COFDM receiver apparatus via a plurality of coded orthogonal frequency-division-multiplex (COFDM) carrier waves, said method comprising steps of:
breaking down said bitstream of successive bits of systematic data into respective component bitstreams of data, each component bitstream designed to describe a multi-level-coding/parallel-independent-decoding (MLC/PID) modulating signal for ones of said COFDM carrier waves;
low-density parity-check convolutional (LDPCC) coding each of said component bitstreams of data to generate a respective component of said MLC/PID modulating signal, the LDPCC coding for each said component of said MLC/PID modulating signal being chosen taking into consideration the likelihood of error in that component during parallel independent decoding thereof in said receiver apparatus; and
modulating said COFDM carrier waves in accordance with said MLC/PID modulating signal.

17. A method as set forth in claim 16, wherein said step of breaking down said bitstream of successive bits of systematic data into component bitstreams of data for subsequent steps of MLC includes substeps of:
outer coding each component of said systematic data as broken down into component bitstreams of data for subsequent steps of MLC.

18. A method as set forth in claim 17, wherein said outer coding is Bose-Chaudhuri-Hocquenghem (BCH) coding.
